(19) United States
(12) Patent Application Publication
(10) Pub. No.: US 2017/0061003 A1
(43) Pub. Date: Mar. 2, 2017

(54) SYSTEM, METHOD, DEVICE AND PRODUCT FOR COMPILING AGGREGATED MEDIA IN A TIME-BASED PLAYLIST

(71) Applicants: David A. Baird, Novi, MI (US); Joseph Michael Vaillancourt, Rochester, MN (US); Mark Kopulos, Sharon, MA (US); Brittany Barbara Vaillancourt, Rochester, MN (US); Christopher Smith, Wixom, MI (US); Tibor Fulop, Budapest (HU)

(72) Inventors: David A. Baird, Novi, MI (US); Joseph Michael Vaillancourt, Rochester, MN (US); Mark Kopulos, Sharon, MA (US); Brittany Barbara Vaillancourt, Rochester, MN (US); Christopher Smith, Wixom, MI (US); Tibor Fulop, Budapest (HU)

(21) Appl. No.: 15/213,399

(22) Filed: Jul. 19, 2016

Related U.S. Application Data
(63) Continuation-in-part of application No. PCT/US15/00010, filed on Jan. 16, 2015.
(60) Provisional application No. 61/965,054, filed on Jan. 16, 2014.

(51) Int. Cl. G06F 17/30; H04N 21/482; H04N 21/262

(52) U.S. Cl. CPC G06F 17/30772; H04N 21/26258; H04N 21/4825; G06F 17/30752

(57) ABSTRACT

A system, method and device are provided, for creating multimedia playlists. A visual module aggregates at least one image file targeted from one or more visual media fields. A music module aggregates multiple audio files targeted from one or more audio media fields. A time module registers allocated mix duration and references elapsed mix duration versus the allocated mix duration, A news module aggregates topical information targeted from one or more news fields, pertaining to at least one of the sound files, as the sound file is added to the playlist. A publishing module compiles the aggregated visual and sound files, respectively, while updating the aggregated news. Provided the elapsed mix duration is less than or equal to the allocated mix duration, a discrete playlist is displayed on a User interface console as the sound files are played, when prompted by the system or the User.

CROSS-REFERENCE TO RELATED APPLICATION(S)

This application is a Continuation-in-part of earlier International Application Number PCT/US2015/000010, filed Jan. 16, 2015, which in turn is based on U.S. Provisional Application No. 61/965,054, filed Jan. 16, 2014 by some or all of the present inventors, the priority dates of said applications being hereby expressly claimed, and the entire contents of said applications being expressly incorporated by reference and made a part herein.

### TECHNICAL FIELD

The present invention relates generally to a system, method and apparatus for User-created musical playlists that combine other media elements.

### BACKGROUND

The internet has enabled online contacts to share various types of media files with one another, as part of social networks. Such files have included images, audio (including music) and/or topical information concerning the image or audio files so referenced.

### PRIOR ART

One way User experiences have sought to share media has been through pictures with accompanying textual commentary, in an interactive network service such as Instagram.com. This is a social media service said to allow Users to experience moments in friends' lives through pictures as they happen. Instagram Users are invited to choose a filter to transform the look and feel of their particular image into a memory to keep around forever, according to the service. Instagram.com Users can post on the service or share to Facebook, Twitter, Tumblr, their text messages together with photos and other images uploaded by them. Images can be stored on Instagram.com for later posting.

Other interactive services exist on the Internet for Users to create and share audio files in the form of playlists. On the Web, 8tracks.com is said to be an ‘Internet Radio” or “webcasting” service where Users can do two things: listen to a playlist, or create a playlist of 8 or more songs, which does not have a time limit. Listeners are invited to search for a mix by artist or genre, stream it in a legal, radio-style manner, and follow others who (in their opinion) make compelling mixes. This service invites DJs to upload MP3 or AAC (Advanced Audio Coding) files to craft a playlist, add context with description and art, and publish their mix on 8tracks.com and a personal webpage.

Another streaming audio service on the Web is SoundCloud.com, said to be a social sound platform where anyone can create sounds and share them everywhere. This service also offers a search function for Users to locate titles of potential interest in building their mixes. Users may create a profile with an avatar or personal photo, which may be displayed along with their uploaded file. Recording and uploading sounds to SoundCloud enables Users to share these privately with their online friends or publicly to blogs, sites and social networks Twitter, Tumblr, Facebook and Foursquare. SoundCloud is said to be accessible anywhere using official iPhone and Android mobile phone “apps”, as well as numerous creation and sharing apps built on the SoundCloud platform. There is no time limit for an uploaded file, neither is there more than one discrete audio file involved per upload. In addition to authorized uploaders of studio versions of a title, DJ's also commonly upload their customized mixes of a given title or “mash-up” concatenations of different titles by different artists submitted as one audio file.

Published Application No. US 2012/0221559, entitled “Social Discovery Platform Apparatuses, Methods and Systems”, relates to so-called magic playlists that are automatically generated playlists of content related to a “seed” item such as an artist, an album, a track, a playlist, another User or a combination thereof. In one embodiment, a magic playlist generation algorithm may utilize historical (e.g., listening/usage history), social (e.g., what friends are listening to), usage, profile, Gurus, track rating, crowd sourcing and other data to create a magic playlist. Activities that may lead to rewards and/or recognition include sharing libraries, playlists and/or knowledge, posting to other Users', friends', and followers' comment streams, recruiting new followers and/or friends, suggesting and/or recommending music to friends and/or followers, sharing playlists for followers, friends and/or other, increasing music consumption, reviewing contents (artists, albums, playlists) and posting to content comment streams, and/or the like. The playlists are not specifically User-generated but rather a function of specific data concerning one or more aspects of music associated with the User.

Published Application No. US 2009/0276709, entitled “Method and Apparatus for Providing Dynamic Playlists and Tag-tuning of Multimedia Objects”, provides a particular User with the capability to post items that are associated with multimedia objects, such as audio files and video files. The posted items are automatically added to the dynamic playlists of other Users who are “following” the particular User. The posted items may also be added to the particular User's own dynamic playlist. The dynamic playlist of any User is provided to that User for viewing and for accessing the multimedia objects associated with the items in the dynamic playlist. One User may give another User a particular amount of social currency, and a particular's User's total amount of social currency received through gifts is maintained and displayed in a profile of the particular User. Various items, including multimedia objects, blog entries, products, may be tagged with tags that indicate some information about the items. For example, a multimedia object that is an audio file may be tagged with “classical”, “punk”, “rap”, etc. These tags may be automatically generated based on identifiers associated with the multimedia objects (e.g., ID3 information associated with MP3 audio files) or based on the data contained within the multimedia objects themselves. In addition, Users may create tags and associate the created tags with the multimedia objects. For example, a User may create a tag called “happy” and associate the “happy” tag with several multimedia objects. User-created tags and associations to multimedia objects, and may be retrieved in performing tag cloud tuning, or tag filtering.

U.S. Pat. No. 8,463,245 entitled “Systems and Methods for Communicating Music Indicia” describes a menu permanently stored on a mobile device, which provides a ranked music indicia option to review a ranked list of music indicia over a cellular network. The menu further provides news and reviews option to review news and reviews relating to a music artist or a band over a cellular network an option to the device User, to review news and reviews relating to a music artist or band over the cellular network. The news request is initiated by the User's device before it is displayed.

The afore-mentioned approaches of others are often prone to auto-suggestion, mechanizing the User experience, rather than relying upon first-hand choices by Users, and User interactions with the music and the other Users.

Accordingly, there is a space in the field for a more organic approach to the creation and sharing of musical life moments in a social network.

Therefore it is an object of the present invention to provide systems that amalgamate various media into instant social jukebox mixes.

### SUMMARY OF THE INVENTION AND ADVANTAGES

As will be appreciated by one skilled in the art, the present invention may be embodied as a system, method, device or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages, or HTML5. The program code may execute entirely on the User's computer, partly on the User's computer, as a stand-alone software package, partly on the User's computer and partly on a remote computer or entirely on the remote computer or server. In the latter scenario, the remote computer may be connected to the User's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks

Referring now to the Figures, the flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Accordingly, in its various embodiments, the present invention provides an instant social jukebox system. The system includes a music module that aggregates a multiplicity of sound files targeted by a User's device from one or more audio media sources searched by the system, making a musical playlist having an elapsed unit of time in duration. A visual module aggregates an image file targeted by the User from one or more visual media sources. A news module aggregates updated textual information targeted from one or more news sources, topically pertaining to the musical playlist. A time module allocates a standard unit of time to each musical playlist and compares the standard unit of time to the elapsed unit of time. A publishing module compiles the aggregated sounds, images, news and text as a life-to-media mix moment. The mix moment is published if the elapsed time unit is less than or equal to the standard time unit, in which case the moment is discretely displayed on a User interface console as the one or more sound files are streamed to other Users, when prompted by the system. that creates a life-to-media moment.

Preferably the system console displays multiple instant social jukebox moments respectively published by multiple Users, together in a pre-determined sequence which, more preferably are displayed in chronological order. Even more preferably, the system moments are selected by Users manually by navigating the console or are played automatically by the system.

Still preferably, the system visual module further targets images from locations selected from those accessible via the internet, private network or local User drive.

Yet preferably, the system news module further updates continually with topical information, which is automatically displayed on the console, as a moment is being played by a User or by the system.

Also preferably, the system captioning module has separate title and description random entry lines.

Also preferably, the system currency module further dispenses additional standard time units earned by the User according to value criteria defined by the currency module, which enables the User to extend the elapsed time unit beyond the standard time unit.

Also preferably, the system publishing module further displays the image and text for each moment on a card that can be manually flipped to display a reverse side for User commentary or other information.

According to the present invention, there is provided a method for creating multimedia playlists comprising several steps. One step involves targeting a multiplicity of sound files from one or more audio media fields and aggregating the sound files in a music module, for each playlist. Another step involves registering allocated mix duration in a time module and referencing elapsed mix duration versus the allocated mix duration, for each playlist. Yet another step involves targeting at least one image file from one or more visual media fields and aggregating the image file in a visual module for each playlist. Still another step involves targeting topical textual information pertaining to at least one of the sound files from one or more news fields and aggregating the textual information in a news module, as the sound file is added to the playlist. Again, another step involves compiling the aggregated sound files and image file and updating the aggregated topical information, ascertaining that the elapsed mix duration is less than or equal to the allocated mix duration, then publishing the files and updated text as an audiovisual playlist, discretely displaying each audiovisual playlist on a User interface console as the sound files are played, respectively.

Preferably, the method step of publishing includes multiple playlists, by separate Users, displaying the playlists in a pre-determined sequence on the console and, more preferably, displaying the playlists in chronological order of publication; even more preferably is a step of navigating the multiple playlists on a console and manually playing the sound files by Users or automatically in a predetermined order.

Still preferably, in the above method there is a step of targeting visual fields selected from those accessible via the internet, private network or local User drive, in the visual module.

Yet preferably, in the above method there is a step of continually updating the topical information in the news module and automatically displaying the topical information on the console, as a sound file is being played by a User.

Yet still preferably, in the above method there is a step of providing a text input window for manually entering a title or caption by the User. Further preferably, there is a step of increasing the allocated mix duration according to selected value criteria in a time-bank, enabling the User to extend the elapsed mix duration beyond the allocated playlist duration. Even yet preferably, in the above method there is a publishing step displaying the image and text for each mix-moment on a card that can be manually flipped to display a reverse side for User commentary or other textual information.

In another of its aspects, the present invention comprises a software product having discrete instructions sets detailed in the Figures of the Drawings and also in the code document submitted herewith and made a part

An advantage of the present invention, in its preferred form, is a horizontally scrolling sequence of flippy cards each with a separate User playlist mix.

The features and advantages of the disclosure will be set forth in the description which follows, and in part will be apparent from the description, or may be learned by practice of the disclosure without undue experimentation. The features and advantages of the disclosure may be realized and obtained by means of the systems, methods, devices, products and combinations thereof, particularly pointed out in the appended claims.

### BRIEF DESCRIPTION OF THE DRAWINGS

FIG. 1 is a schematic view of a system in accordance with the present invention;

FIG. 2 is a logical flow diagram showing the overall operation of the present invention, particularly the mix creation process steps including aggregation of an image, allocation of a time-bank, aggregation of audio files from a playlist fitting within the lapsing time-bank, aggregation of news content pertaining to the audio, (preferably) entering descriptive text and finally compiling aggregated image, audio and news and publishing the media content as a mix moment;

FIG. 3 is a logical flow diagram of the image (photo) uploading procedure according to the system of the present invention, where a User device logged-in to the system utilizes a third party application programming interface (“API”) such as uploadcare.com, to search for and select an image as instructed, from among a variety of social media sources (e.g., Facebook.com, Instagram.com, etc.), an image bank hosted by the system, a Web search engine URL link (e.g., via Google, Bing, Yahoo, etc.) and a local drive controlled by the User device (e.g., Smartphone, tablet, desktop PC or Mac, etc.), then preferably further processing the image (e.g., crop and filter) or, if acceptable, to submit the image for publishing on the system in the mix-moment;

FIG. 4 is a logical flow diagram of a server-based news aggregation procedure according to the system of the present invention, with search for topical information being requested by the server relevant to a given audio file that is being selected for the playlist, the news being continually updated while audio files are being added to the playlist as instructed, then the news is saved until the mix-moment is published at which time the saved news is updated with more recent news to be scrolled across the console of a User device when the mix-moment is selected;

FIG. 5 is a logical flow diagram further showing in greater detail the server based Find-and-Save function of the news aggregation procedure of FIG. 4 according to the system of the present invention, where a search is requested of targeted news providers for relevant news of artists, songs and other information pertaining to audio files being aggregated, which results are further prioritized by date to combine and increase the priority of duplicate results, then sorted and saved for the highest result so that the news is saved;

FIG. 6 is a logical flow diagram showing browser-based actions of the User device upon mix-moment selection according to the system of the present invention, where the news starts with the upload of the mix-moment instructed by a User device, which news is stored to await more songs to check in a feedback loop and is updated when a User plays the mix-moment, as parallel processing is undergone;

FIG. 7A is a logical flow diagram showing browser-based actions of the User device upon mix-moment selection according to the system of the present invention, where it is loaded from a published mix-moment and streamed, its availability on the targeted media sources verified, initiating streaming;

FIG. 7B is similar to FIG. 7A, but shows a further step of checking song availability, that is, whether a song has been removed at the audio source, resulting in a Message/Alert in which case the particular song is skipped in another feedback loop;

FIG. 8 is a logical flow diagram showing the time-based social currency of the system of the present invention;

FIG. 9 is Lines 2-24 of coding pertinent to the mix-moment publishing procedure according to the system of the present invention;

FIG. 10A (separately paginated) are continuous sections of coding for the Update News procedure per Lines 28-67 according to the system of the present invention;

FIG. 10B (separately paginated) are continuous sections of coding for the Update News procedure per Lines 68-103 according to the system of the present invention;

FIG. 11A (separately paginated) are continuous sections of coding Lines 107-148 pertinent to the image aggregation procedure according to the present invention;

FIG. 11B (separately paginated) are continuous sections of coding Lines 149-171 pertinent to the image aggregation procedure according to the present invention;

FIG. 12A (separately paginated) are continuous coding Lines 176-218 pertinent to the User Notifications procedure according to the system of the present invention;

FIG. 12B (separately paginated) are continuous coding Lines 220-251 pertinent to the User Notifications procedure according to the system of the present invention;

FIG. 13 is a wireframe of a console for a User device equipped with the present system, showing the User registration procedure;

FIG. 14 is a wireframe of a console for a User device equipped with the present system, showing the horizontal orientation of the console with cards scrollable to display published mix-moments of Users;

FIG. 15 is a wireframe of a console for a User device equipped with the present system, showing the site-wide search function window whereby User mix-moments and profiles may be searched for artists, songs and other words of interest;

FIG. 16 is a wireframe of a console for a User device equipped with the present system, showing the sign-in screen;

FIG. 17 is a wireframe of a console for a User device equipped with the present system, showing the home playing display with navigation bar and card activation to hear mix-moments on a card corresponding the mix-moment;

FIG. 18 is a wireframe of a console for a User device equipped with the present system, showing the connection to a User's other social media accounts through the present system;

FIG. 19 is a wireframe of a console for a User device equipped with the present system, showing the aggregation of a mix-moment in terms of the the song playlist assembly together with the image selection and text entry screens;

FIG. 20 is a wireframe of a console for a User device equipped with the present system, showing the time-bank which keeps track of the social currency in terms of the time that is credited to a given User in exchange for ‘follows’, ‘likes’ and other affirmations that are translated into additional time that can be used besides the basic time allocated to each new mix-moment;

FIG. 21 is a wireframe of a console for a User device equipped with the present system, showing the notifications of events and other User affirmations, as found on the flip side of a User's mix-moment card and also dropping down into their profile;

FIG. 22 is a wireframe of a console for a User device equipped with the present system, showing the profile information associated with the cards in the User profile, listing for example the mix-moments published by the User, the following Users, and other background information chosen to be included by a User;

FIG. 23 is a wireframe continuation of FIG. 22;

FIG. 24 is a wireframe showing card interactions according to the console for a User device equipped with the present system;

FIG. 25 is a wireframe showing the card sharing feature;

FIG. 26 is a wireframe showing another view of the card interaction; and

FIG. 27 is a wireframe showing an example of a card playing a mix-moment on a smartphone equipped with WiFi and browser-enabled;

FIG. 28 is a logical flow diagram depicting the various upload options possible with the present system for making Mix-moment creations, i.e., a single photo in the top-most horizontal tier, below which is a horizontal tier representing a multiple photo slideshow with audio or an integrated audio-visual file, in the case of video a FlowPlayer brand video player is available commercially and initialized by the present system, process and software instructions;

FIG. 29 is a logical flow diagram the mix-creation process, controlled by instructions contained in the code abstracted within the FIG. 28 diagram wherein submitted herewith and also indicated in FIG. 28 insofar as the movie, and an automated slideshow rendering accompanied by separately added audio file(s);

FIG. 30 is a Listing of “Multiple Photo Slideshow Creation Code”, particularly Lines 1-38, portions of which are bubbled-out in pertinent sections of the logic diagram of FIG. 29;

FIG. 31 is a continuation of the listing of FIG. 30, particularly sequential Lines 39-68;

FIG. 32 is a continuation of the Listing of FIG. 31, particularly sequential Lines 69-103;

FIG. 33 is a continuation of the Listing of FIG. 32, particularly sequential Lines 104-112 that pertain to the Multiple Photo Slideshow Creation Code with respect to FIGS. 30-32;

FIG. 34 is a Listing of Video Showing Code, particularly Lines 113-134;

FIG. 35 is a Listing of Code for .gif (static and animated) and any other image(s), but not a separate video file;

FIG. 36 is a wireframe taken from a screen shot of the slideshow mix-making with multiple images shown at the left side of the screen;

FIG. 37 is a wireframe taken from a screen shot of the video mix-making;

FIGS. 38-61 are wireframes taken from screen shots of the artist and band ecosystem;

FIG. 62 is a logic diagram of the artist and band ecosystem;

FIG. 63 is a code listing for the FIG. 62 logic diagram with pertinent lines of coding shown bubbled-out in the FIG. 62 diagram; and

FIG. 64 is a code listing for the Direct Uploader operation(s).

### DETAILED DESCRIPTION OF THE DRAWING FIGURES

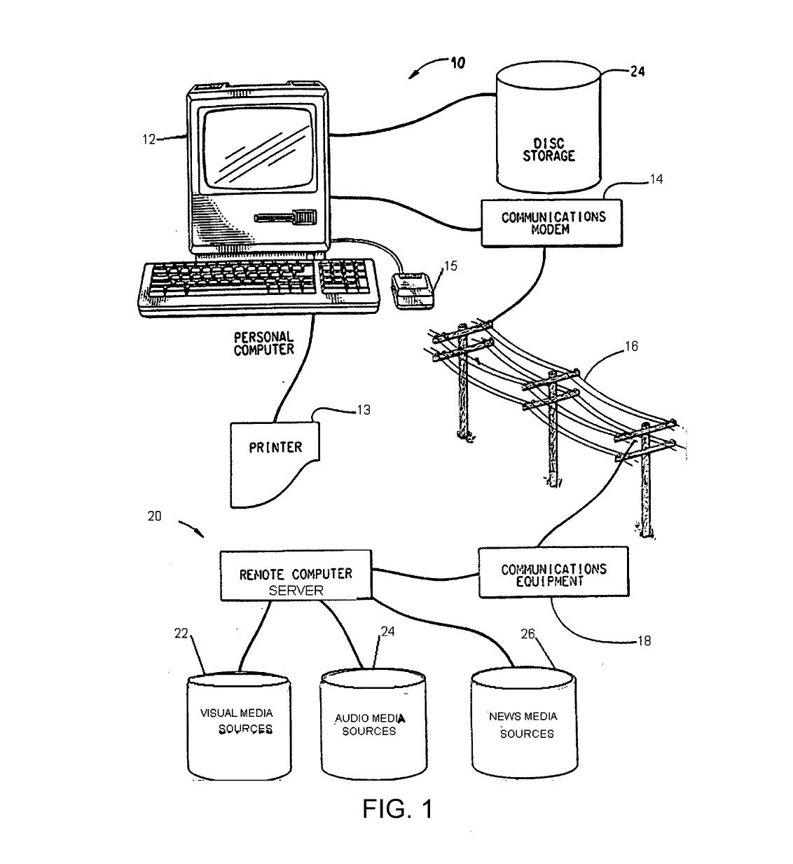

In FIG. 1 is depicted an exemplary hardware layout for operation of the present system 10, including one of several User devices, in this case personal computers including CPU 12, printer 13 and mouse 15, which are each communicating with the internet via modems 14 carrying broadband signals via transmission lines 16 and other communications equipment such as routers 18 managed by one or more system servers 20 that handles the active scripting file download to the User devices by the system. Server 20 targets visual 22, audio 24 and news 26 sources or fields from which content is added to a mix-moment by a User device 12 according to the process flow discussed further herein.

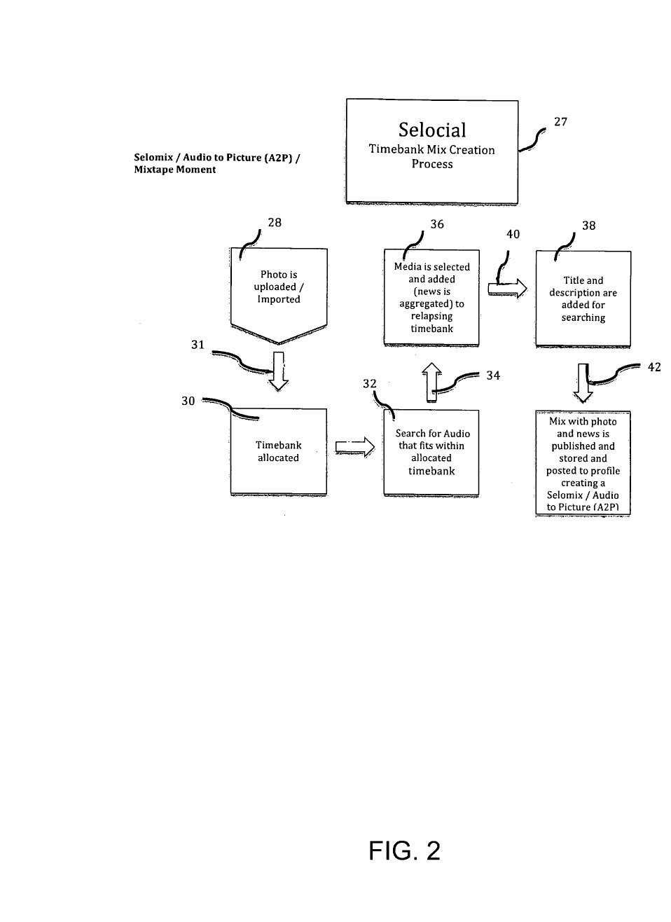

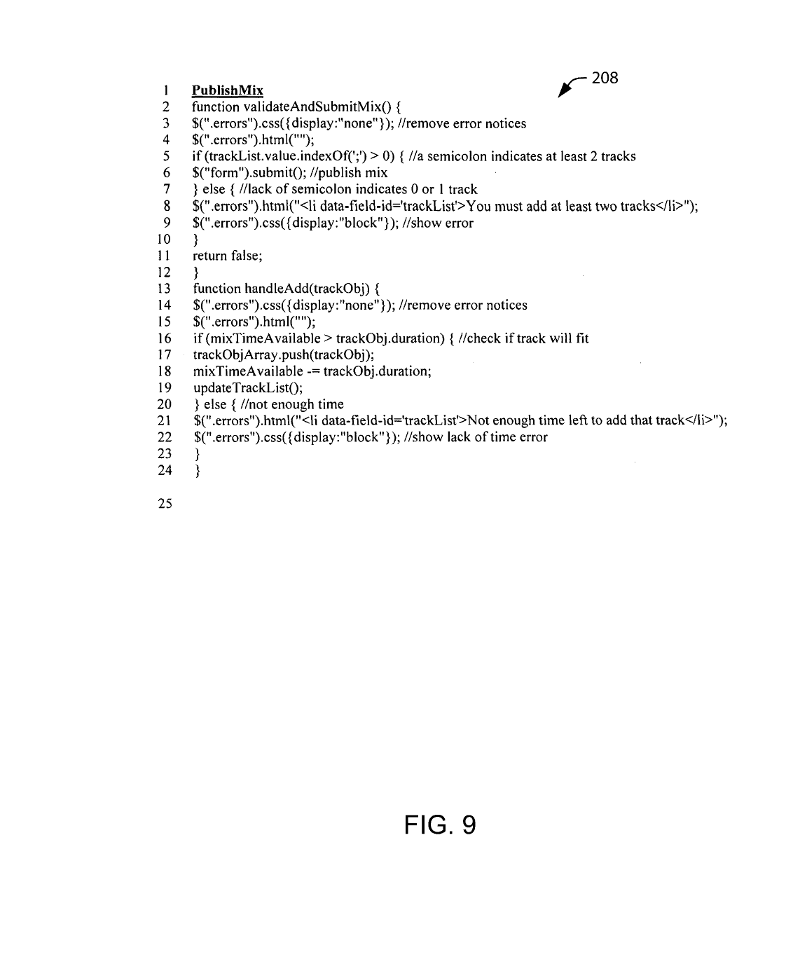

In FIG. 2 is shown the mix-moment creation process 27 enabled by the devices and other architecture of the present system discussed immediately above. The steps include aggregation of an image 28, allocation of a time-bank 30 via step 31, aggregation of audio files from a playlist 32 fitting within the lapsing time-bank indicated by step 34, with search and aggregation of news content 36 pertaining to the audio. Preferably, entry of descriptive text in caption and title 38 in step 40 is made by the User device 12 and finally the step 42 of compiling aggregated image, audio and news 44 media content that is published using the instructions in FIG. 9 as a mix moment. 42.

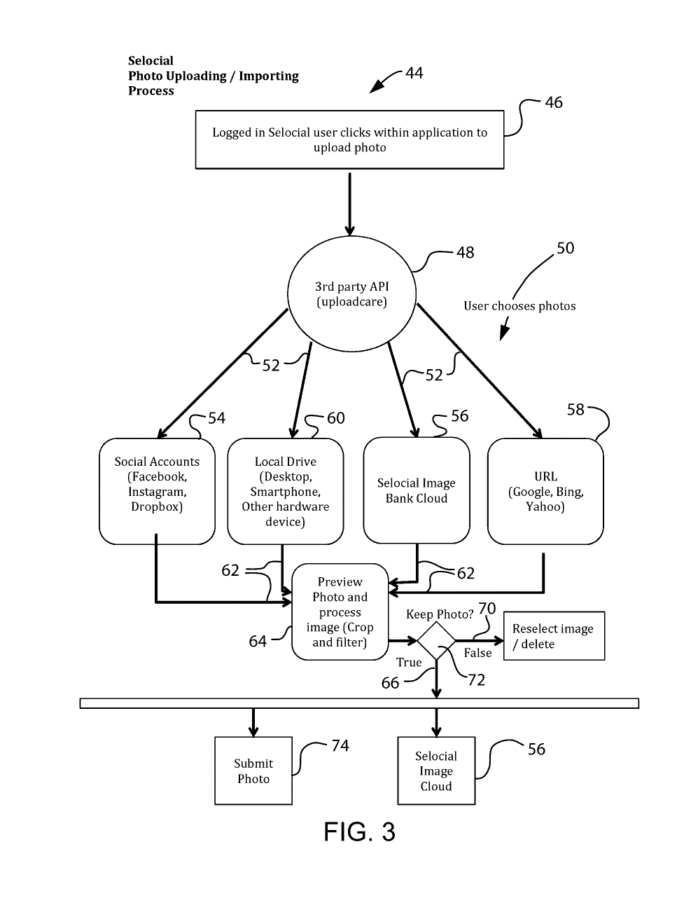

FIG. 3 is a logical flow diagram of the image (photo) uploading procedure 44 according to the system 10 and process 27 of the present invention, where a User device 12 logged-in to the system at step 46 utilizes a third party application programming interface (“API”) generally indicated at 48, such as uploadcare.com, to search for and select at 50 an image as instructed (such as by arrows 52), from among a variety of social media sources generally at 53, including Facebook.com, Instagram.com or Dropbox.com 54, an image bank 56 hosted by the system 10, a Web search engine URL link, e.g., via Google, Bing, Yahoo, etc. 58 and a local drive 60 controlled by the User device 12 (e.g., Smartphone, tablet, desktop PC or Mac, etc.), then preferably further processing (as at arrows 62) the image, e.g., crop and filter at 64 and, if acceptable at True 66 or not acceptable at False 70 at decision point 72, to submit the image at 74 for publishing on the system 10 in the mix-moment 42 as introduced above.

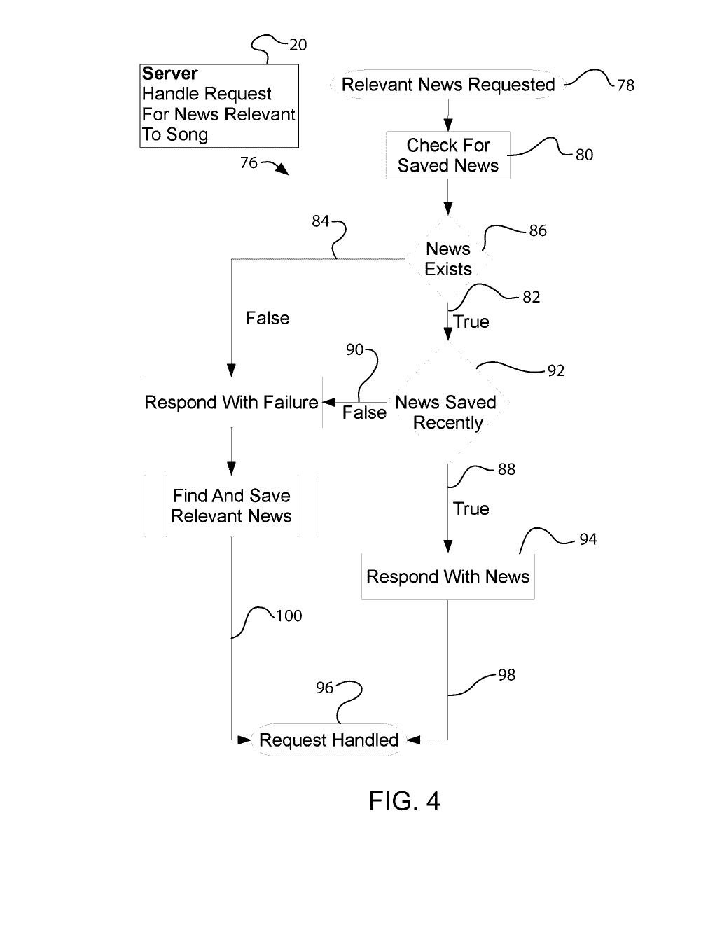

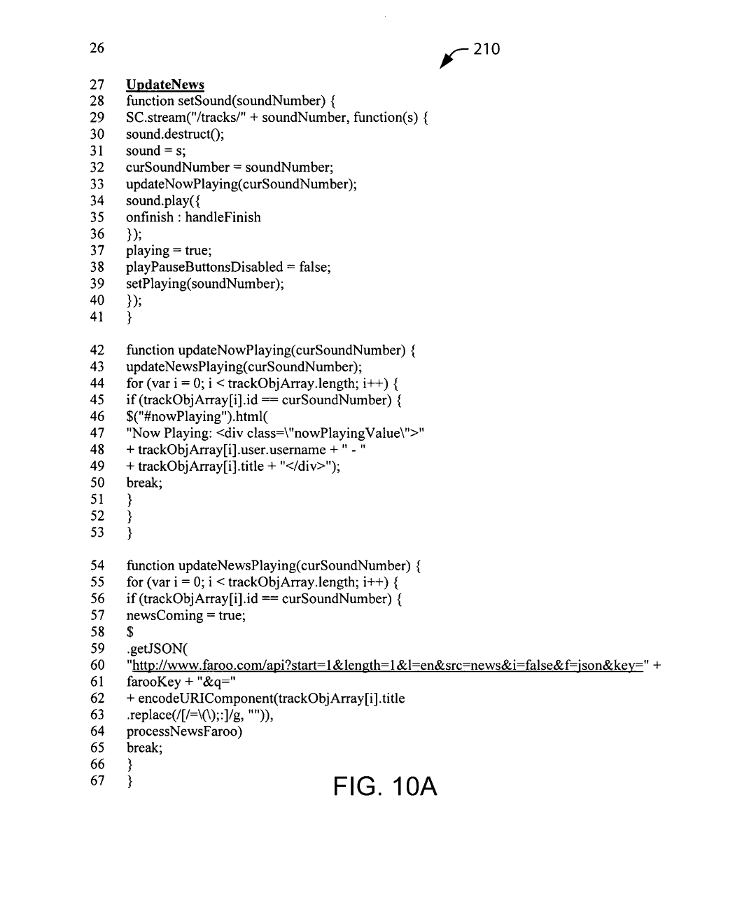

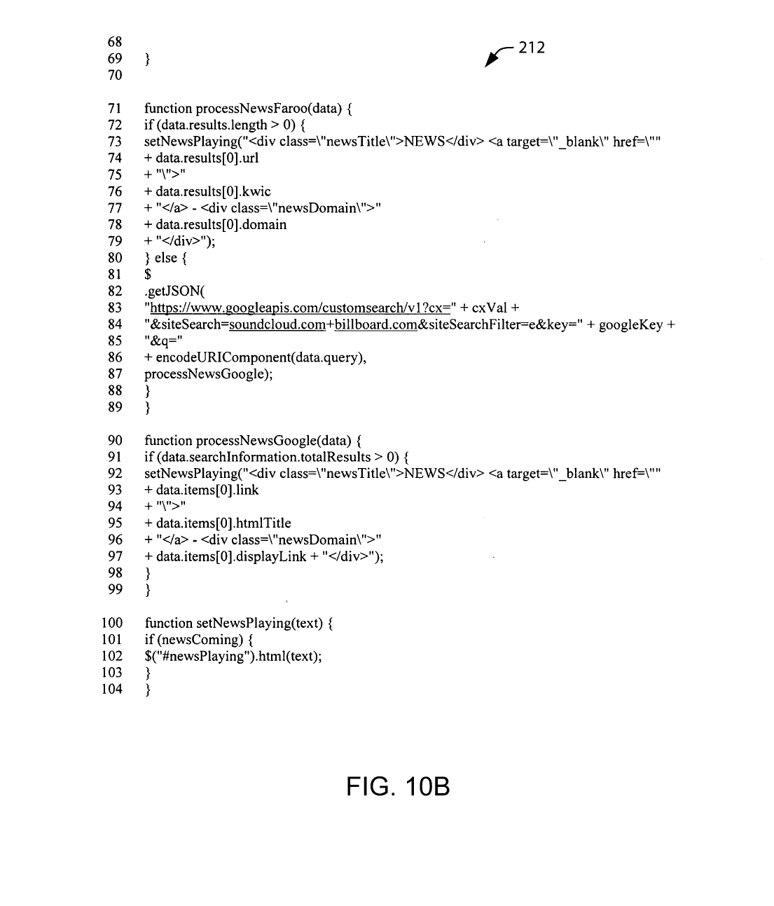

FIG. 4 is a logical flow diagram of a server-based news aggregation procedure, generally shown at 76, according to the system 10 of the present invention, with search for topical information being requested 78 by the server 20 relevant to a given audio file 32 that is being selected 34 for the playlist, the news being continually updated 80 while audio files 24 are being added 36 to the playlist as instructed in FIGS. 10A and 10B for the news aggregation 76, then the news which exists at 82 or not at 84 at decision point 86 is saved at True 88 or not at False 90 at decision point 92 until the mix-moment is published at which time the saved news is updated with more recent news 94 to be scrolled across the console of a User device 12 when the mix-moment 42 is selected. This parallel processing with audio files from source 24 and news aggregation from source 26 are as per the instructions in FIGS. 10A-B, which handle the news requests 96 in positive 98 and negative 100 feedback loops to find and save relevant news properly updated as desired.

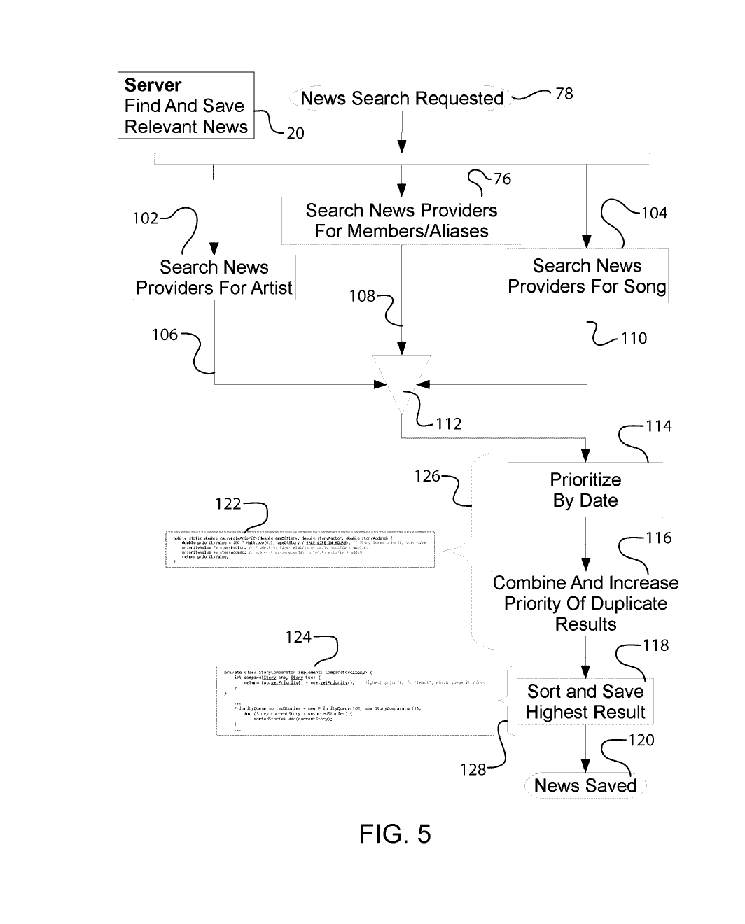

FIG. 5 shows in greater detail the server 20 based Find-and-Save function of the news aggregation procedure 76 of FIG. 4 according to the system 10 of the present invention, where a search 78 is requested of targeted news providers 26 or relevant news of artists 102, songs 104 and other information, e.g., meta-data, pertaining to audio files being aggregated, which results of each of the pathways 106, 108, 110 converge at point 112 in the audio and news aggregation parallel processes, according to Applicants' invention. These searches are prioritized by date 114 to combine and increase the priority of duplicate results 116, then sorted and saved 118 for the highest result so that the news is saved 120. Portions of the instructions 122, 124 are given for the steps in brackets 126, 128, respectively.

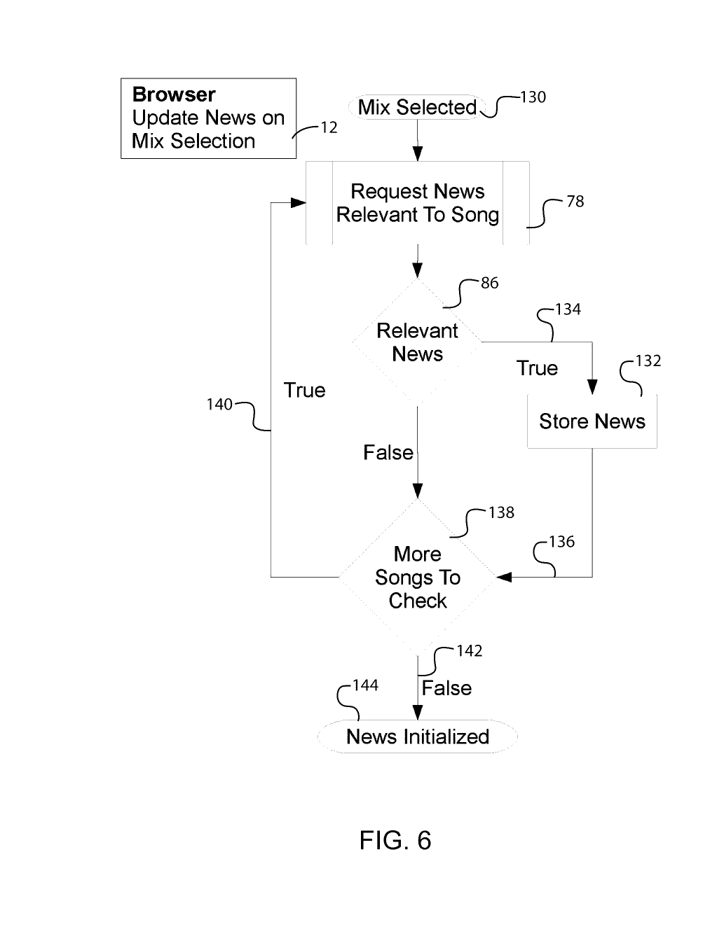

FIG. 6 shows browser-based (e.g., equipped with HTML 5) actions of the User device 12 upon mix-moment selection 130 according to the present system 10 and process 27, where the news 86 starts with the upload 42 of the mix-moment instructed by a User device 12, which news is stored 132 if True 134 (or False 135) to await 136 more songs 138 to check in a True 140 or False 142 feedback loop and is updated when a User plays the mix-moment 42, as parallel processing is undergone as per the preceding discussion herein, as the news is initialized.

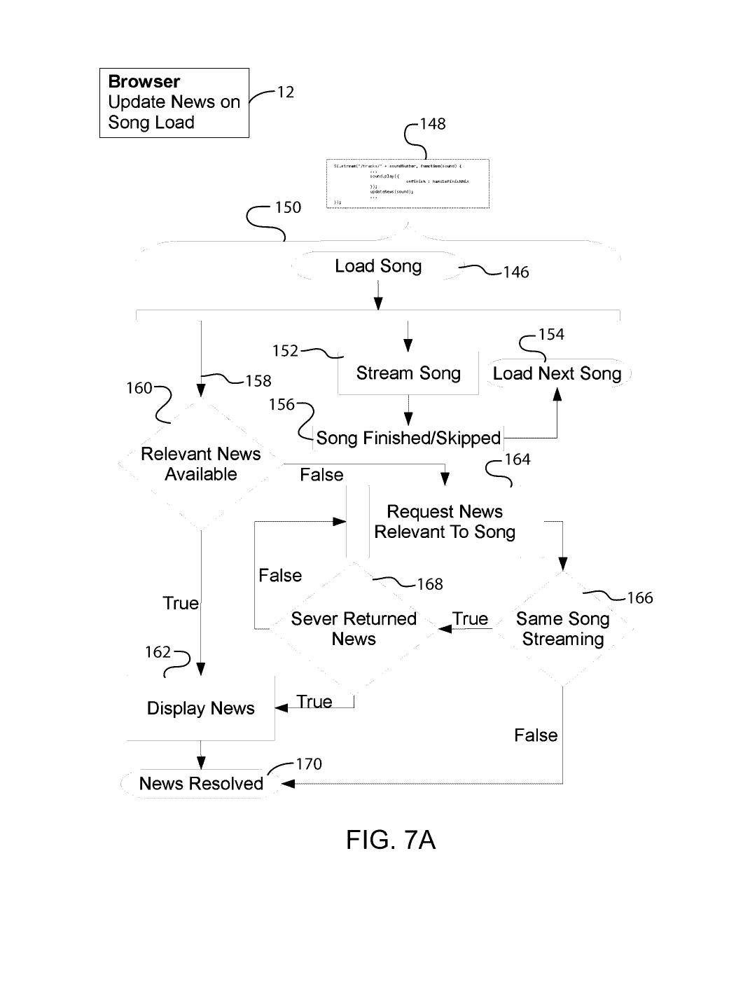

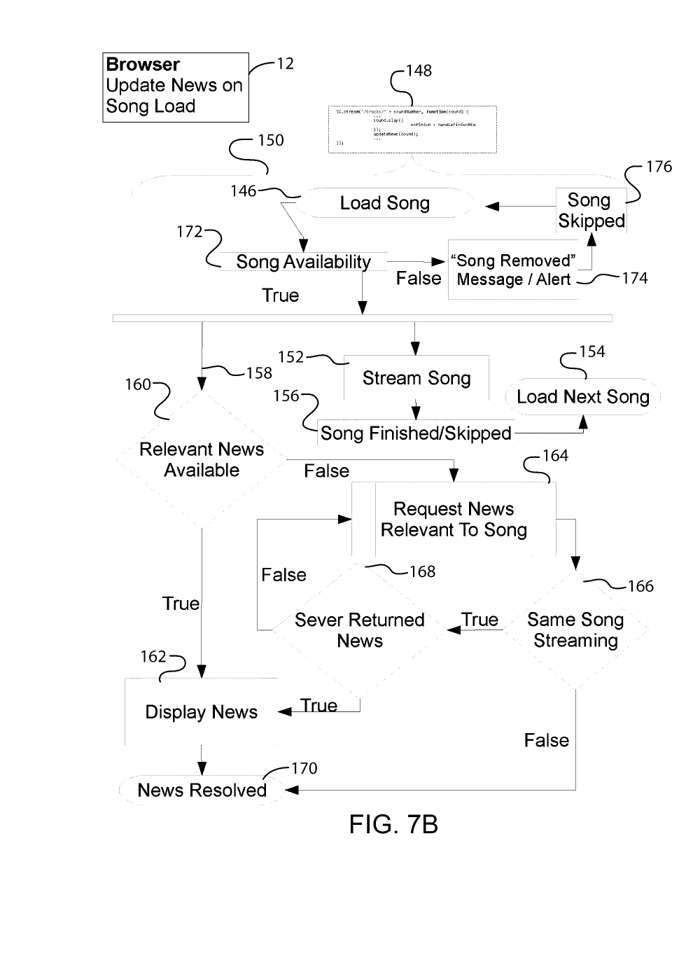

FIG. 7A shows browser-based actions of the User device 12 upon mix-moment selection 42 according to the present system 10 invention, where a song is loaded as per the instructions given at 148 for the steps indicated by bracket 150 from a published mix-moment 42 and streamed 152, its availability on the targeted media sources 24 verified, initiating streaming of the initial 152 and loading of the next song 154 when the preceding song is either finished or skipped 156. As song is loaded 146 this initiates the request for relevant news at which decision point 160 the news is either displayed 162 (True) or not (False) to request news relevant to song 164. This leads to a further decision point 166 that the server 20 returned news decision point 168 (True) to display news 162 (True) or feeds back (False) to request news 164 in feedback loop, in any event the news is resolved 170.

FIG. 7B is similar to FIG. 7A, but shows a further step of checking song availability 172, that is, whether a song loaded 150 has been removed at the audio source 24, resulting in a Message/Alert 174 in which case the particular song is skipped 176 in another feedback loop.

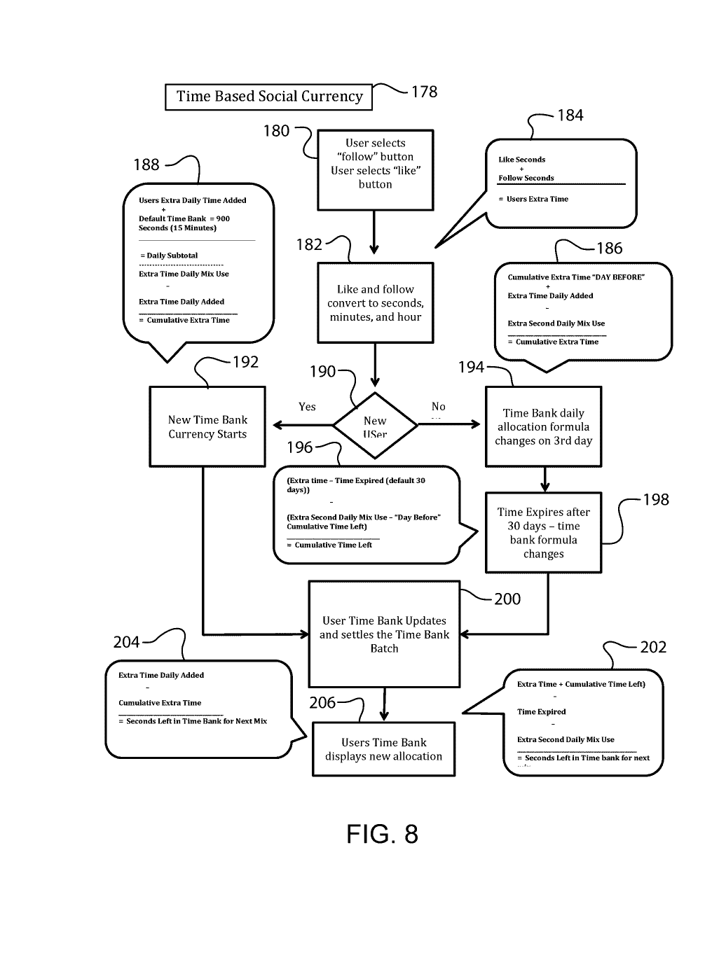

FIG. 8 shows the time-based social currency 178 of the present system 10 and method 27. This is one way that a User may accumulate extra time for use in published a “mix moment” 42. A User may press a “Like” and/or “Follow” button 180 on a device 12, in favor of another User and that other User can earn more time 182 to be added to their present or future “mix moments” according to a certain formula 184. This extra time accumulates from day to day 186. Each mix-moment a User is allocated a standard amount of time 188, e.g., fifteen minutes, which is measured by the combined length of the songs from an audio source 24, e.g., Soundcloud.com. The system processes the time bank accumulation by a decision point 190 with new Users 192 starting a new time-bank and existing Users a daily allocation formula that changes with the number of days 194. There is a default thirty day period, for example, after which time expires in the time bank, on a rolling basis 196 and a balance goes forward 198. The User time-bank up and settles the time bank batch 200. There are further allocation steps 202, 204 resulting in a User's time-bank displaying a new allocation 206 as the case may be. Users are encouraged to make the most of their allocated time, since unused time from one mix-moment does not roll over to a succeeding mix-moment, hence a User may wish to have more time to fit in another or a different song but not have the time available. However, if the User has been “liked” or “followed” then in each instance an amount of time, e.g., 2 seconds, is added

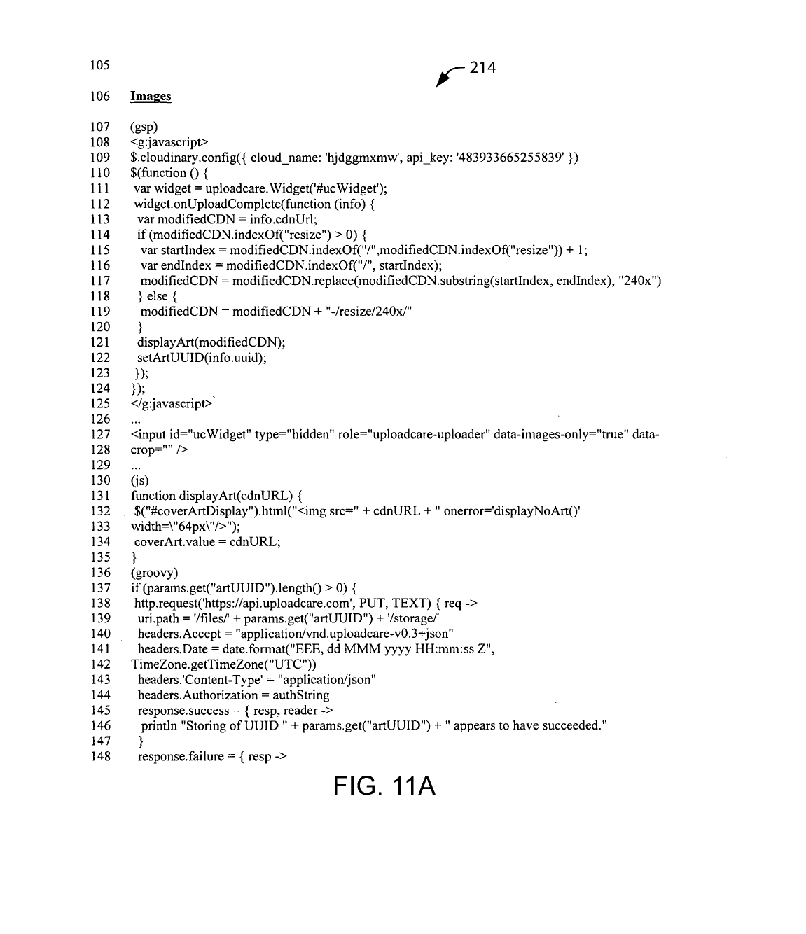

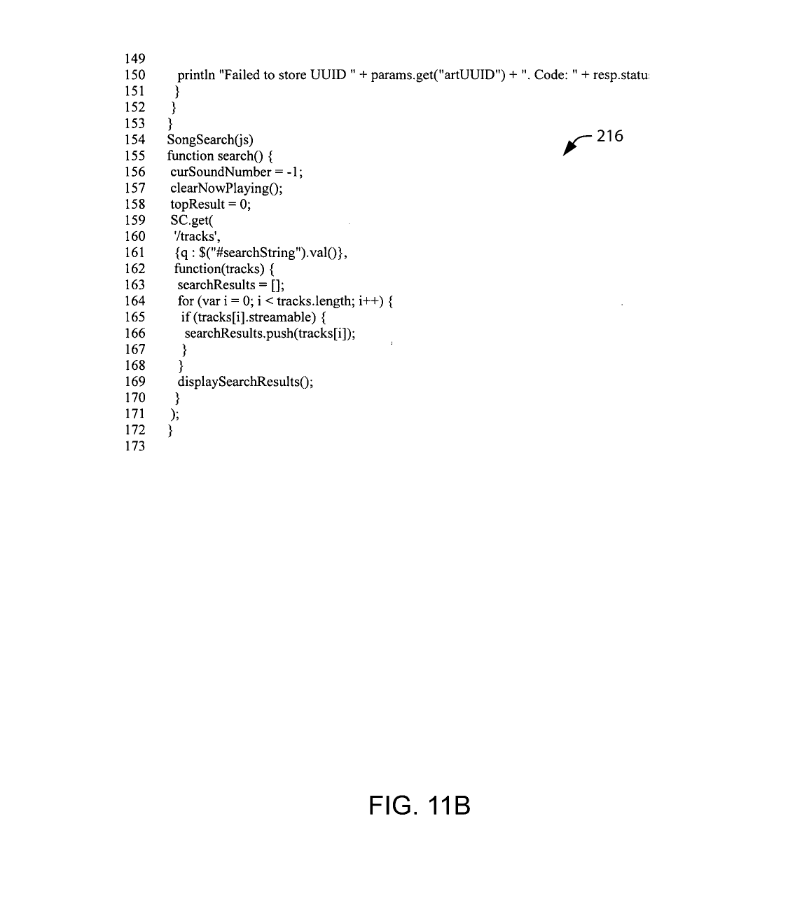

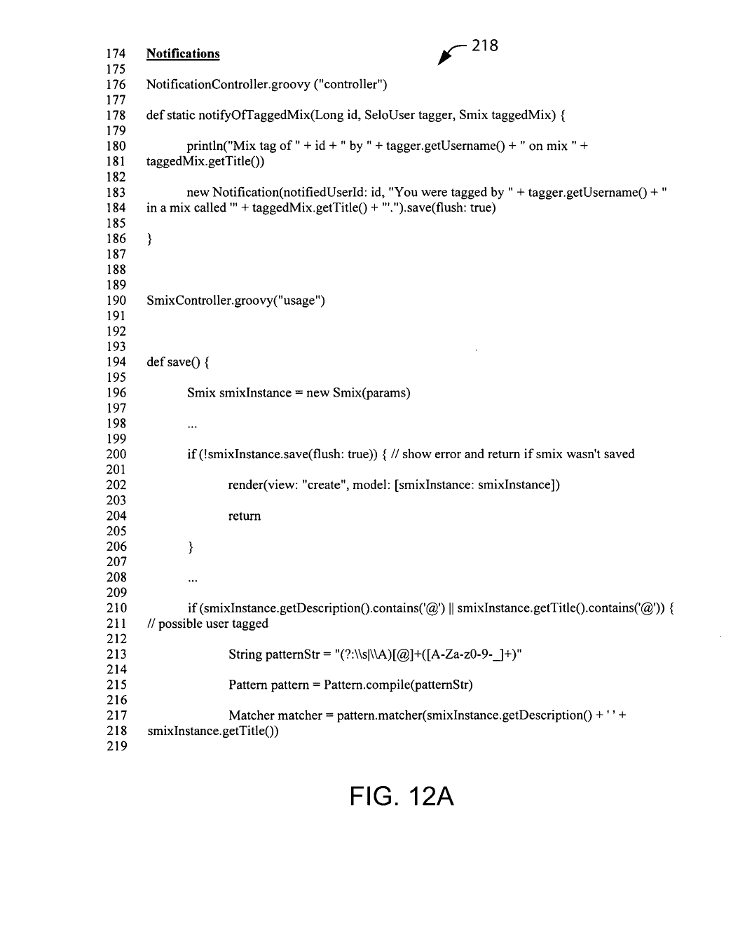

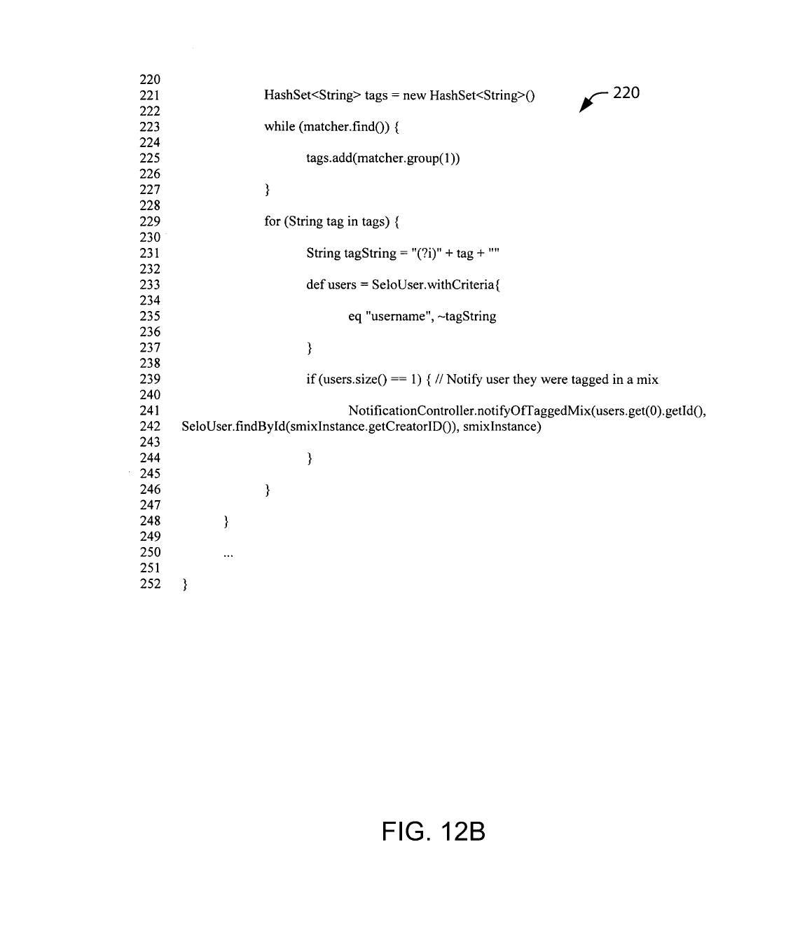

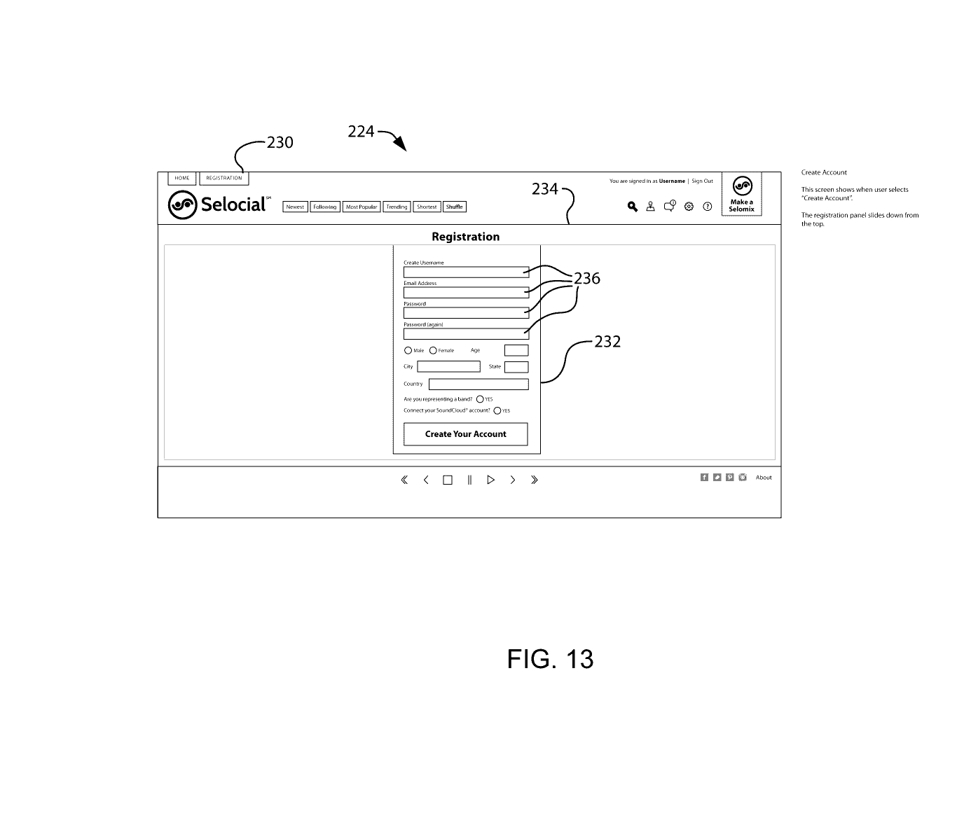

Accordingly, in its various embodiments, the present invention provides a system 10 for creating multimedia playlists from audio media sources 24. The system has a music module 150 that aggregates a multiplicity of sound files targeted by a User from one or more audio media sources 24 as a musical playlist having an elapsed unit of time in duration. A visual module 44 aggregates an image file targeted by the User from one or more visual media sources 22, as per the instructions in FIGS. 11A-11B at 210 and 212, respectively. News module 76 aggregates updated textual information targeted from one or more news sources 26, topically pertaining to the musical playlist, as per instructions in FIGS. 10A-10B at 210 and 212, respectively. A captioning module preferably 38 aggregates text manually entered by the User, describing the musical playlist. A time-based currency module 178 allocates a standard unit of time to each musical playlist and compares the standard unit of time to the elapsed unit of time. A publishing module 42 compiles the audio sounds, images, news and (optionally) text as a life-to-media moment. The moment is published 42 per instructions in FIG. 9 generally shown at 208. If the elapsed time unit is less than or equal to the standard time unit, in which case the moment is discretely displayed on a User interface console (see wireframes herein discussed) on a device 12, as the one or more sound files are streamed to other Users, when prompted by the system. Notifications are as per the instructions in FIGS. 12A-12B at 218 and 220, respectively.

Referring to FIGS. 13-27, preferably the system 10 has a distinctive console 224, which displays multiple mix-moments 42 in mix-cards 226, respectively published by multiple Users, together in a pre-determined sequence which, more preferably has the mix-moments displayed in chronological order. Even more preferably, a selected mix-moment 228 is highlighted as it is played by a User manually by navigating the console 226 or a mix-card may be played automatically by the system 10. The various functionalities of console 224 are discussed in greater detail further below.

Still preferably, the system visual module 44 further targets images from locations selected from those accessible via the internet, private network or local User drive.

Yet preferably, the system news module 76 further updates continually with topical information, which is automatically displayed on the console 224, as a moment 42 is being played by a User or by the system 10.

Also preferably, the system captioning module 38 has separate title and description random entry lines.

Also preferably, the system currency module 178 further dispenses additional standard time units earned by the User according to value criteria defined by the currency module, which enables the User to extend the elapsed time unit beyond the standard time unit.

Also preferably, the system publishing module 42 further displays the image and text for each moment on a card that can be manually flipped to display a reverse side for User commentary or other information.

According to the present invention, there is provided a method for creating multimedia playlists comprising several steps. One step involves targeting a multiplicity of sound files from one or more audio media sources 24 and aggregating the sound files in a music module 76, for each playlist. Another step involves registering allocated mix duration in a time module 178 and referencing elapsed mix duration versus the allocated mix duration, for each playlist. Yet another step involves targeting at least one image file from one or more visual media sources 22 and aggregating the image file in a visual module 44 for each playlist. Still another step involves targeting topical textual information pertaining to at least one of the sound files from one or more news sources 26 and aggregating the textual information in a news module 76, as the sound file is added to the playlist. Again, another step involves compiling the aggregated sound files and image file and updating the aggregated topical information, ascertaining that the elapsed mix duration is less than or equal to the allocated mix duration, then publishing the files and updated text as an audiovisual playlist, discretely displaying each audiovisual playlist on a User interface console as the sound files are played, respectively.

Preferably, the method step of publishing includes multiple playlists, by separate Users, displaying the playlists in a pre-determined sequence on the console 224 of a device 12 and, more preferably, displaying the playlists in chronological order of publication; even more preferably is a step of navigating the multiple playlists on a console and manually playing the sound files by Users or automatically in a predetermined order.

Still preferably, in the above method there is a step of targeting visual sources 22 selected from those accessible via the internet, private network or local User drive, in the visual module.

Yet preferably, in the above method there is a step of continually updating the topical information in the news module 76 and automatically displaying the topical information on the console 224, as a sound file is being played by a User.

Yet still preferably, in the above method there is a step of providing a text input window 38 for manually entering a title or caption by the User. Further preferably, there is a step of increasing the allocated mix duration according to selected value criteria in a time-bank 178, enabling the User to extend the elapsed mix duration beyond the allocated playlist duration. Even yet preferably, in the above method there is a publishing step displaying the image and text for each mix-moment 42 on a card 226 that can be manually flipped to display a reverse side for User commentary or other textual information.

In the screen of FIG. 13 is a console 224 for a User device equipped with the present system, showing the User registration procedure. When a User selects the Registration button 230 at the upper left margin of console 224 on the Homepage, a “Create Account” registration panel 232 slides down from a top margin 234. Panel 232 contains entry boxes 236 that call for User to enter Name, e-mail address and Password information labelled as shown in FIG. 13. Similarly, there are biographical information entry boxes 238, after which the User clicks on the Create Your Account button 240 to complete the Registration Process.

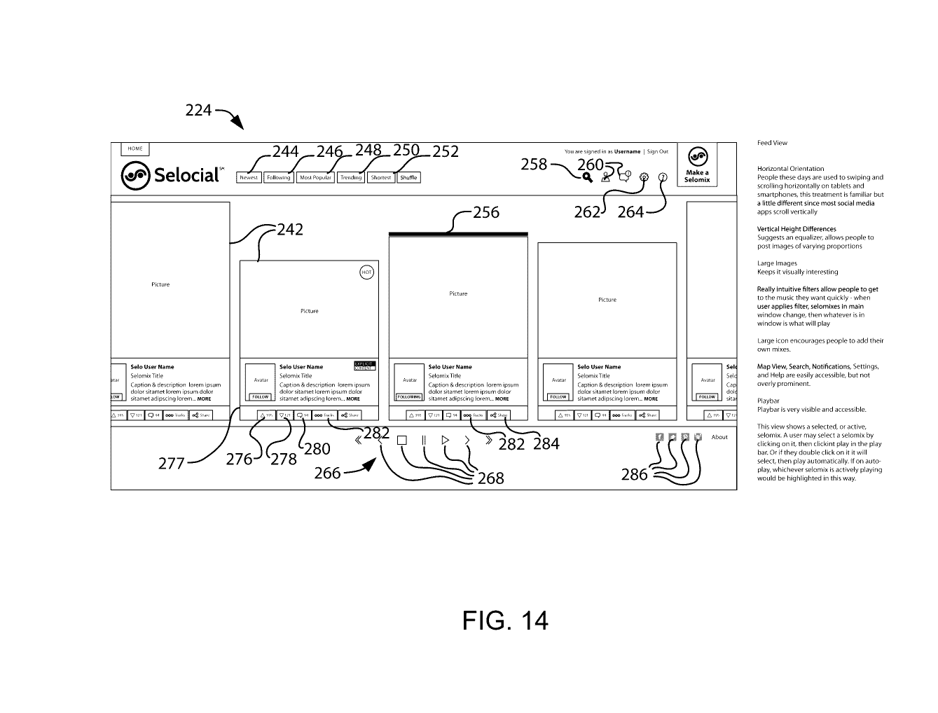

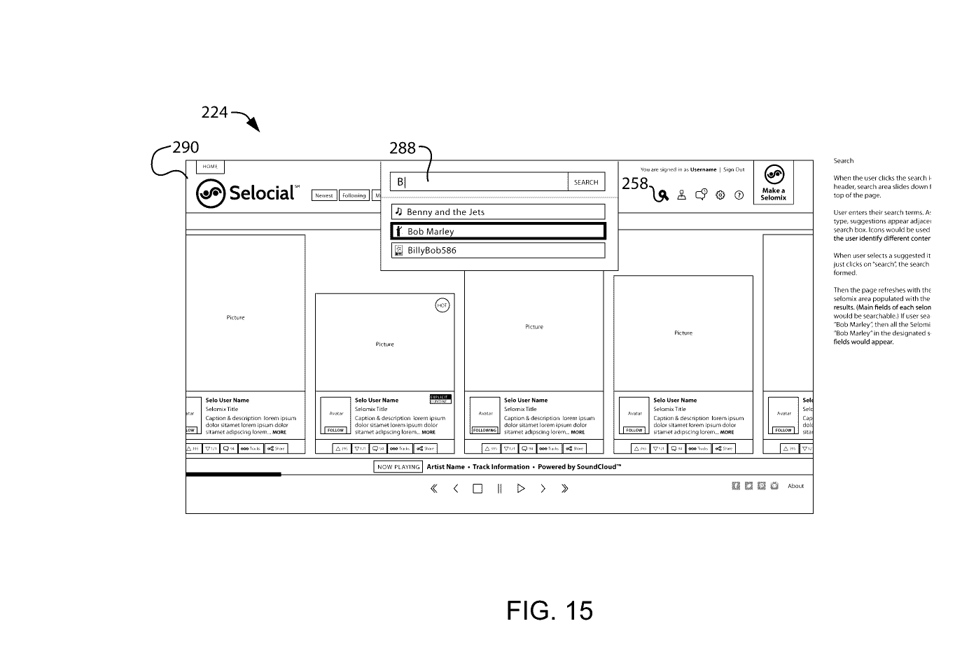

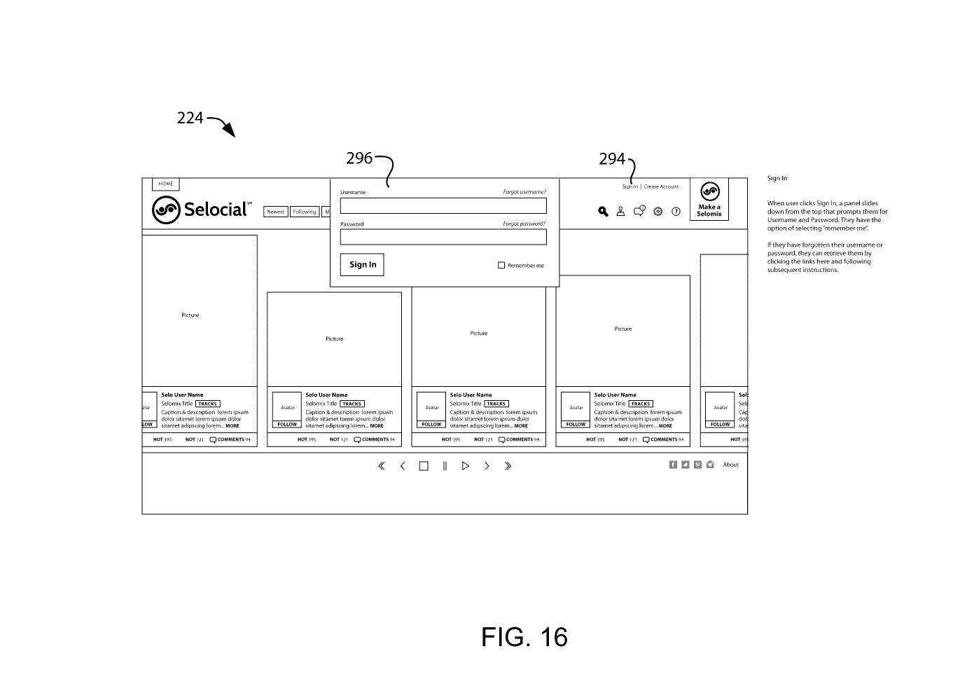

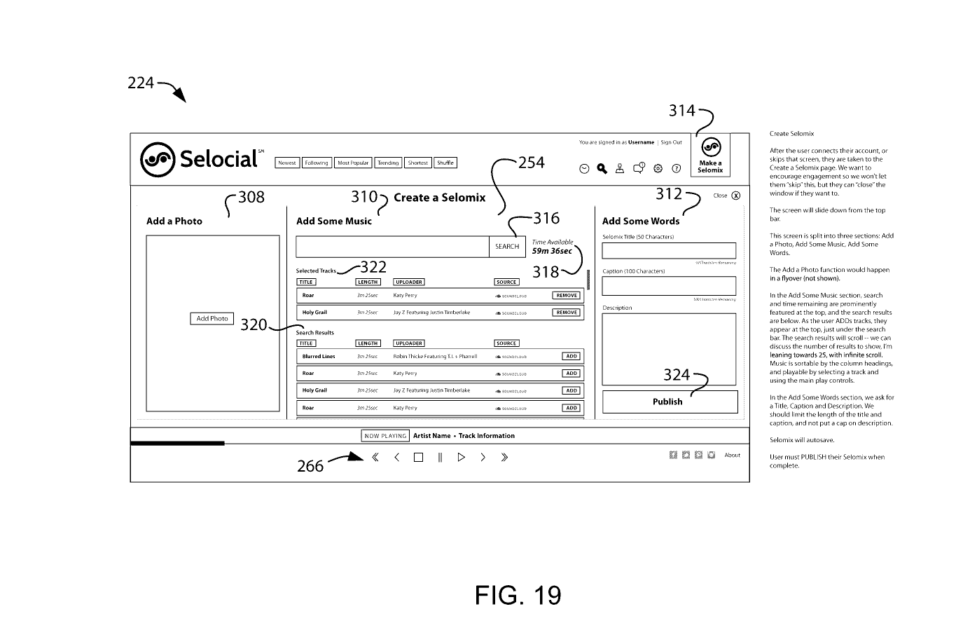

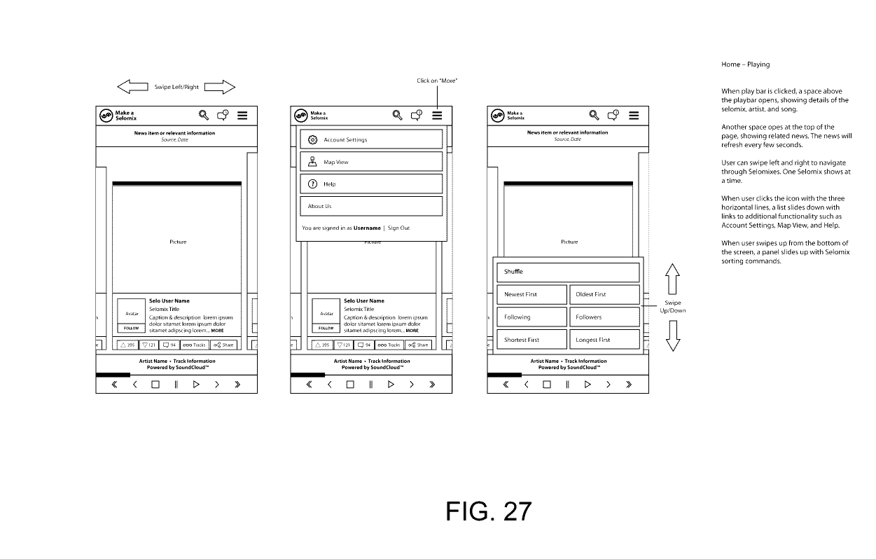

In FIG. 14, with respect to horizontal orientation, Users in a prospective User Base currently are familiar with swiping and scrolling horizontally on tablets and smartphones, yet this treatment is somewhat different since most social media apps scroll vertically (see FIG. 27). Therefore vertical height differences exist which suggests an equalizer in the User Interface (UI), i.e., allowing Users to post images in the spaces 242 of varying proportions for mix-cards 226. Large images seek to keep the process visually interesting. Intuitive filters controlled by various buttons, such as Newest 244, Following 246, Most Popular 248, Trending 250 and shortest 252 filters that allow Users to get to the music they want quickly. Thus a User may apply a filter, which can be reflected in the mix-making screen (FIG. 19) and other screens elsewhere in FIGS. 13-27. Mix-making in the main audio selection window 254 of the screen in FIG. 19, which changes, then whatever is in the main window is what will play. A large icon size implicitly encourages Users to add their own mix-moments viz. the mix-cards 226. The currently playing mix-moment is highlighted as at card 256. Buttons for Search 258, Notifications 260, Settings 262, and Help 264 are easily accessible, but not overly prominent. The play-bar 266 is visible and accessible with the other audio 268 and mix-card advance 270 buttons. This view (FIG. 14) shows a selected, or active, Mix-moment. A User may select a Mix-moment by clicking on it, as aforementioned at 256 then clicking to play in the play bar 266. Or if the User will double click on a mix-card 256, this will select, then play it automatically. If on auto-play, whichever mix-card 256 is actively playing would be highlighted in this way by the heavy upper border 272. Other features of each card 226 representing a Mix-moment include, an Avatar 274 that may be chosen by a User to identify Mix-moments he/she has created. Below Avatar 274 are buttons that include “Thumb-up” 276 or “Down” 278, Notes 280 that appear on the flip-side of the card along with a list of audio tracks 282 and a “Share” button that copies the URL for the Mix-card 226 so that the location may be sent to another User who is already registered or which may be sent via e-mail or social media 286 buttons to a non-registered User, i.e., “Open Sharing”. The above-described features have been set forth with respect to FIG. 14, however, the controls in console 224 operate similarly in the various FIGS. 15-27 which follow and to which the controls pertain. Therefore these controls will not be repeated for the sake of conciseness, nor are reference numerals used except where particular features pertain to a given FIG. 13-27.

In the screen of FIG. 15 there is a console for a User device equipped with the present system, showing the site-wide search function window 288 by clicking the Search control button 258, whereby User mix-moments and profiles may be searched for artists, songs and other words of interest. The User clicks the search icon 258 in the header 290 of console 224, a search panel 292 slides down from the header 290 at the top of the console 224. User enters their search terms. As they type, suggestions appear adjacent to the search box. Icons may be used to help the User identify different content types. When User selects a suggested item, or just clicks on “Search”, the search is performed. Then, the webpage with console 224 refreshes in the browser of User with the main (mix-making) area populated with the search results. The main fields of each mix-moment card 226 would be searchable. If User searches for a named artist, then all the mixes with that artist in the designated search fields would appear as shown in FIG. 15.

In FIG. 16, a User clicks the button labelled “Sign In” 294 and a panel 296 slides down from the top of console 224 that prompts User for their Username and Password in the boxes labelled as such. They have the option of selecting “remember me” in panel 296. If they have forgotten their Username or password, they can retrieve them by clicking the links indicated and following subsequent instructions.

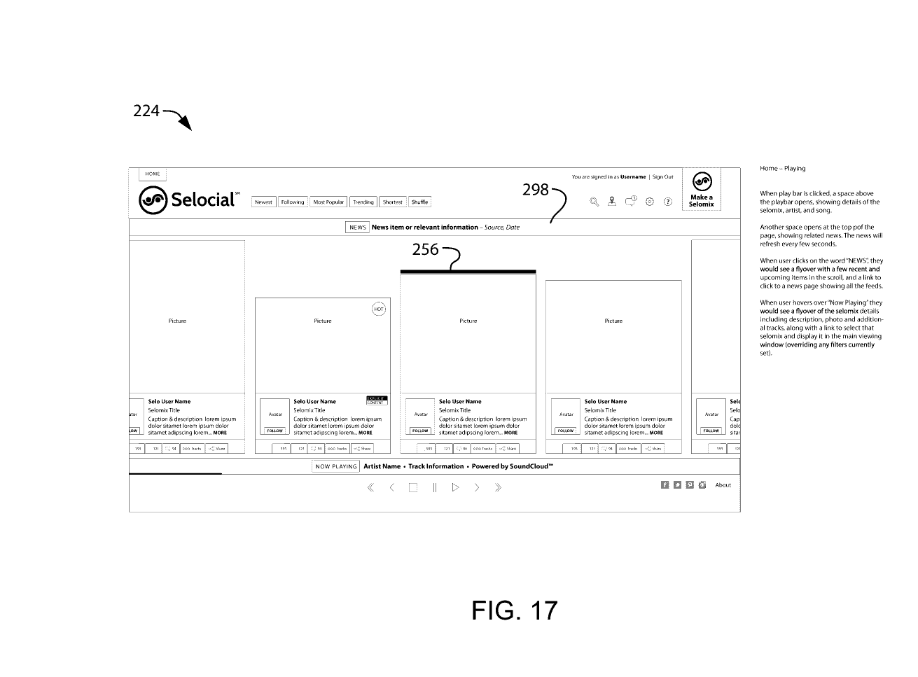

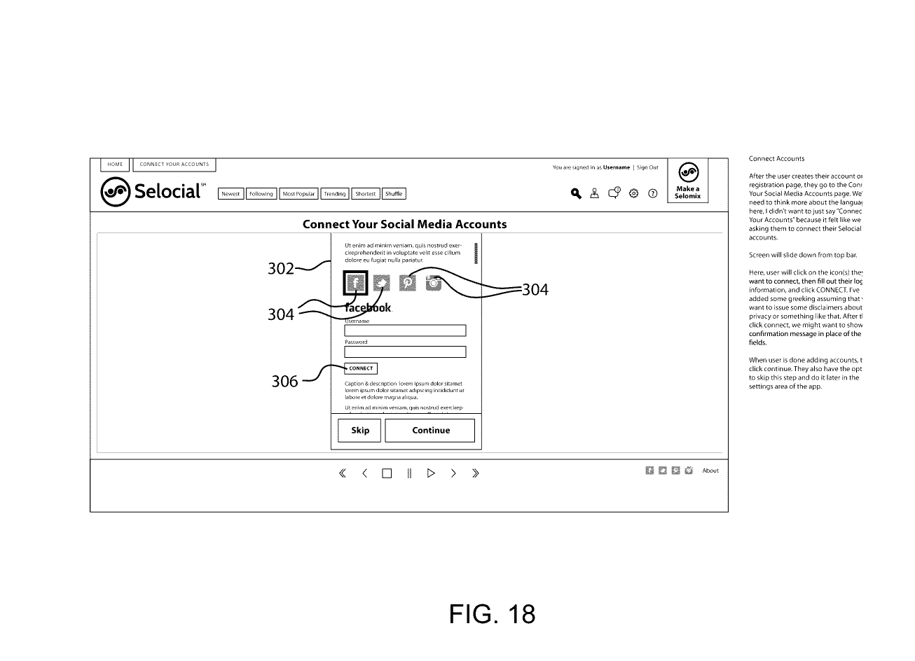

In FIG. 17, when play bar 266 is clicked, a space above the play bar opens, showing details of the mix-moment card 256, such as artist and song. Another space 298 opens at the top 234 of the console 224, showing related news. The news will refresh every few seconds.

As shown in FIG. 18, after the User creates their account on the above described registration page, they go to the Connect Your Social Media Accounts panel 302 that will slide down to view. Here, User will click on the icon(s) for the social media services 304 they want to connect, then fill out their login information in the boxes indicated on panel 302, and click a CONNECT button 306. There are added spaces to issue some disclaimers about privacy. After the User clicks CONNECT, a confirmation message may show in place of the form fields. When User is done adding accounts, they click continue. They also have the option to skip this step and do it later in the settings area of the application.

In FIG. 19 after the User connects their account, or skips that screen (FIG. 18), they are taken to the Create a Mix-moment display shown in three sections named Add a Photo 308, Add Some Music 310 and Add Some Words 312. Or, the make a mix button 314 may be clicked. To encourage engagement, Users are not allowed to “skip” this, but they can “close” the window if they want to at the button labelled Close, which exits the Mix-moment creation display. The screen will slide down from the top bar. This screen is split into the afore-mentioned three sections: Add a Photo 308, Add Some Music 310, and Add Some Words 312. In the Add Some Music section 310, Search box 316 and Time Remaining tally 318 are prominently featured, and the search results are below at 320. As the User ADDs Selected Tracks at 322, they appear at the top, just under the search bar 316. The search results 320 will scroll with the number of results shown being variable, there can be e.g., 25 with infinite scroll, or broken down in sequential screens as desired. Music is sortable by the column headings TITLE, LENGTH, UPLOADER and SOURCE and playable by selecting a track and using the main play controls 266. In the Add Some Words section 312, User is asked for a Title, Caption and Description as indicated. The length may be limited as to the Title and Caption, and may or may not be on the Description. The mix-moment will auto-save until User presses PUBLISH when their mix-moment creation is complete. Otherwise, the mix-moment will not save if the PUBLISH button is not clicked.

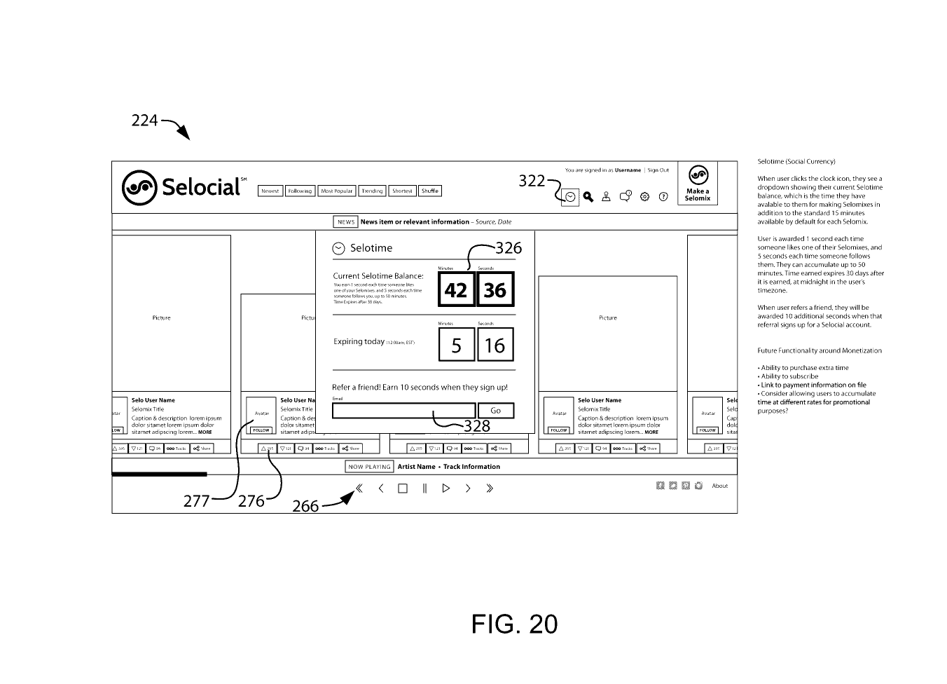

In FIG. 20, when User clicks a clock icon 322, they see a dropdown time panel 324 showing their current time balance at 326, which is the time they have available to them for making Mix-moments in addition to the standard e.g., 15 minutes, available by default for each Mix-moment. User is awarded e.g., 1 second each time someone “Thumbs-up” 276 one of their Mix-moments, and e.g., 5 seconds each time someone “Follows” them at 277. They can accumulate up to e.g., 50 minutes. Time earned expires e.g., 30 days after it is earned, at midnight in the User's time zone. When User refers a friend at box 328, they will be awarded 10 additional seconds when that referral signs up for a Selocial account. Again, the above are examples. Functionality may be provided around Monetization, with ability to purchase extra time, to subscribe, and to link to payment information on file. Optionally, Users may be able to accumulate time at different rates for promotional purposes.

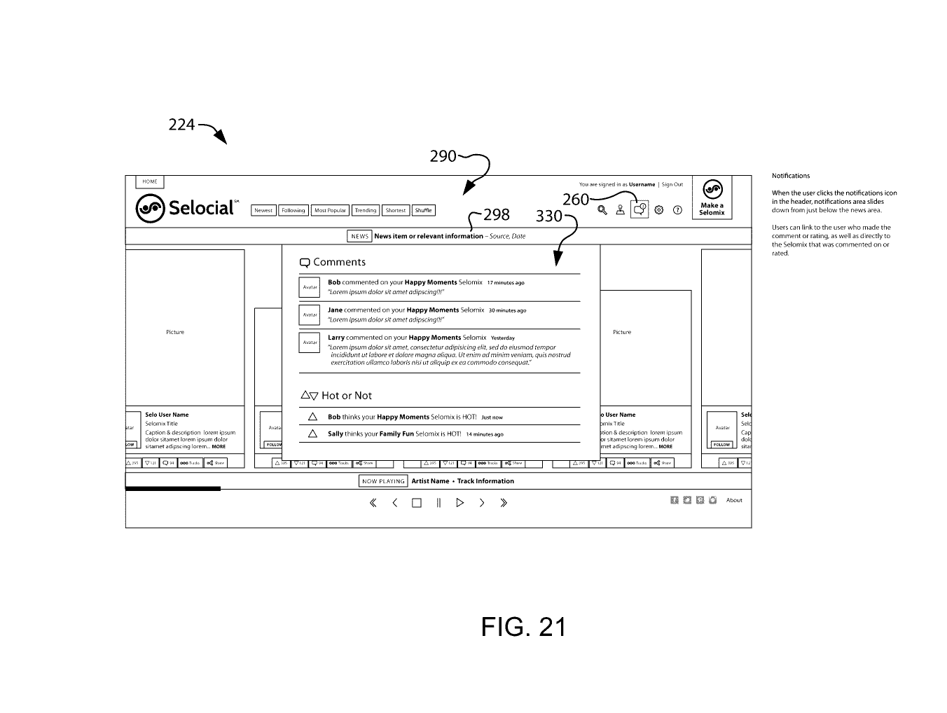

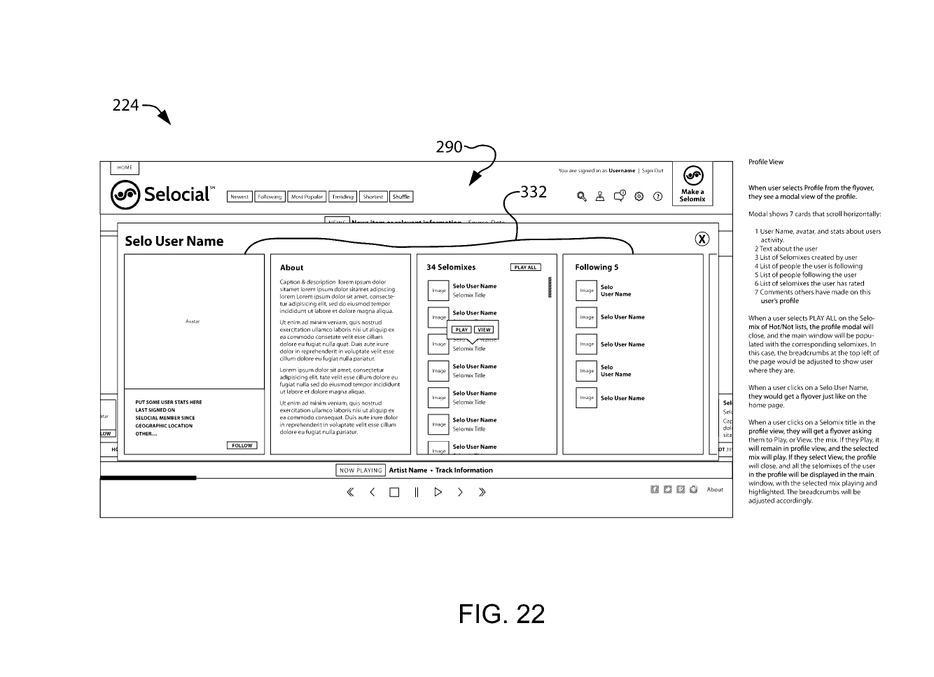

In FIG. 21, when the User clicks the notifications icon 260 in header 290, a notifications panel 330 slides down from just below the news area 298. Users can link to the User who made the comment or rating, as well as directly to the Mix-moment that was commented on or rated.

In FIG. 22, there is shown an optional configuration of a Profile search and display. When User selects another User's name adjacent avatar 274 (FIG. 14) an array 332 may be presented in a Modal view that shows e.g., 7 cards that scroll horizontally. These may include User Name, avatar, and stats about Users activity, as indicated, Text about the User, list of Mix-moments created by User, list of Users the User is following, list of Users following the User, list of Mix-moments the User has rated, and comments others have made on this User's profile. When a User selects PLAY ALL on the Mix-moment of Hot/Not or Active lists, the profile modal will close, and the main window will be populated with the corresponding Mix-moments.

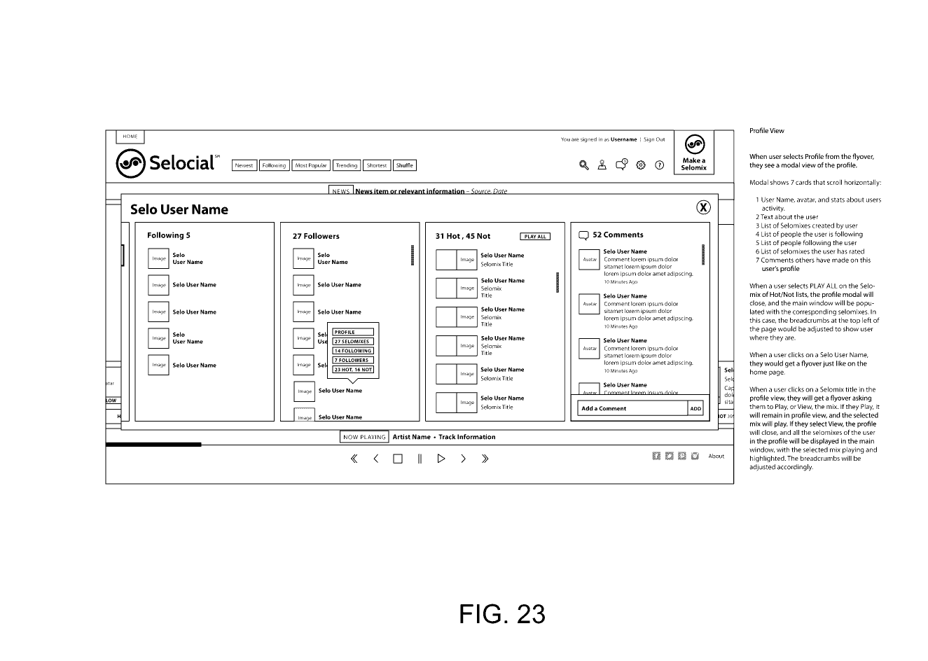

In FIG. 23 is seen a further continuation of the screen array exemplified in FIG. 22.

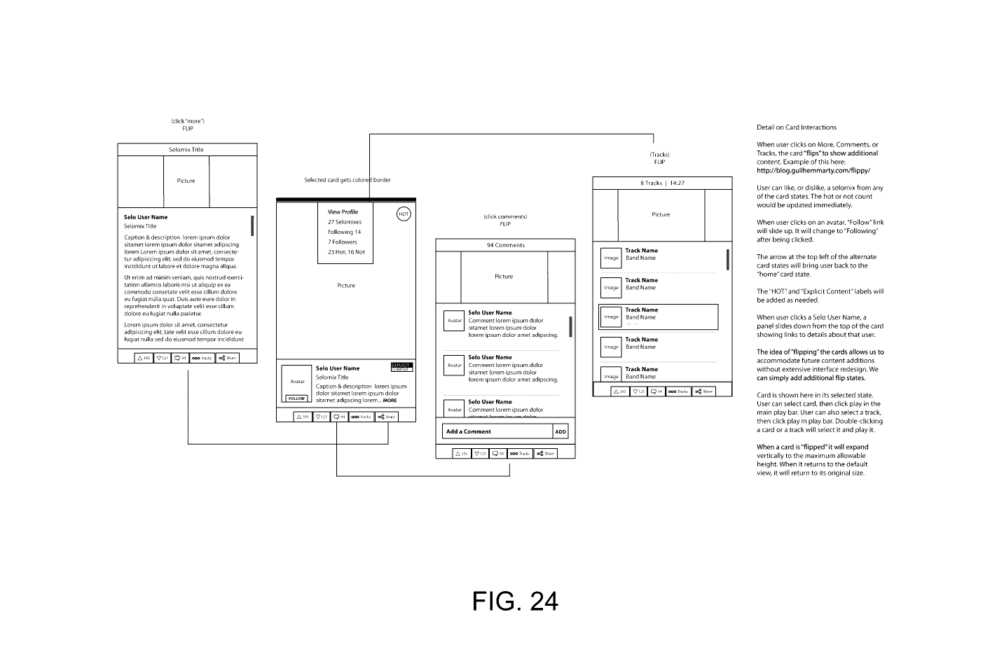

In FIGS. 24-27 as hereafter described, references to features made in the preceding Descriptions will be obvious when viewed in conjunction with the notations correspondingly made in these Figures. When User clicks on More, Comments or Tracks, the card “flips” to show additional content. An example of this can be accessed at http://blog.guilhemmarty.com/flippy/. Users can like, or dislike, a Mix-moment from any of the card states. The hot or not count can be updated immediately. When a User clicks on an avatar, a “Follow” link will slide up. It will change to “Following” after being clicked. The arrow at the top left of the alternate card states will bring a User back to the “home” card state. The “HOT” and “Explicit Content” labels will be added as needed. When a User clicks another User's name, a panel slides down from the top of the card, showing links to details about that User. A colored dot to the left of that User Name indicates that User is currently signed in. The idea of “flipping” the cards allows the accommodation of future content additions without extensive User interface redesign. One can simply add additional flip states. A card is shown here in its selected state. A User can select the card, then click play in the main play bar. The User can also select a track, then click play in the play bar. Double-clicking a card or a track will select it and play it. When a card is “flipped” it will expand vertically to the maximum allowable height. When it returns to the default view, it will return to its original size. Date Formats can be indicated on the cards, for example, 5 minutes ago (after 59 minutes, go to 1 hour), 4 hours ago (after 23 hours, go to 1 day), 2 days ago (after 6 days go to 1 week), 3 weeks ago (after 3 weeks, 6 days, go to date), 10 December (no year until there is a previous year), 31 Dec. 2013.

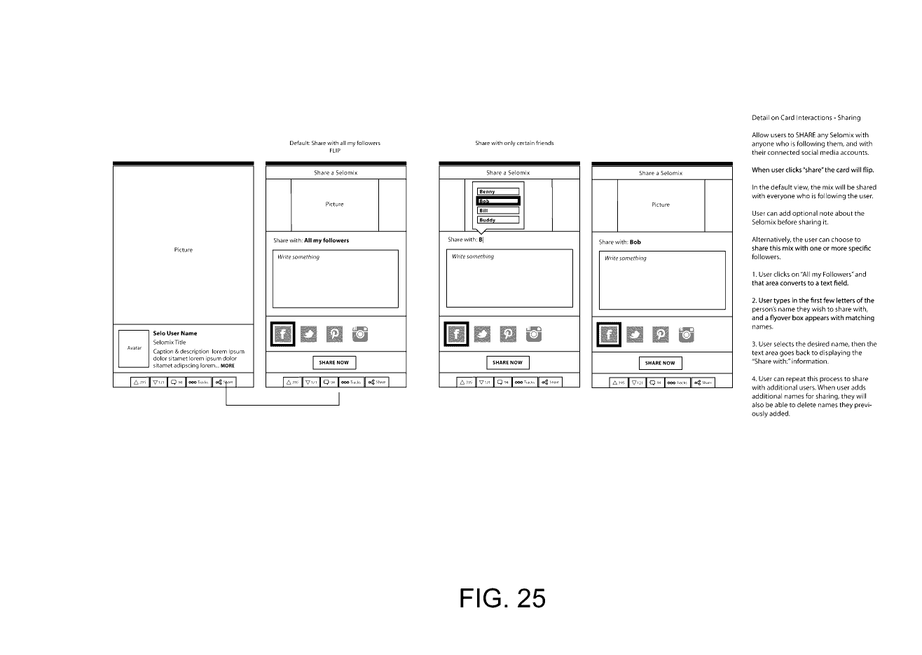

In FIG. 25, continuing from FIG. 24, the card interaction allows Users to Share any Mix-moment with anyone who is following them, and with their connected social media accounts. When a User clicks “SHARE” the card will flip. In the default view, the mix will be shared with everyone who is following the User. User can add optional note about the Mix-moment before sharing it. Alternatively, the User can choose to share this mix with one or more specific followers. First, User clicks on “All my Followers” and that area converts to a text field. Second, User types in the first few letters of the person's name they wish to share with, and a flyover box appears with matching names. Third, User selects the desired name, then the text area goes back to displaying the “Share with:” information. Fourth, User can repeat this process to share with additional Users. When User adds additional names for sharing, they will also be able to delete names they previously added.

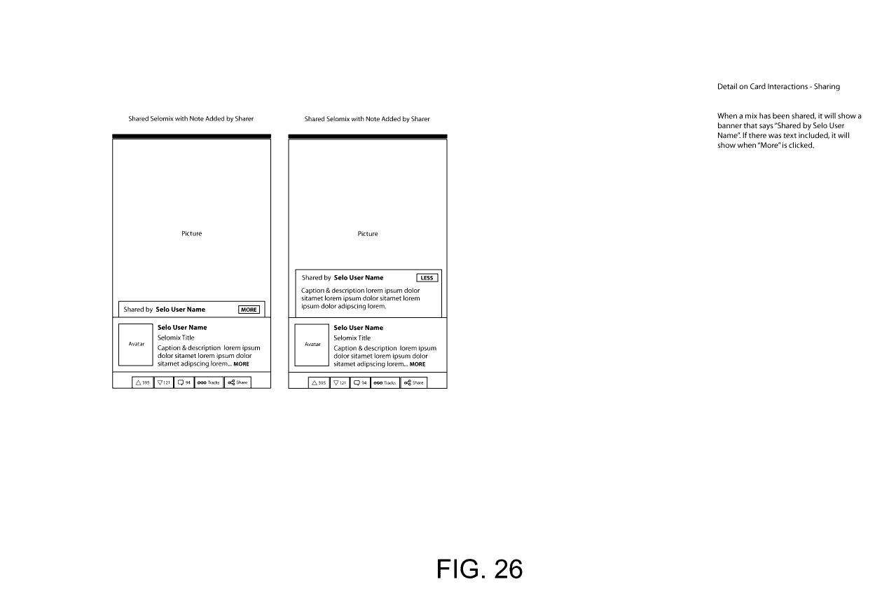

In FIG. 26, when a mix has been shared, it will show a banner that says “Shared by Selo User Name”. If there was text included, it will show when “More” is clicked.

In FIG. 27, showing an example of a card playing a mix-moment on a smartphone equipped with WiFi and browser-enabled, when play bar is clicked, a space above the play bar opens, showing details of the Mix-moment, artist and song. Another space opens at the top of the page, showing related news. The news will refresh every few seconds. User can swipe left and right to navigate through Mix-moments. One Mix-moment shows at a time, when User clicks the icon.

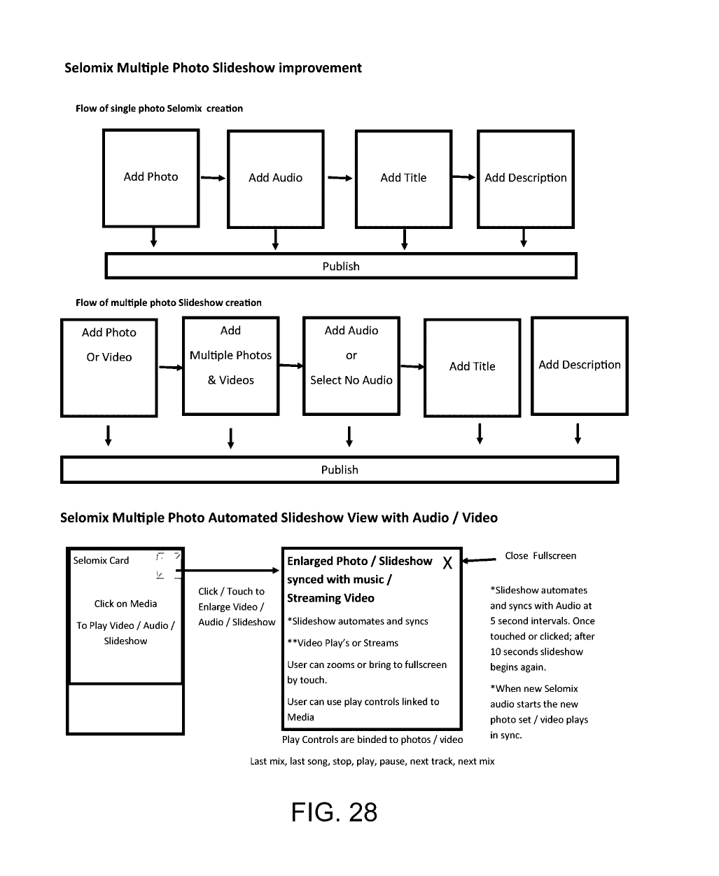

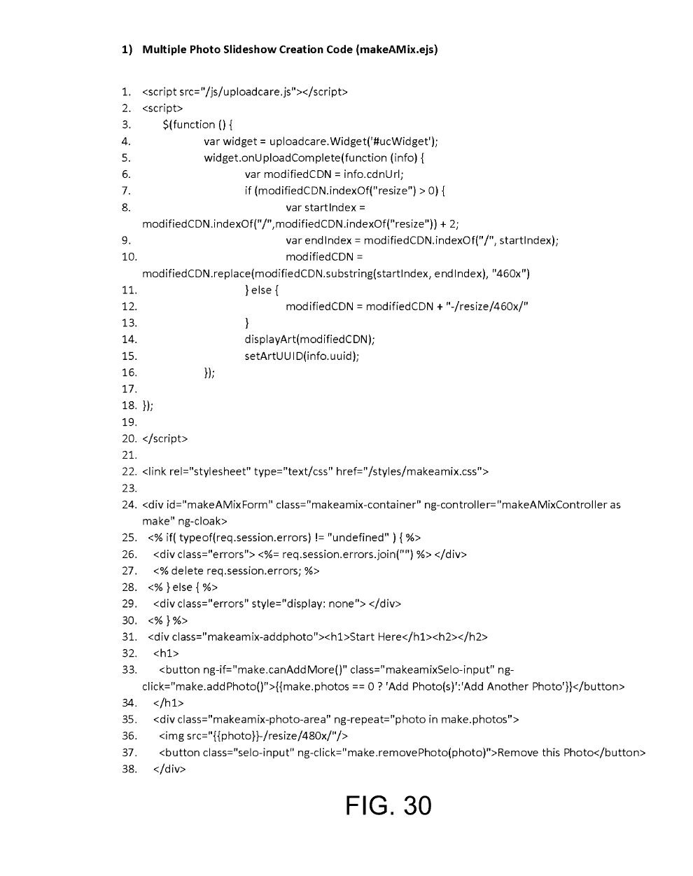

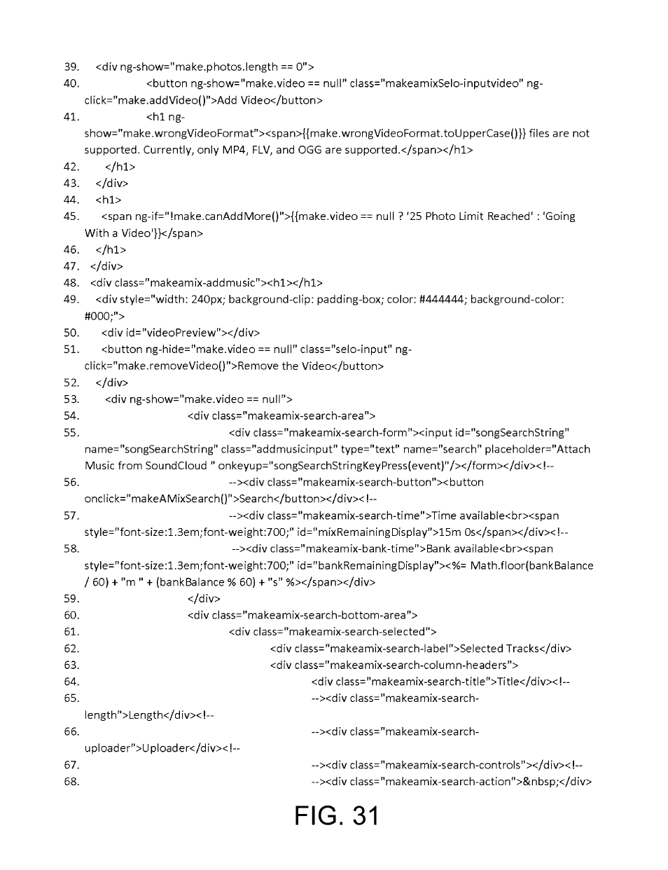

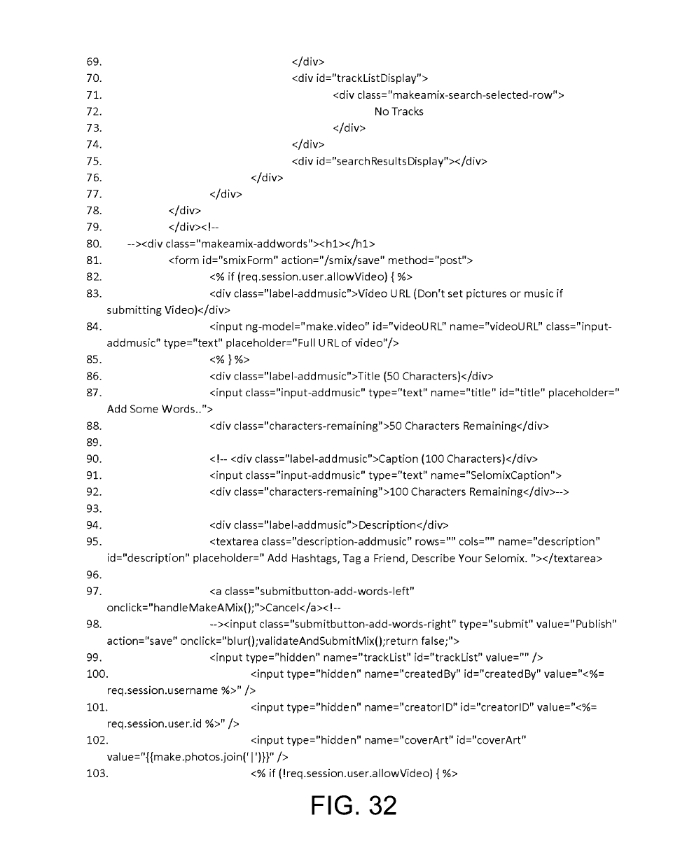

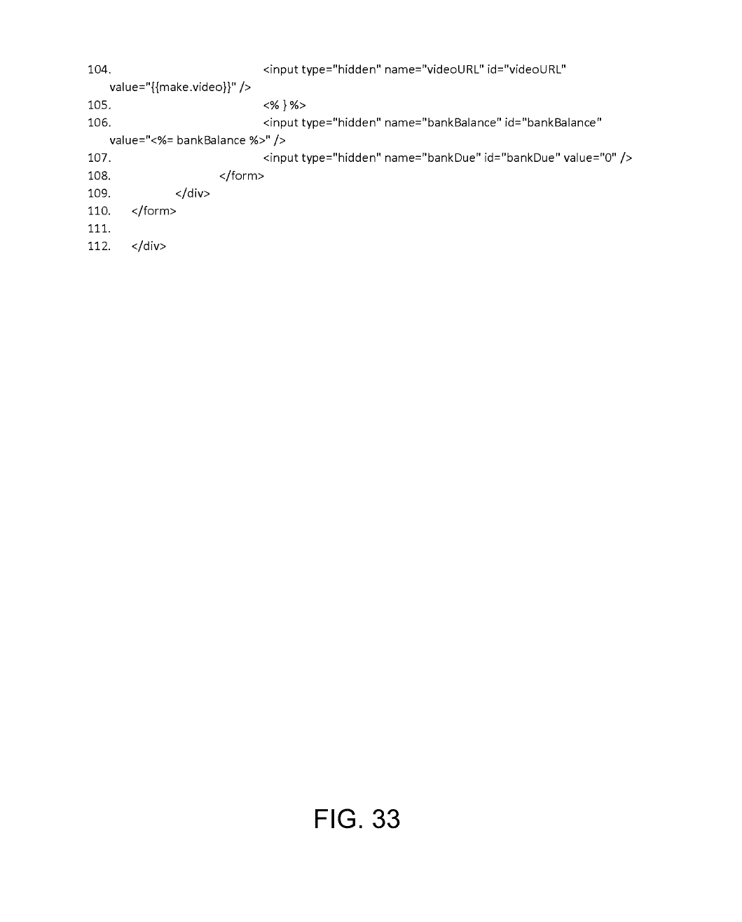

In FIG. 28 there is shown a logical flow diagram 500 depicting the various upload options possible with the present system for making Mix-moment creations, i.e., a single photo in the top-most horizontal tier, below which is a horizontal tier representing a multiple photo slideshow with audio or an integrated audio-visual file, in the case of video a FlowPlayer brand video player is available commercially and initialized by the present system, process and software instructions given in part by FIGS. 30-35, Lines 1-37 mentioned below. User clicks on a Create button which opens the Mix-moment card 226,/Mix Creation screen. User can choose either to add photo(s) or video. After adding photo(s) or video, User can choose music instantly to add to their photo(s). If video is chosen no audio can be added. After choosing or not choosing audio, the User Titles and describes their mix/playlist and publish their mix. Videos and Photos display in a slideshow.

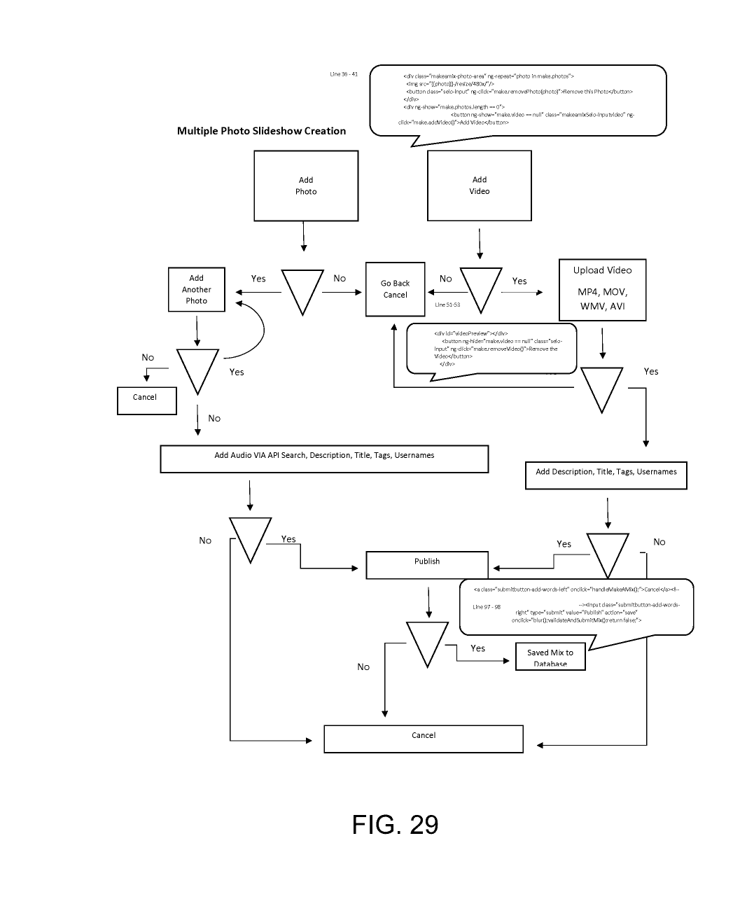

In FIG. 29, a logical flow diagram 502 shows the mix-creation process, controlled by instructions contained in the code bubbled-out in this FIG. 29, which is in turn abstracted from the Multiple Photo Slideshow Creation Code of FIGS. 30-35 below.

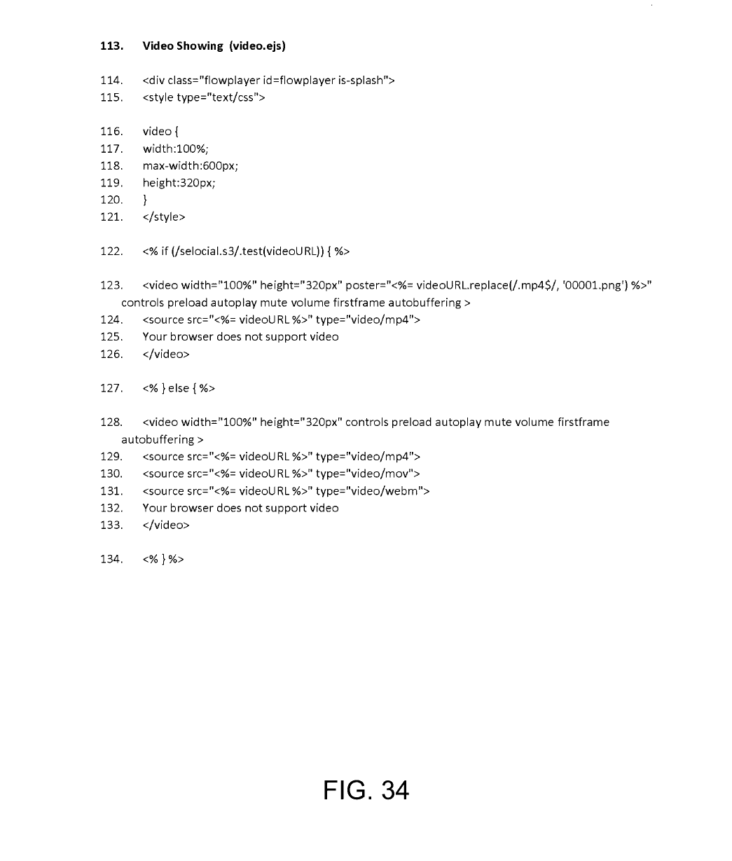

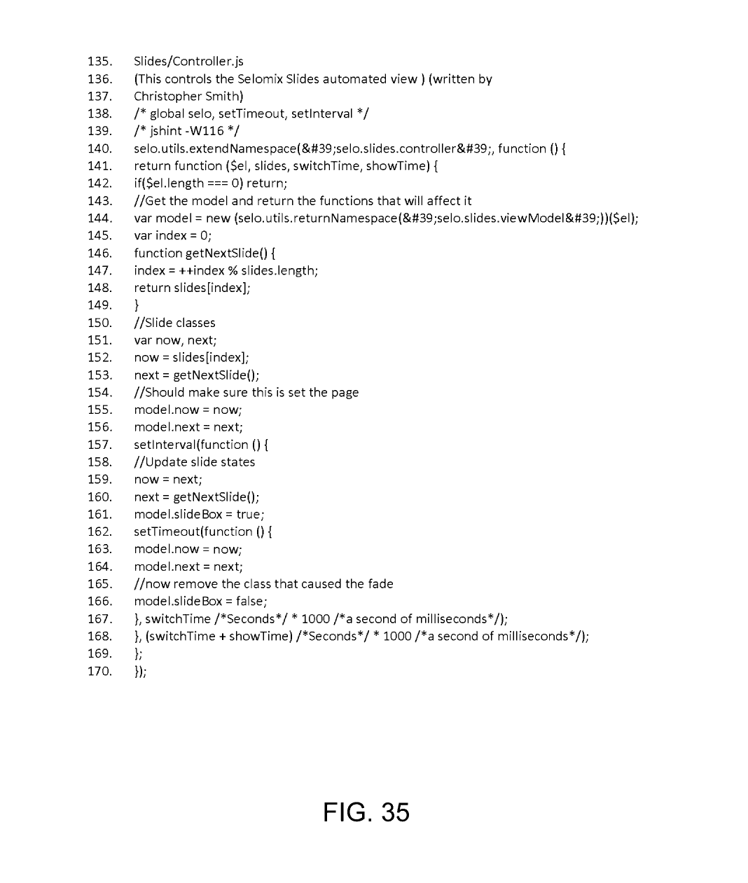

In FIG. 30, there is given a Listing of “Multiple Photo Slideshow Creation Code”, particularly Lines 1-38, portions of which instructions are bubbled-out in pertinent portions of the logic diagram of FIG. 29, further continued in FIGS. 30-33, Lines 39-112, respectively. Lines 113-137 of FIGS. 34-35 pertain to the Video Showing instructions.

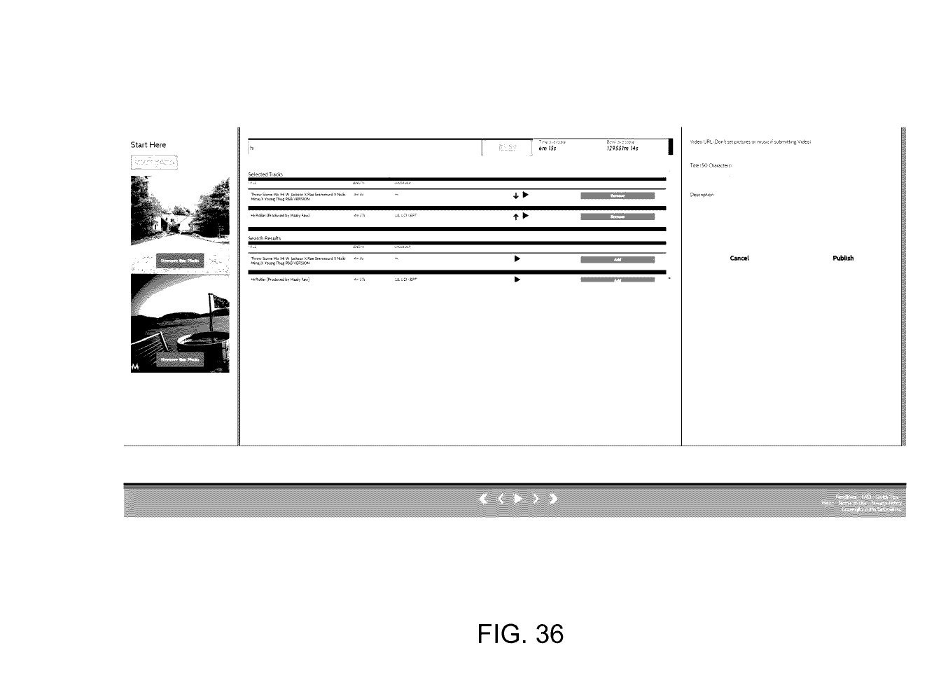

In FIG. 36, there is shown an enlarged mix-card indicating a video capture file that goes with the mix-moment.

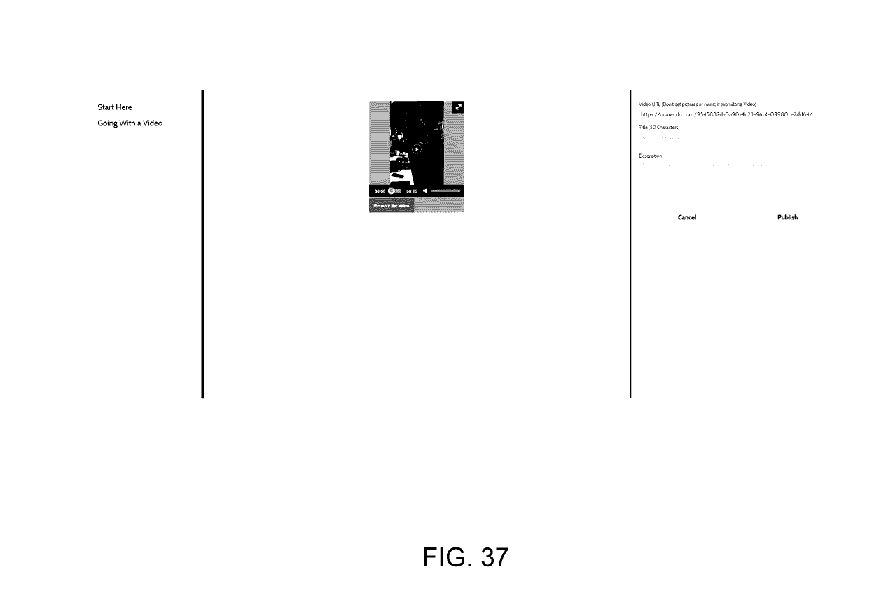

In FIGS. 36-37 there is shown screen captures of the slideshow (FIG. 36) and video (FIG. 37) mix-making operations.

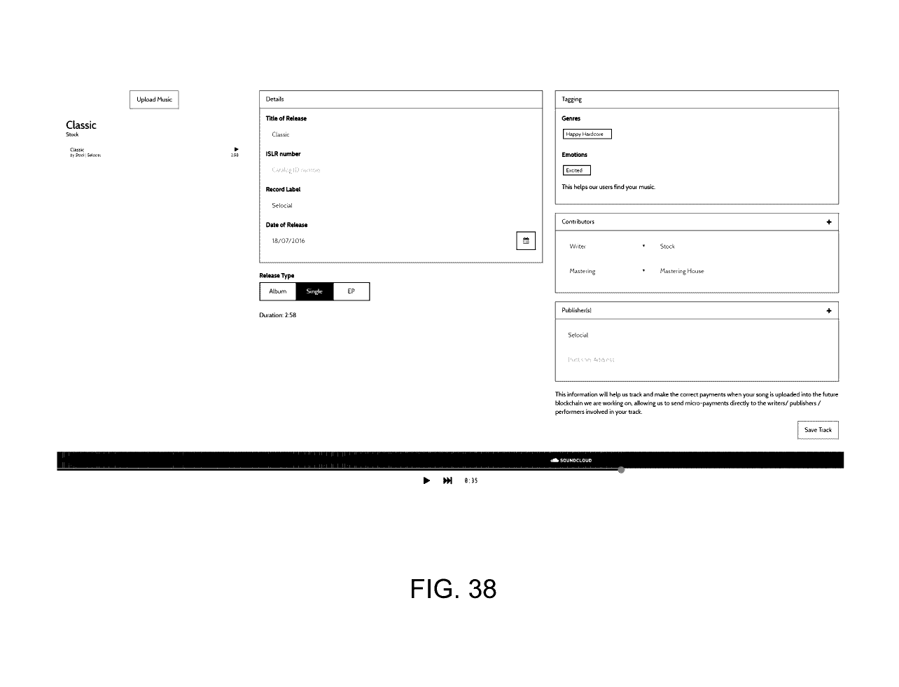

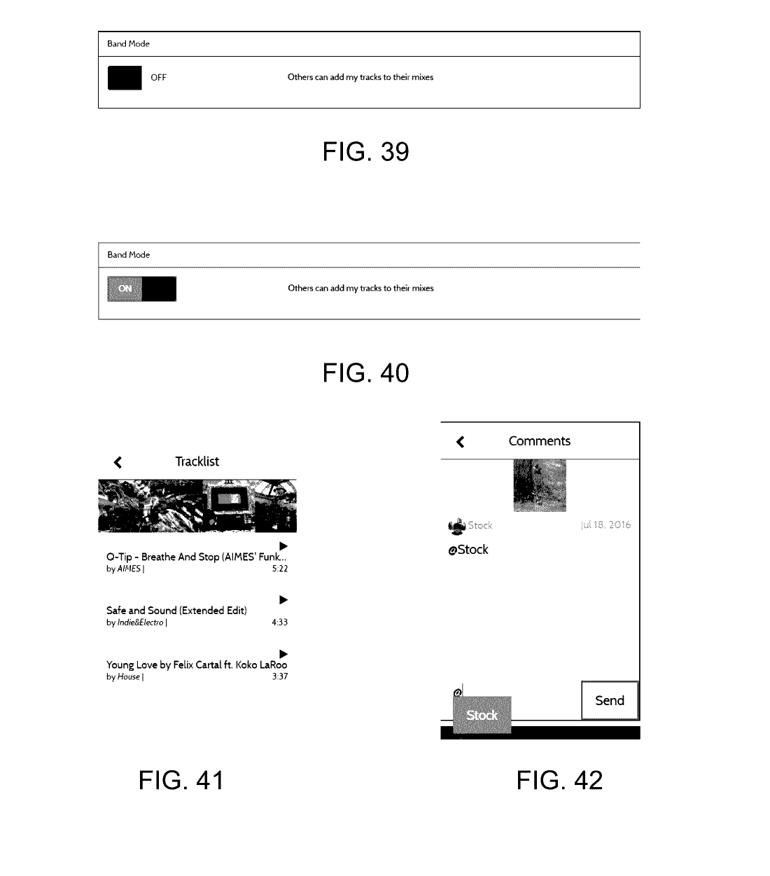

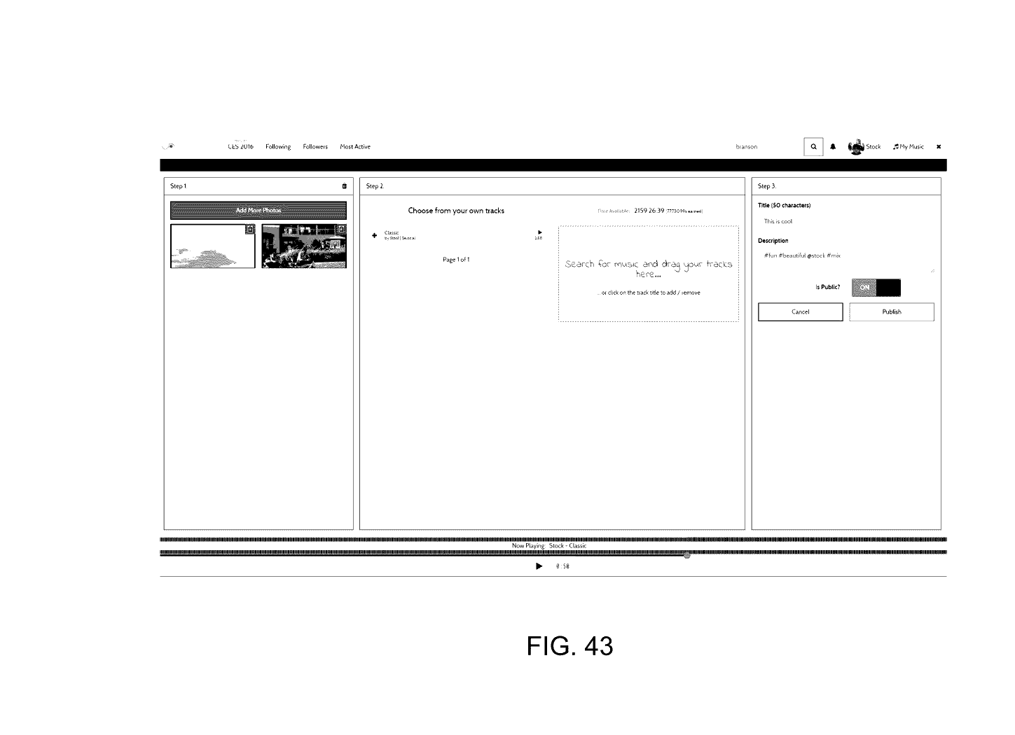

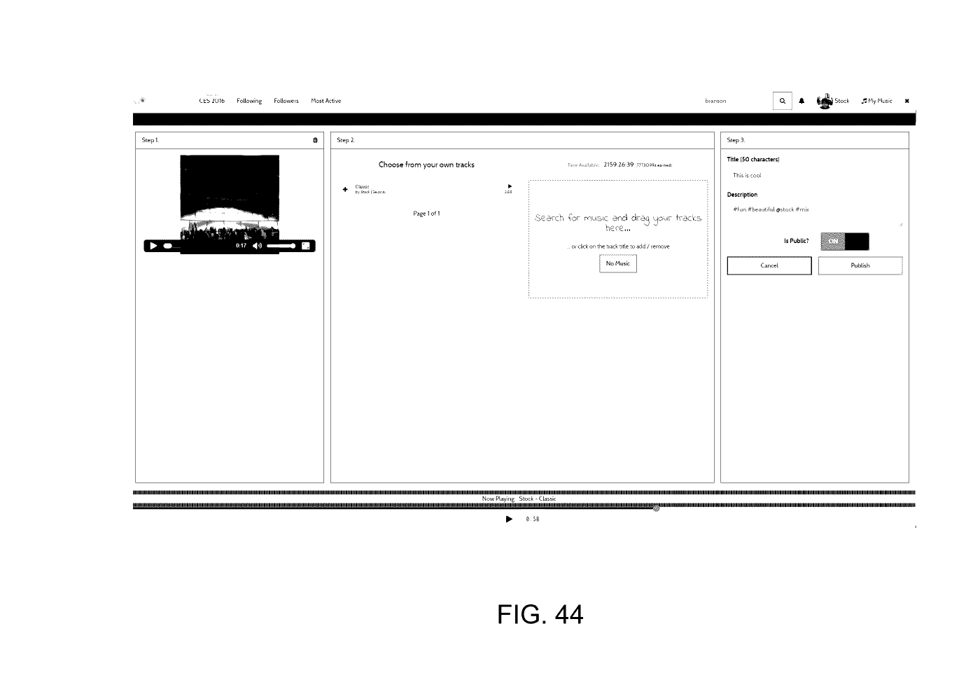

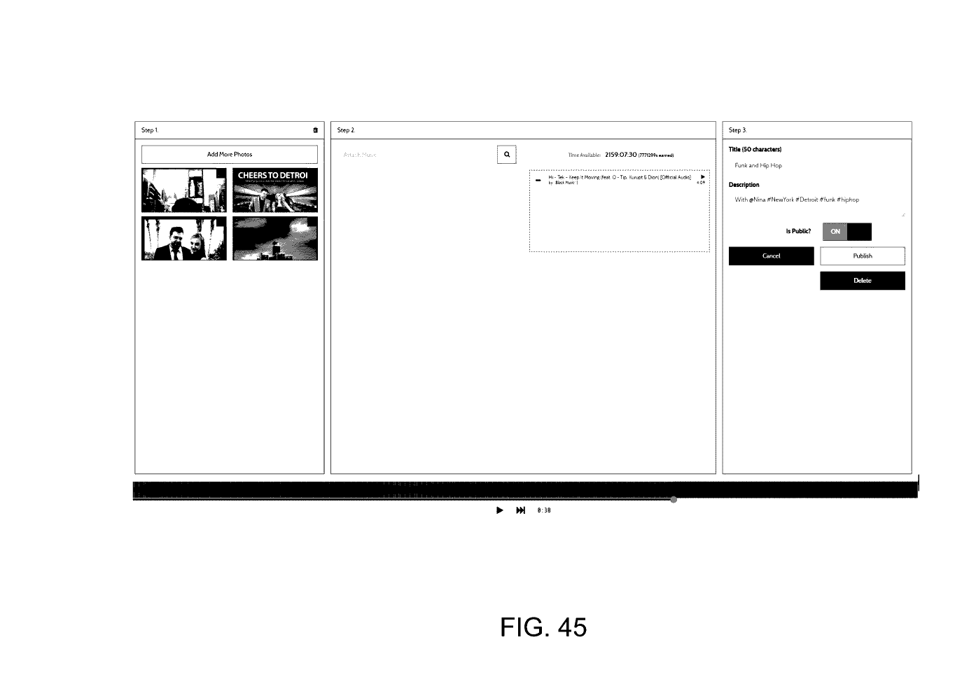

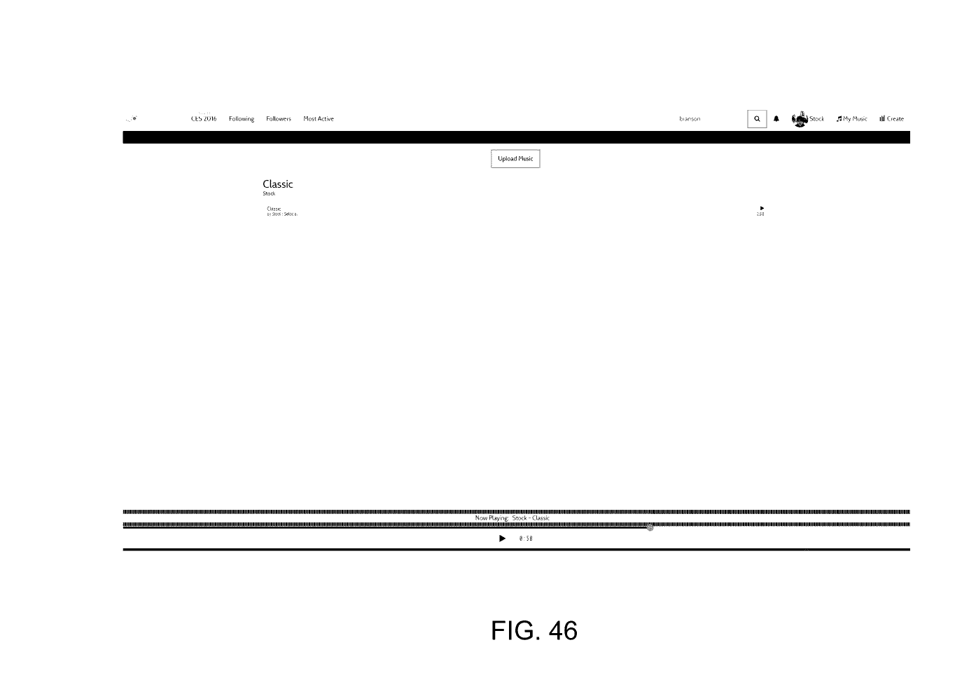

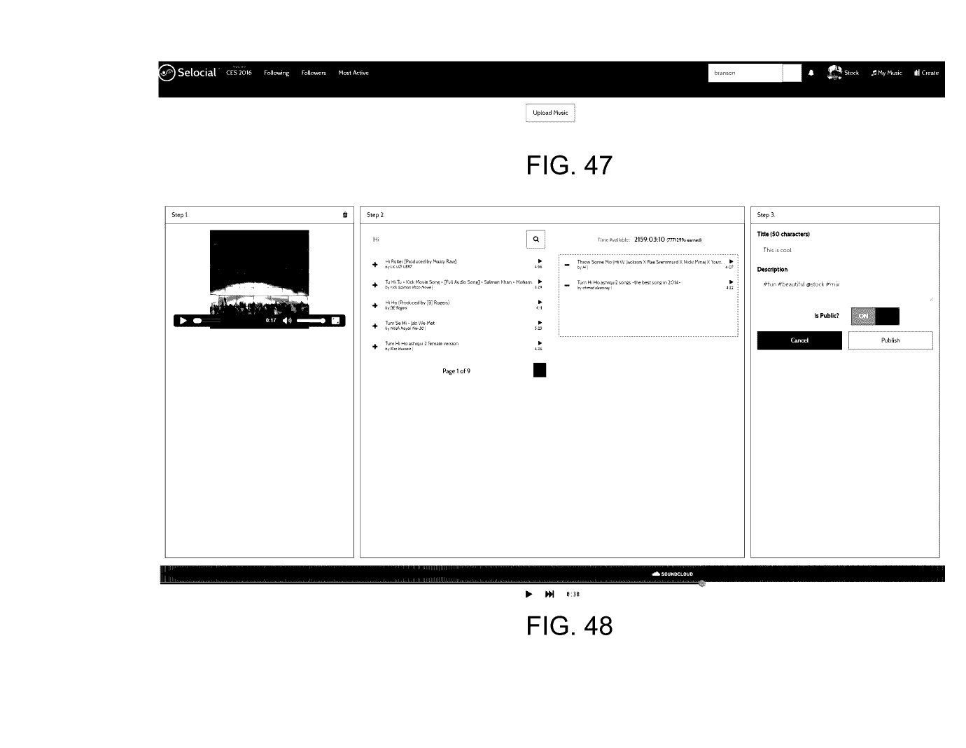

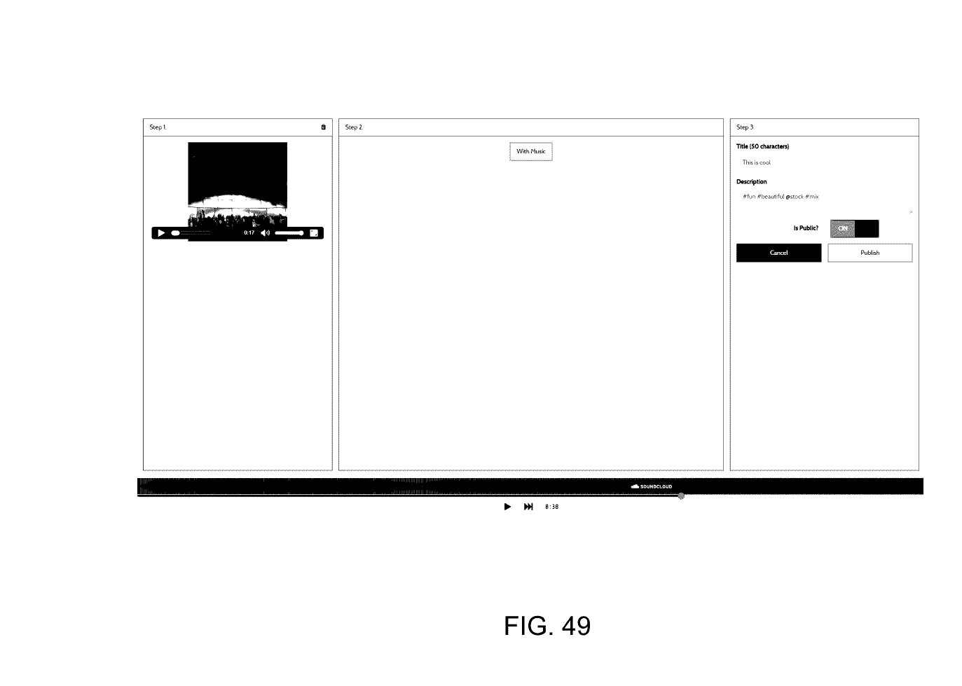

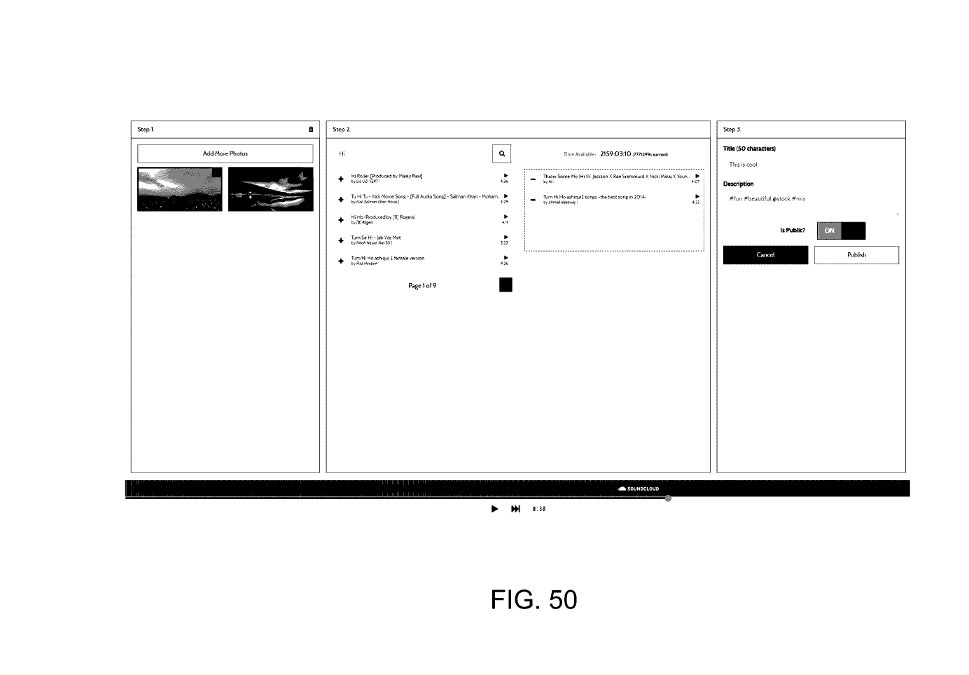

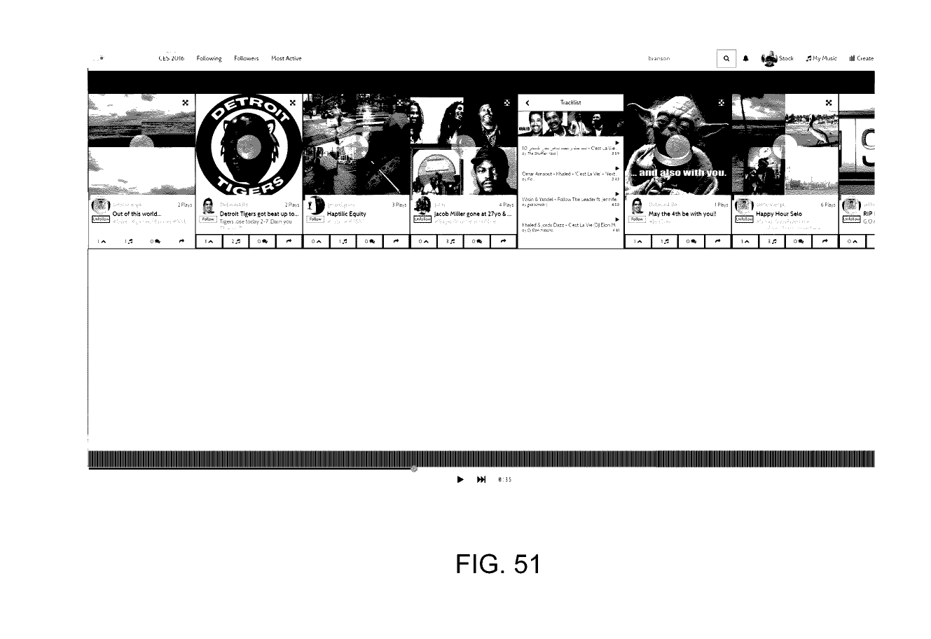

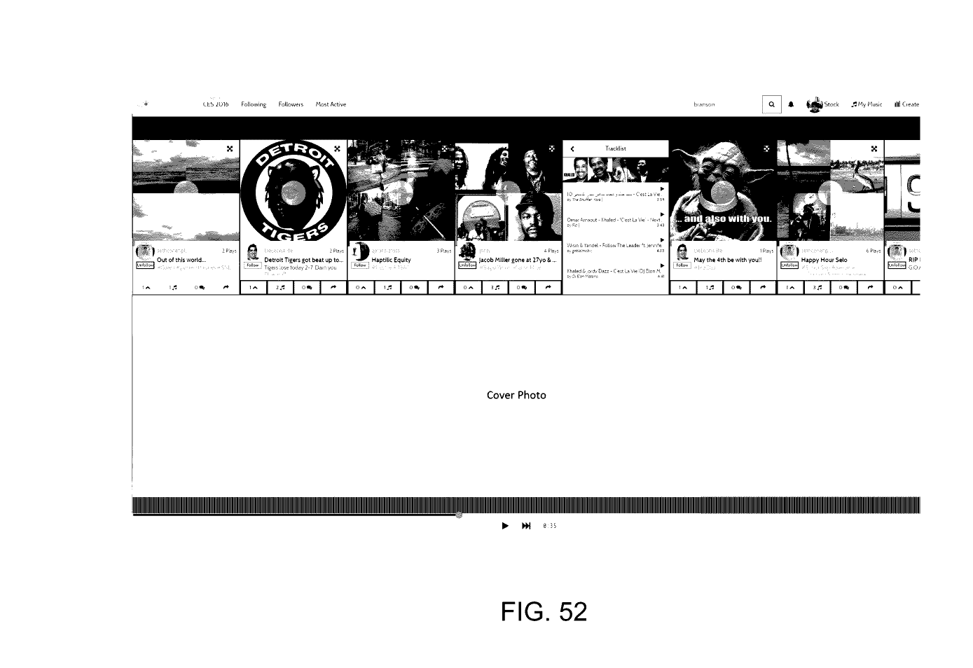

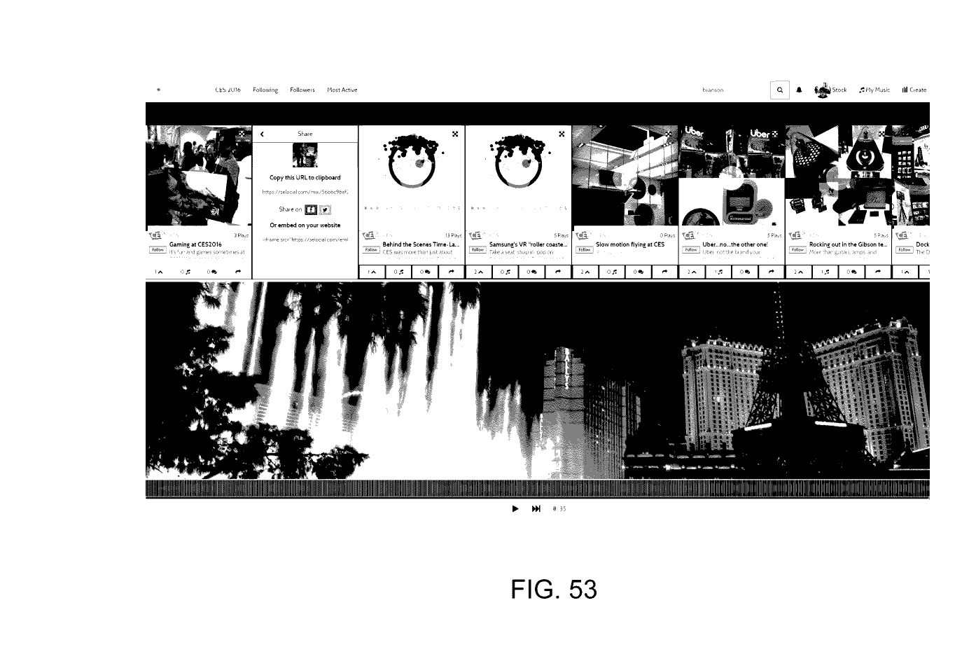

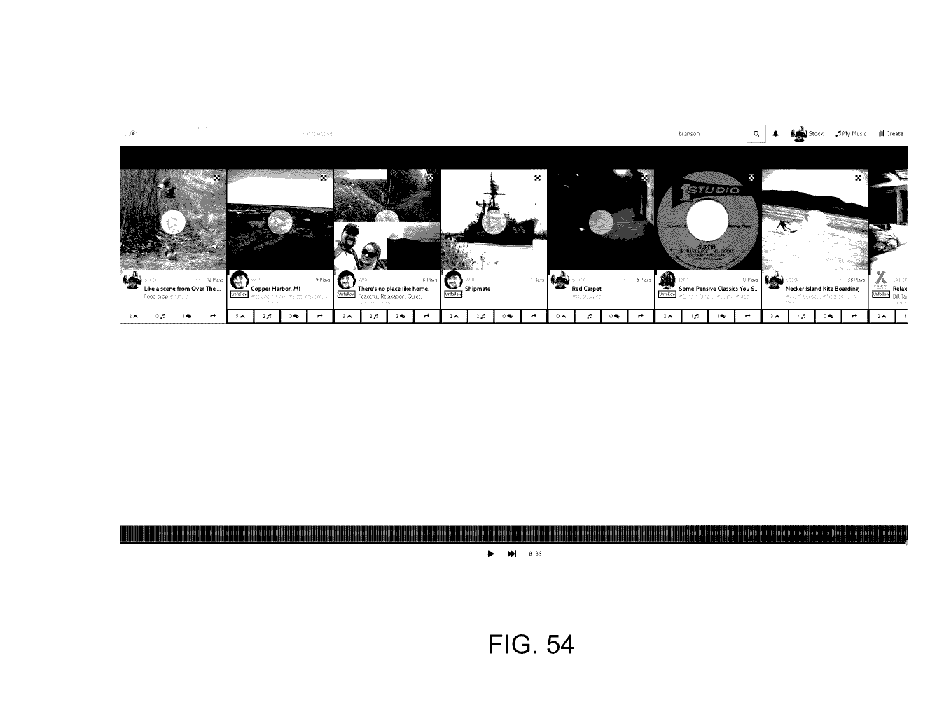

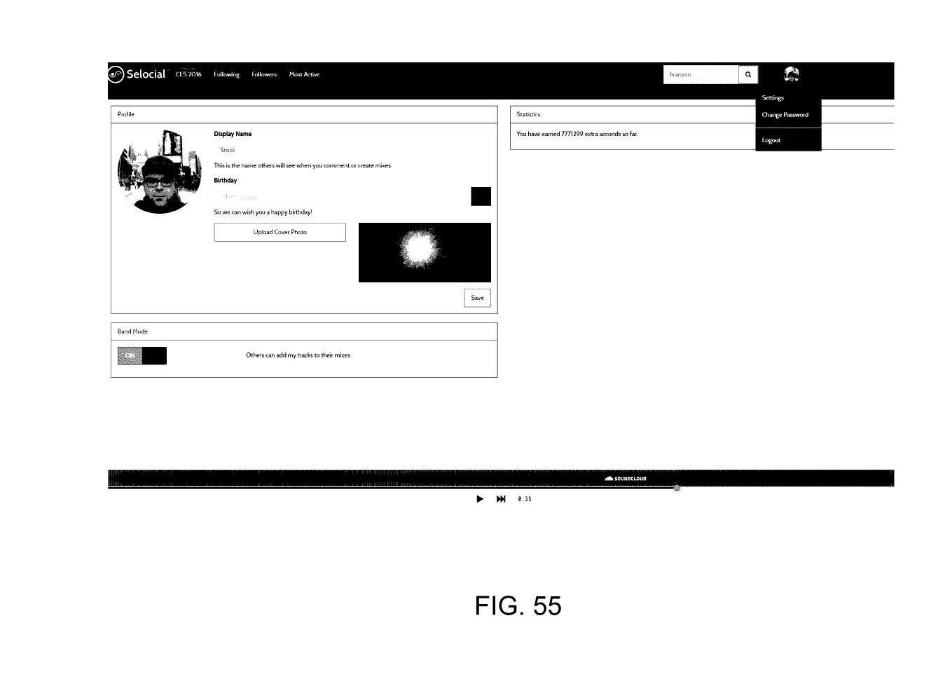

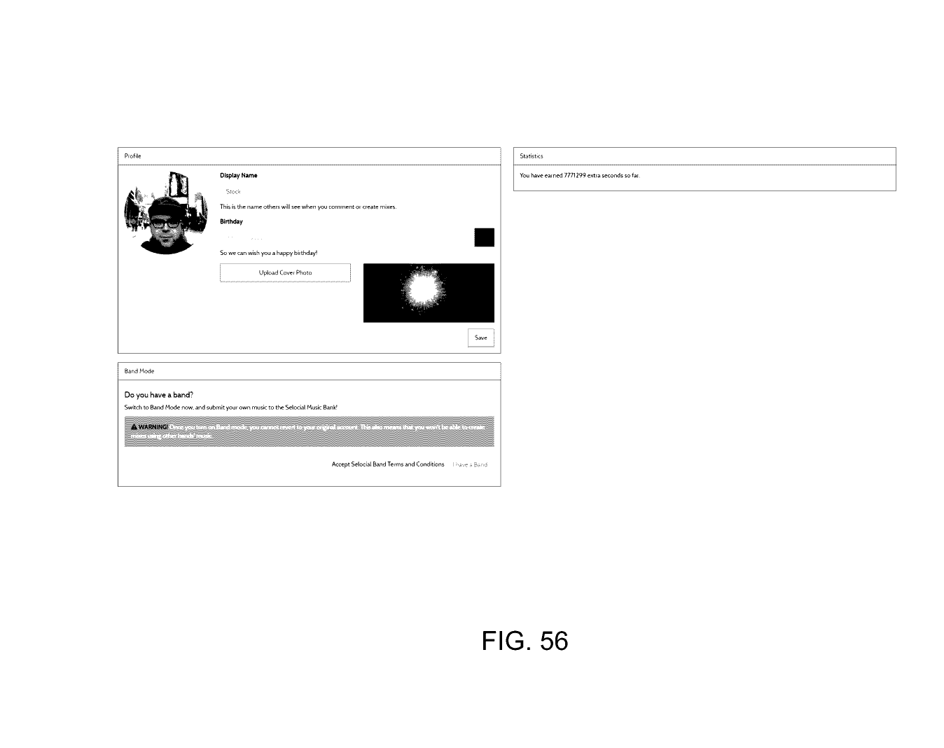

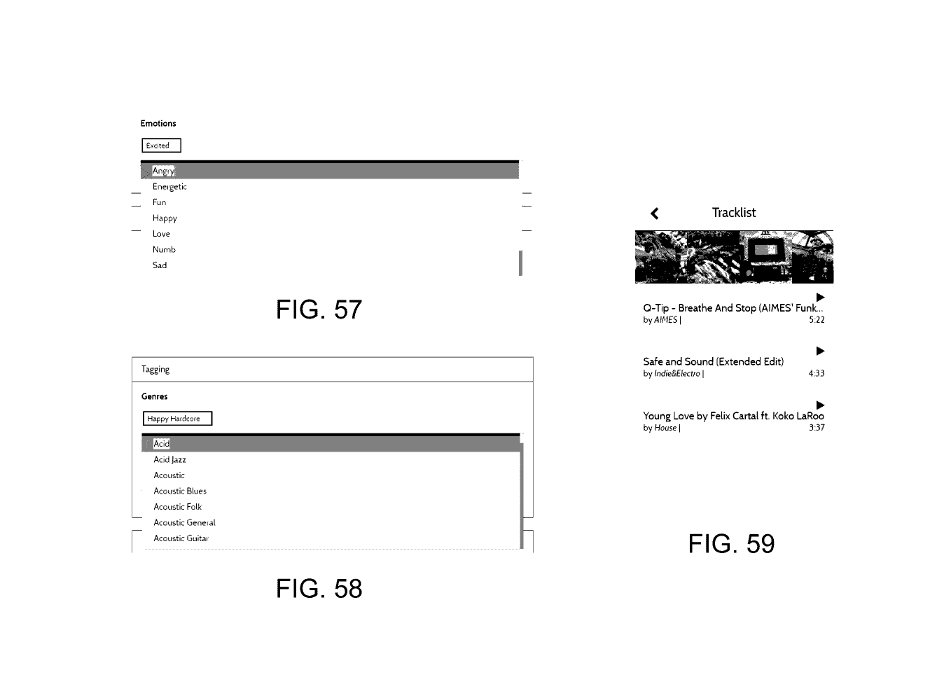

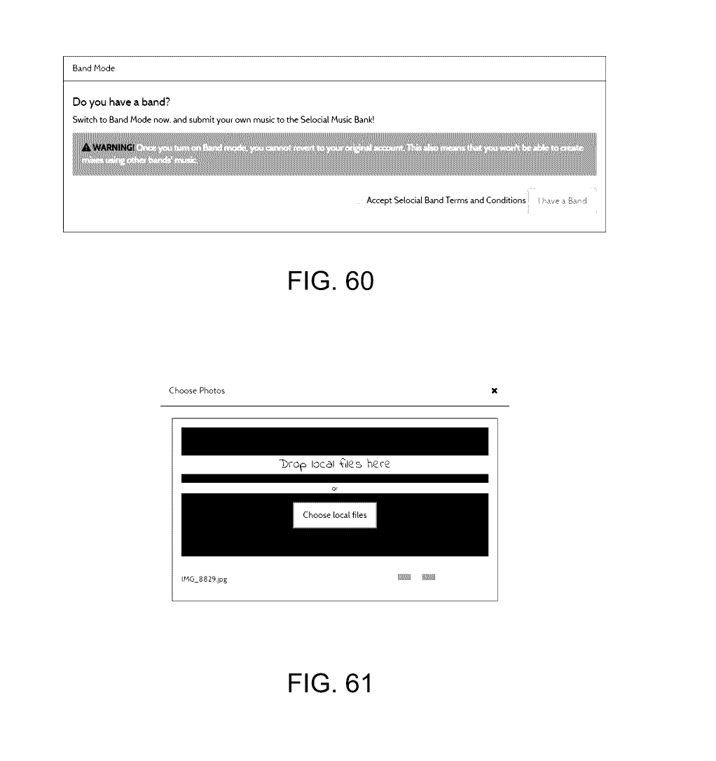

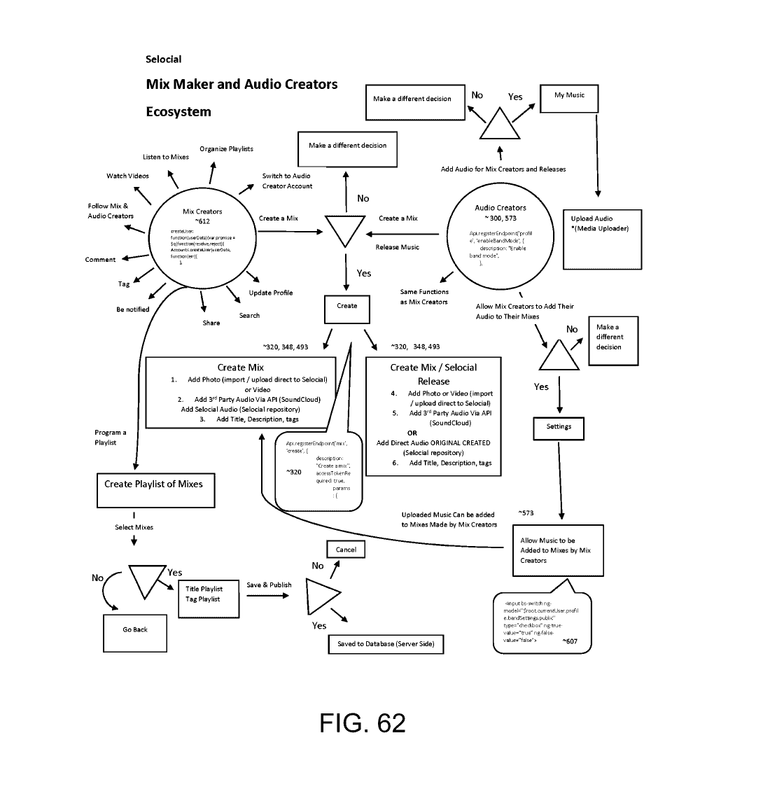

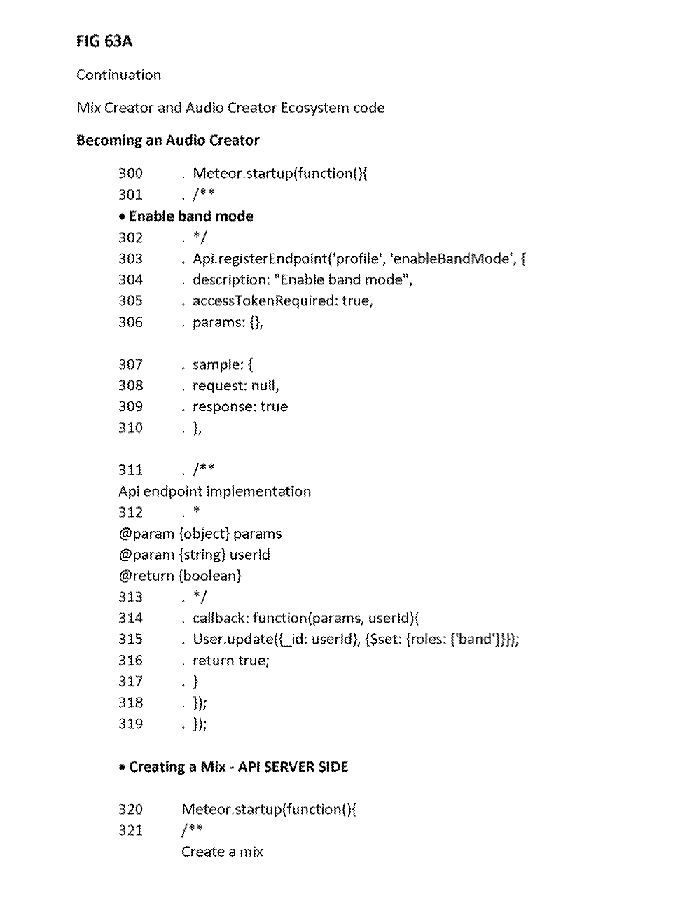

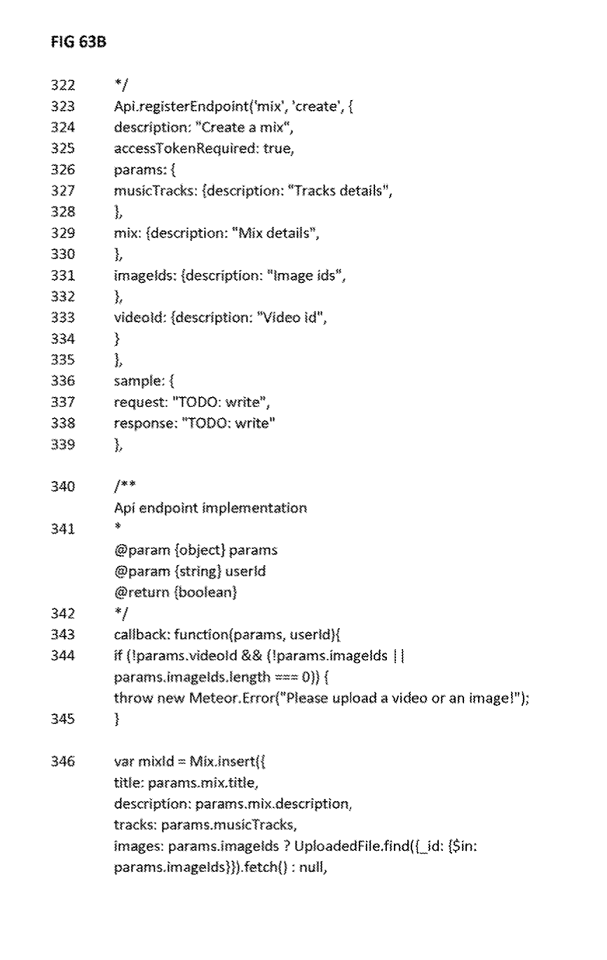

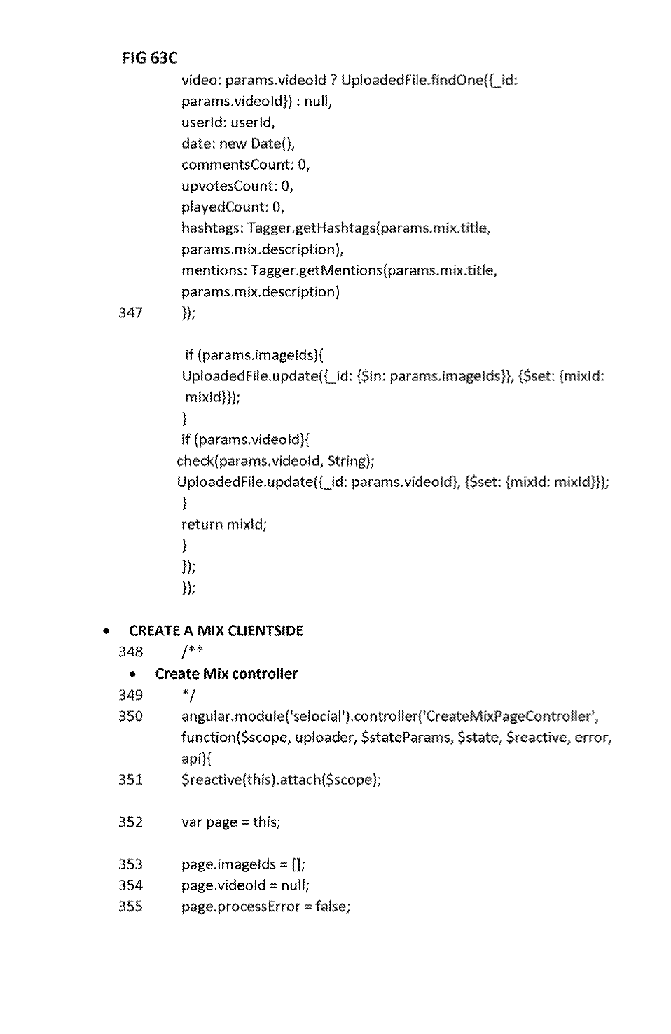

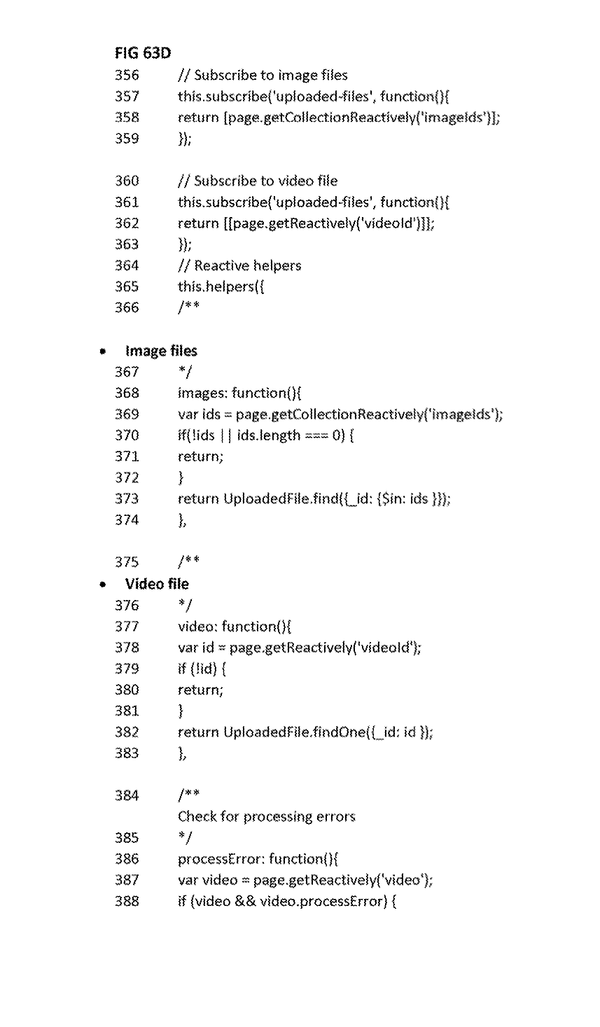

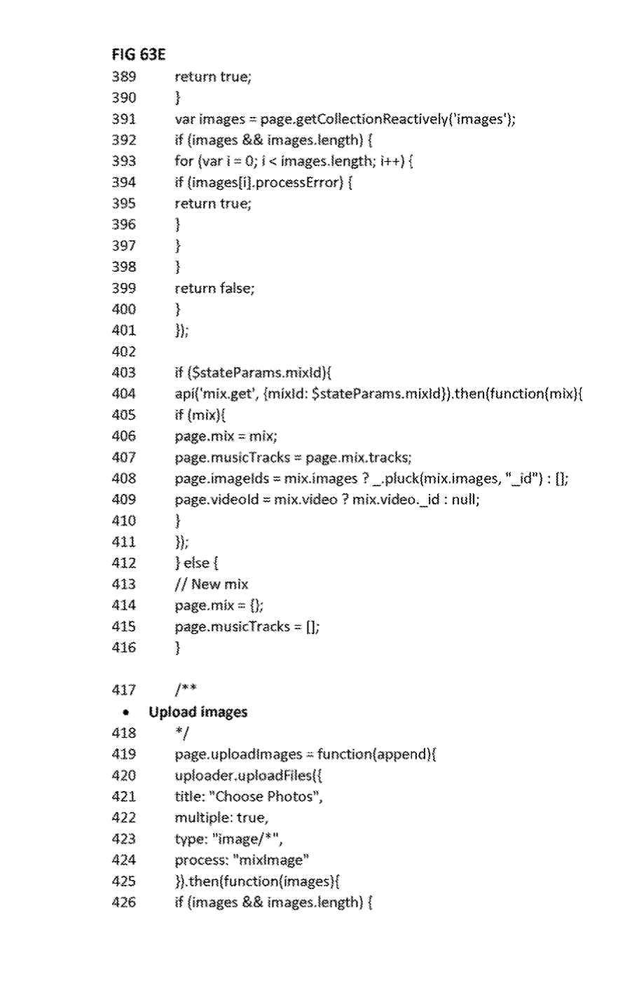

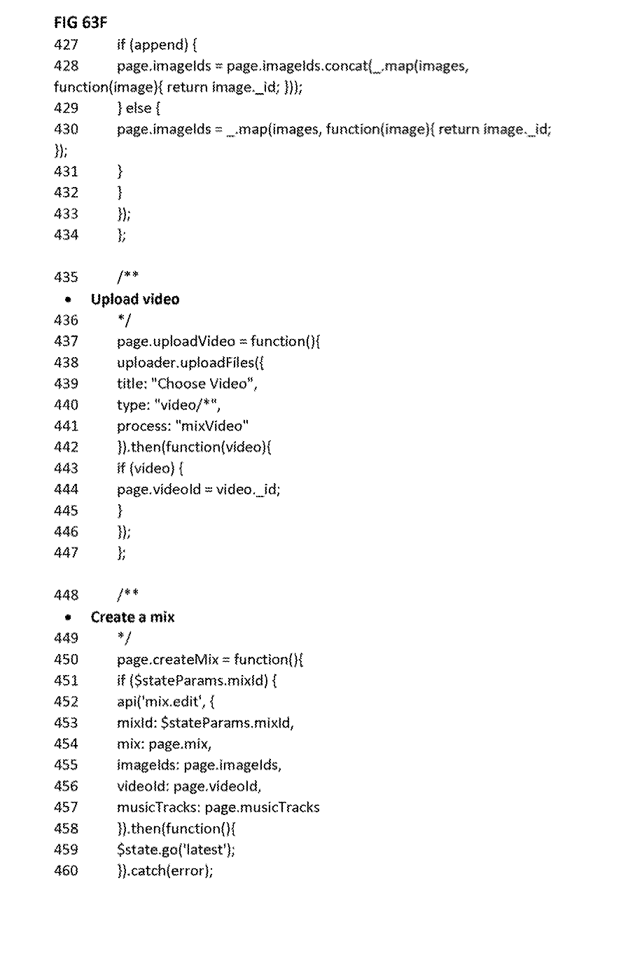

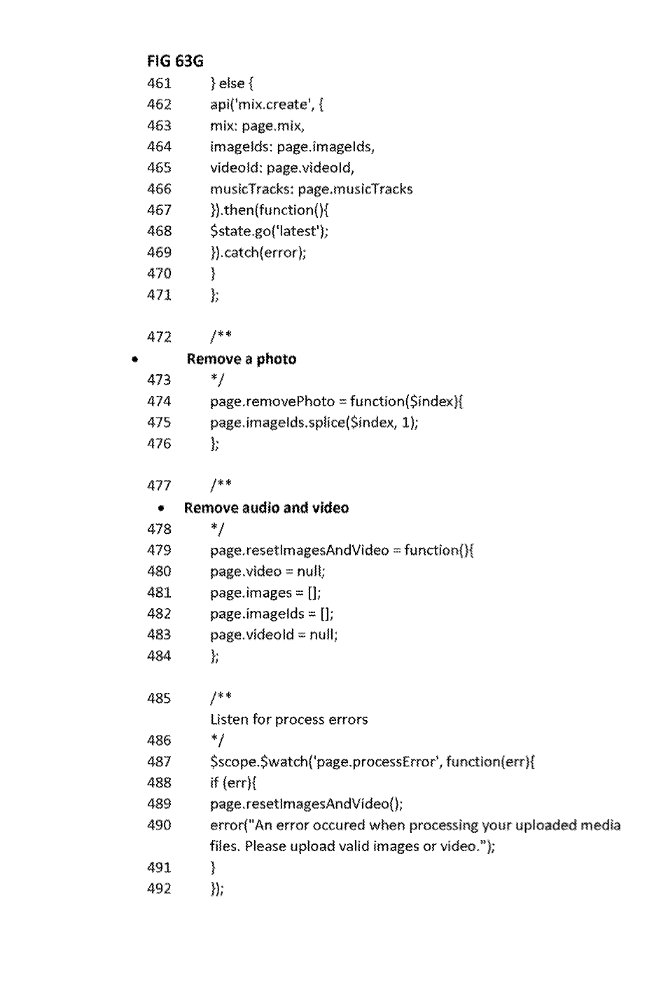

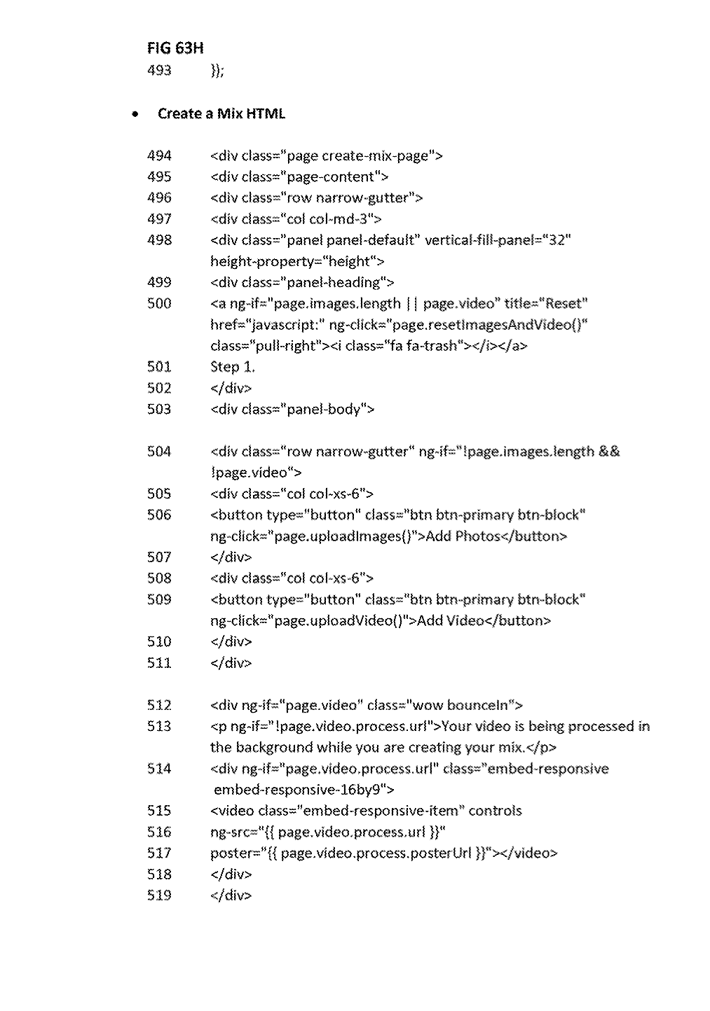

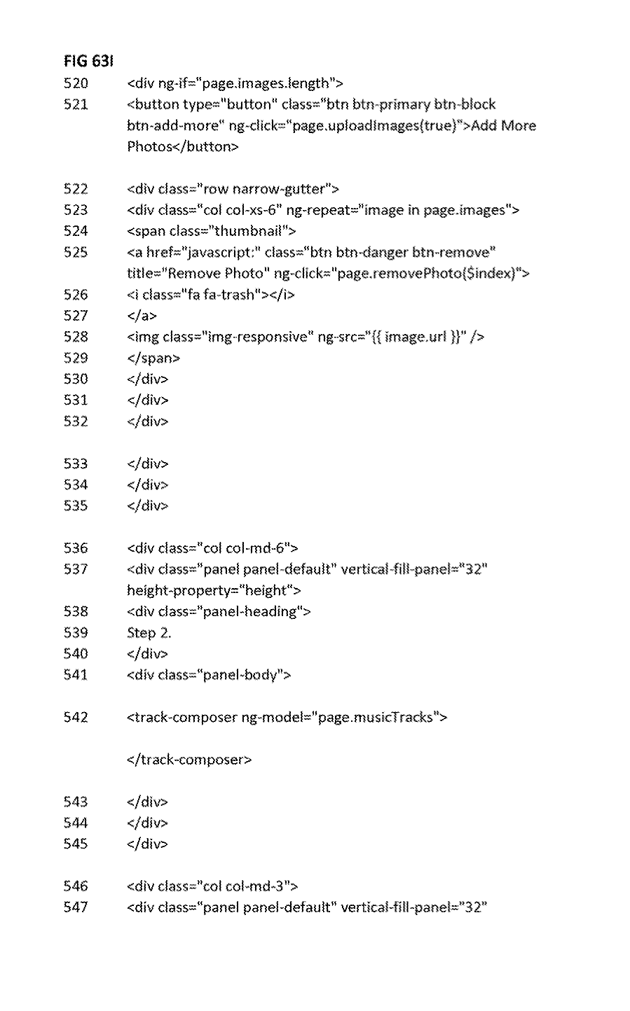

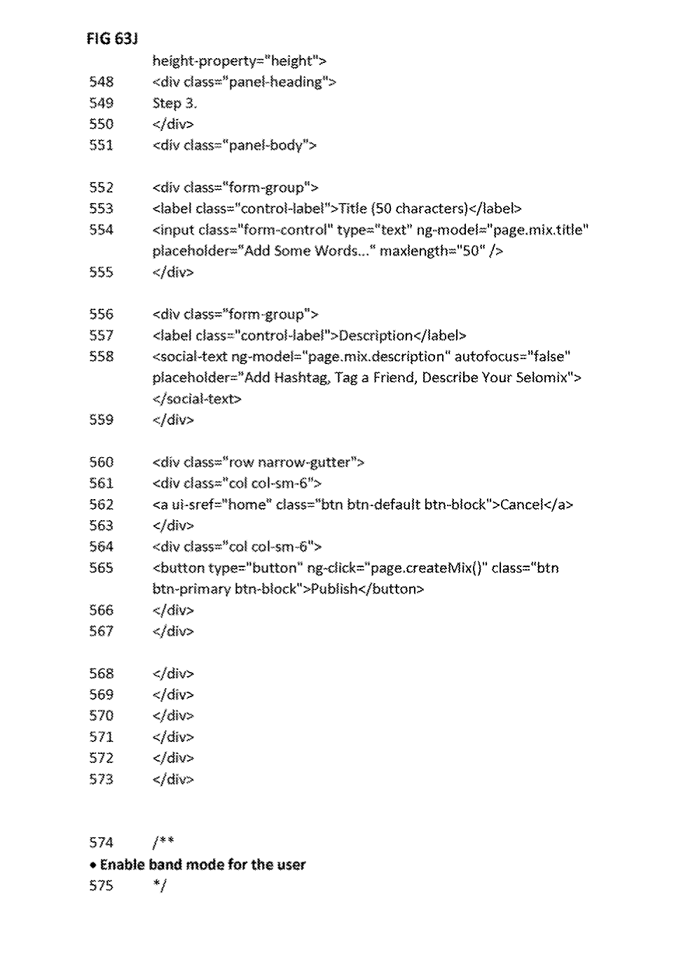

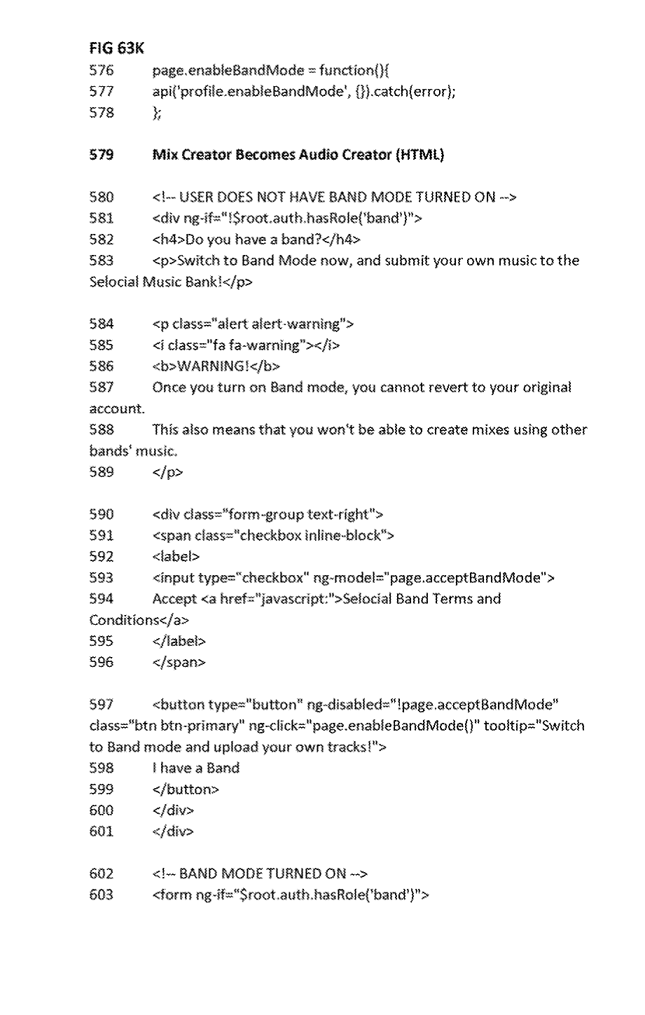

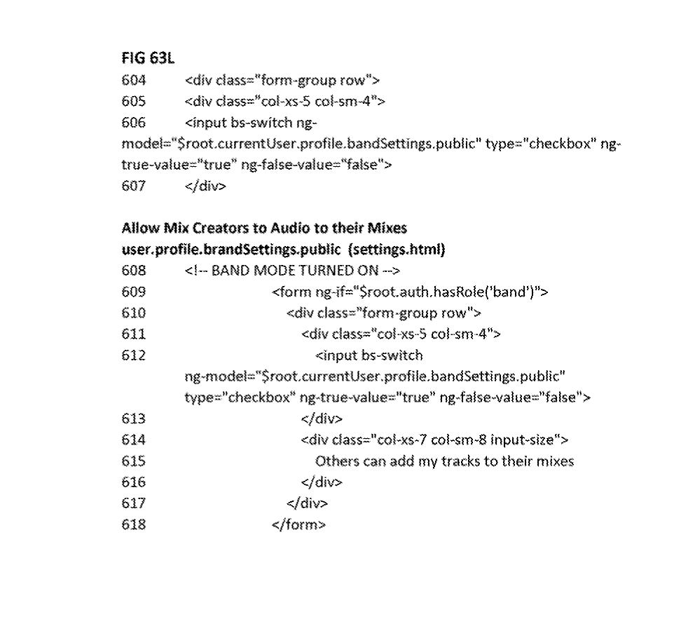

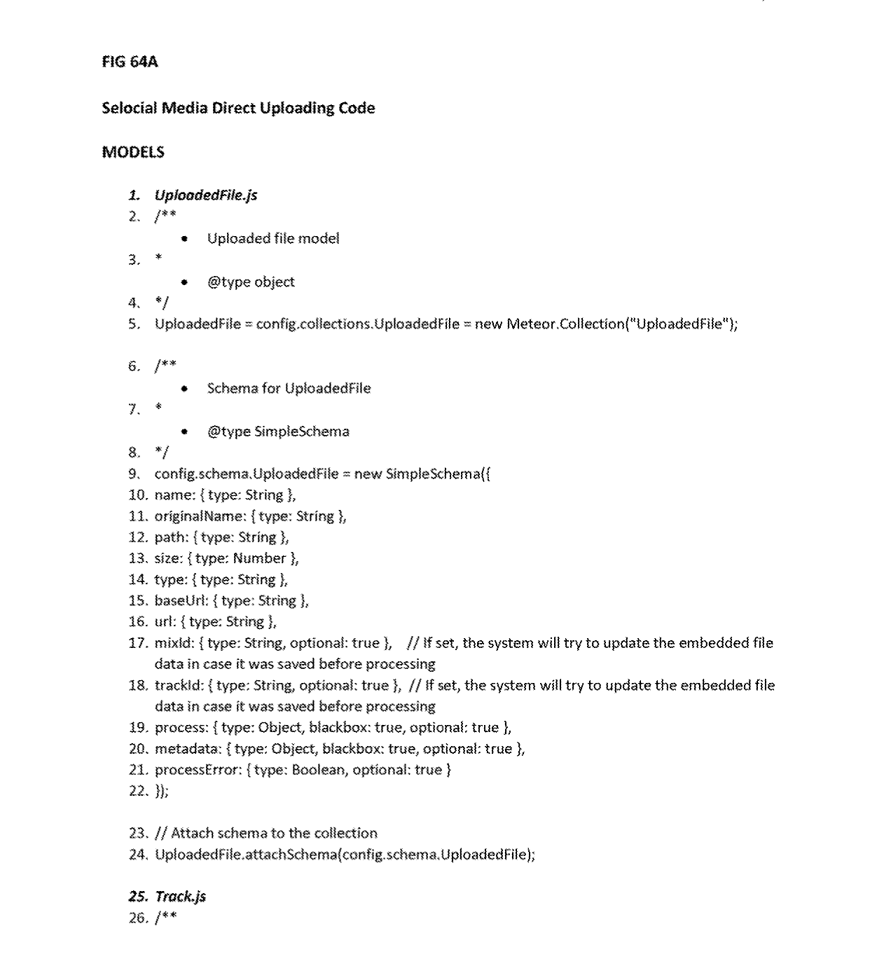

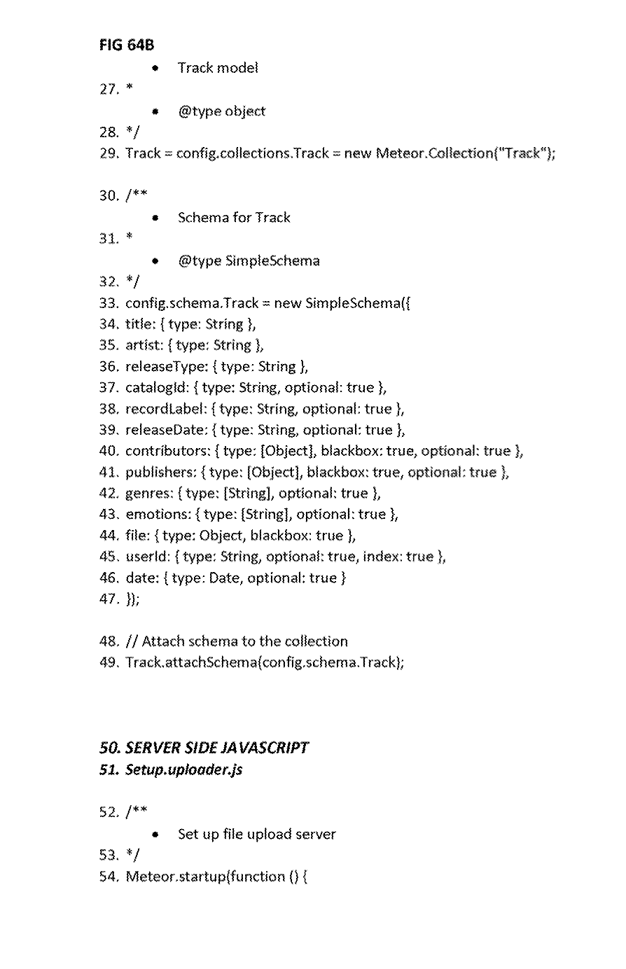

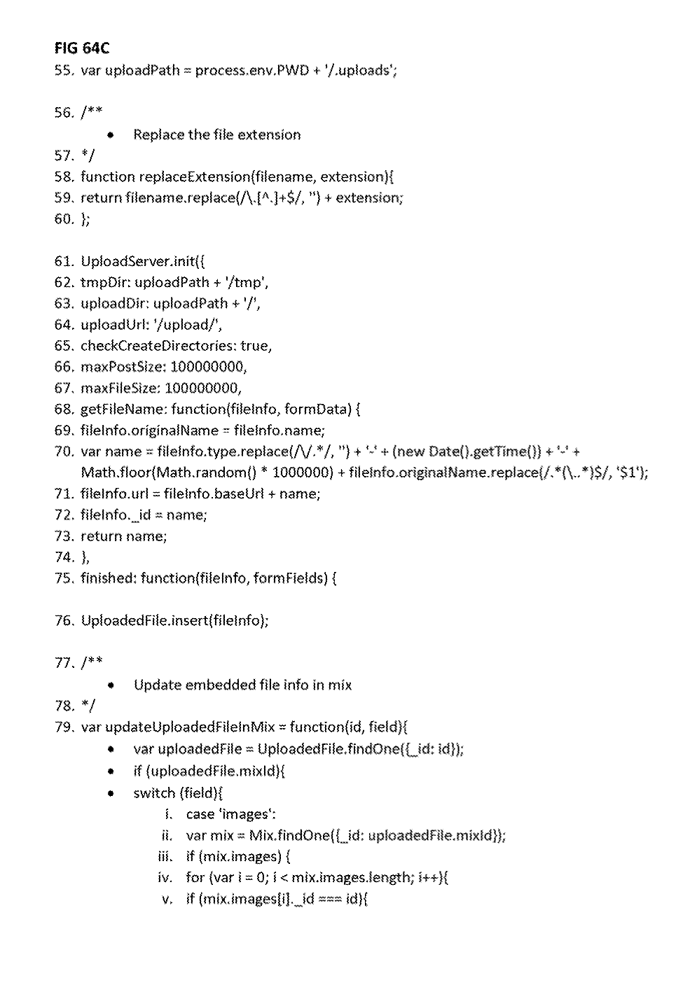

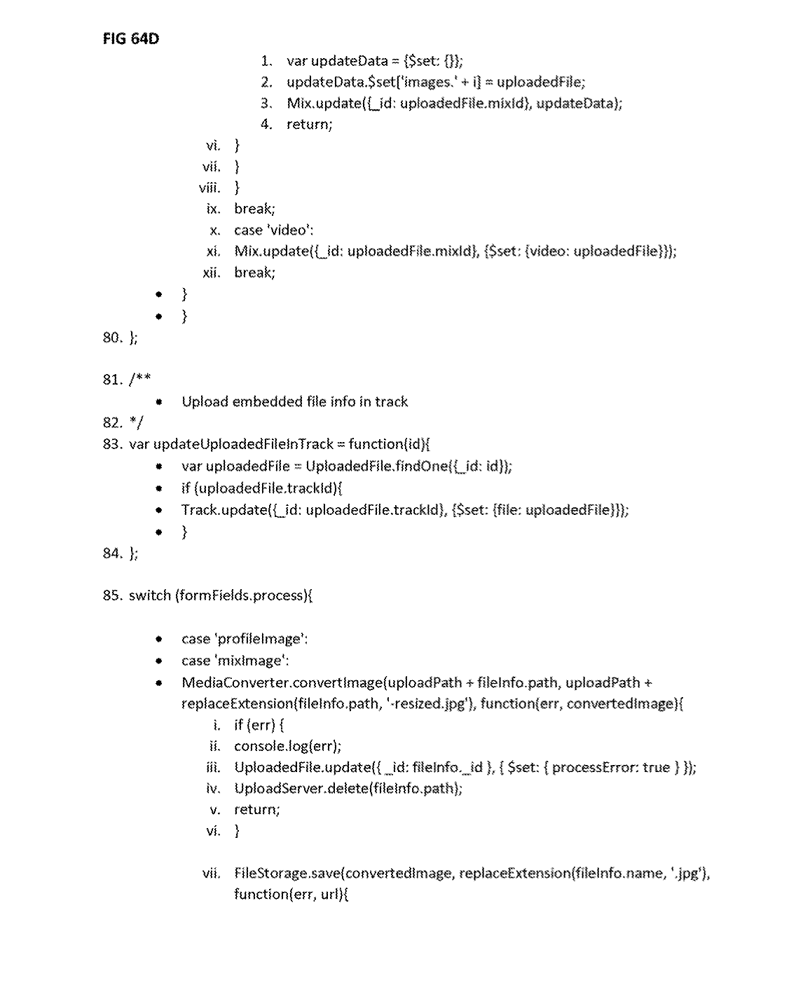

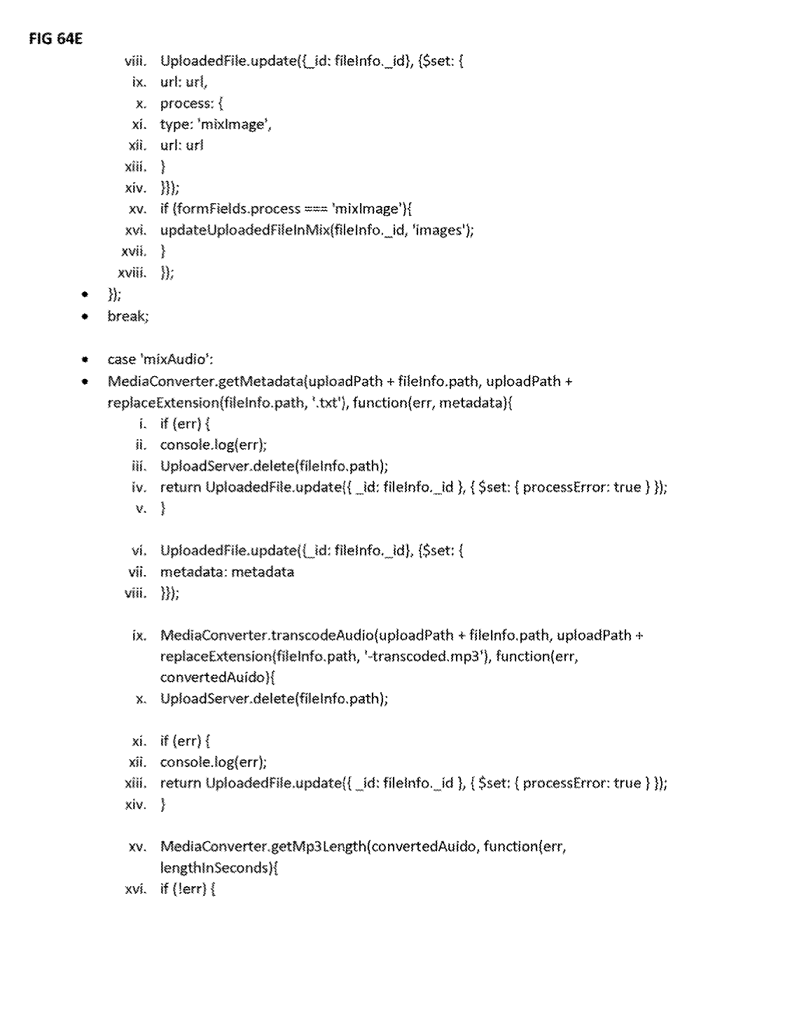

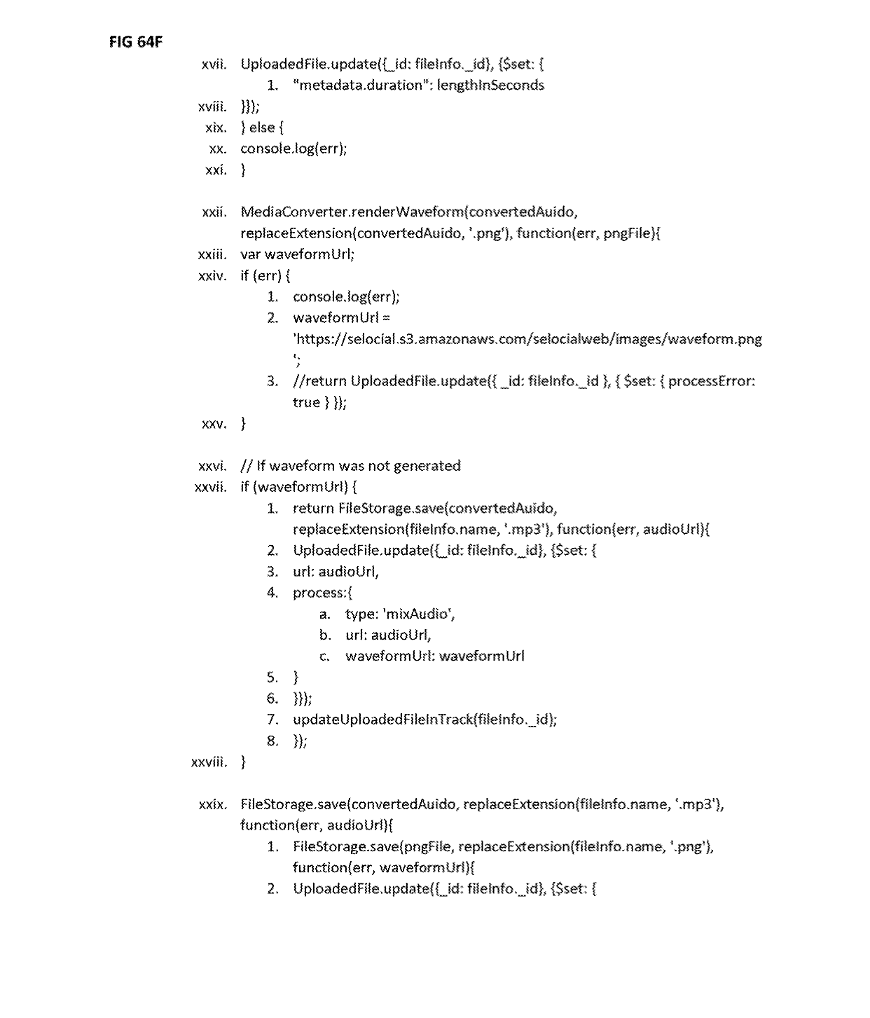

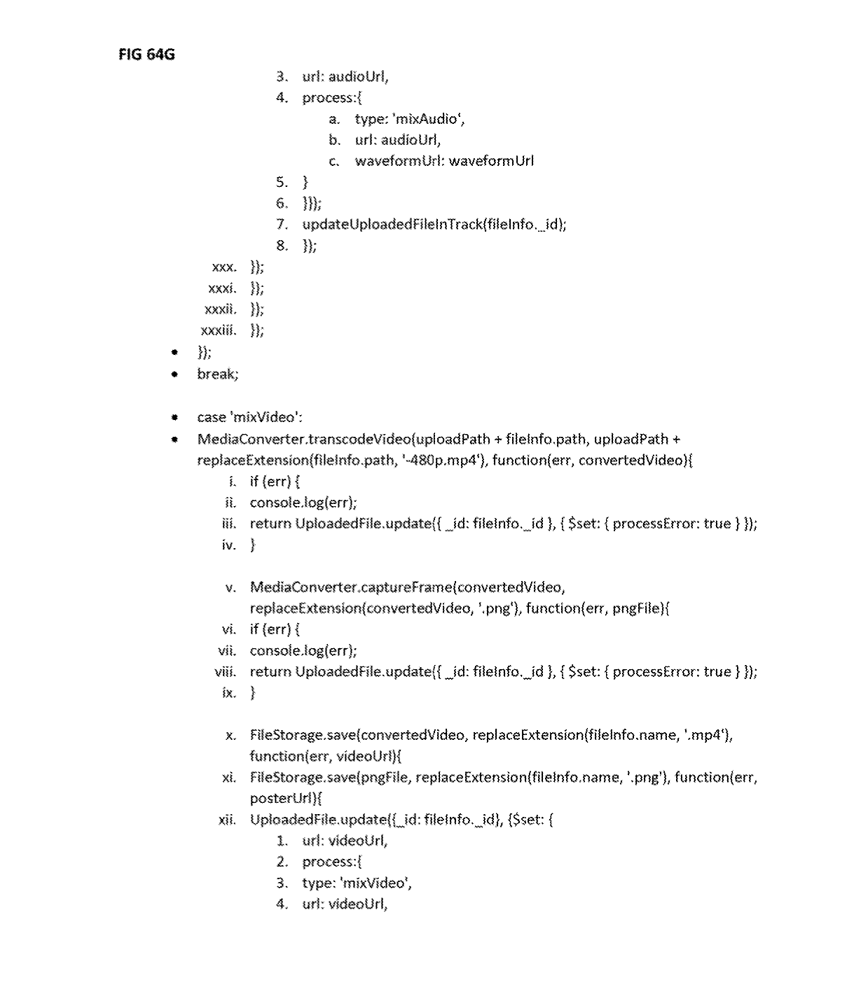

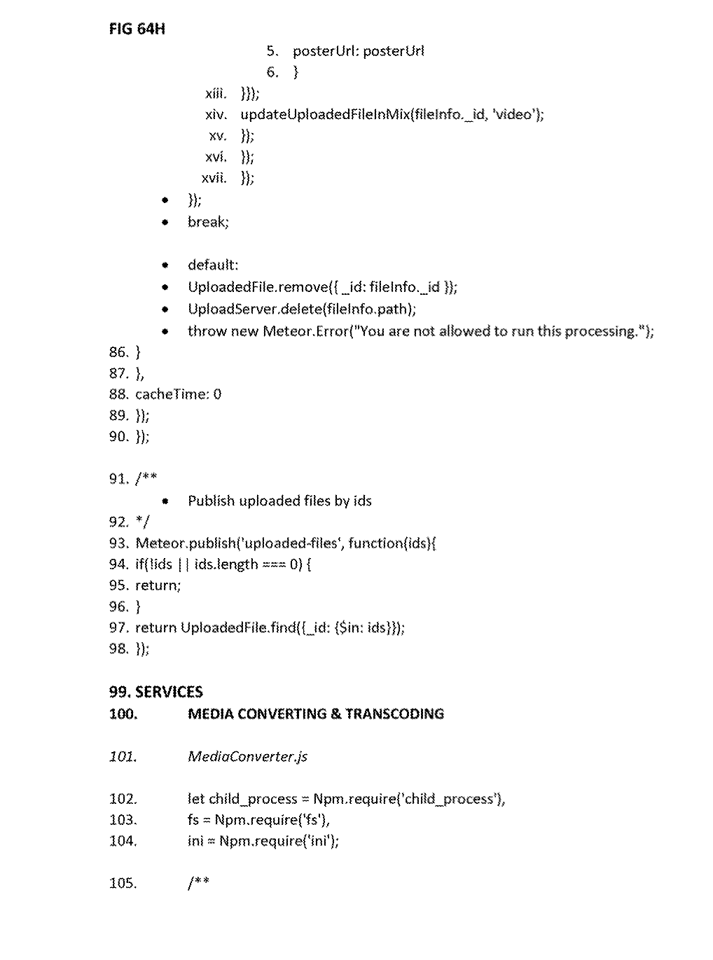

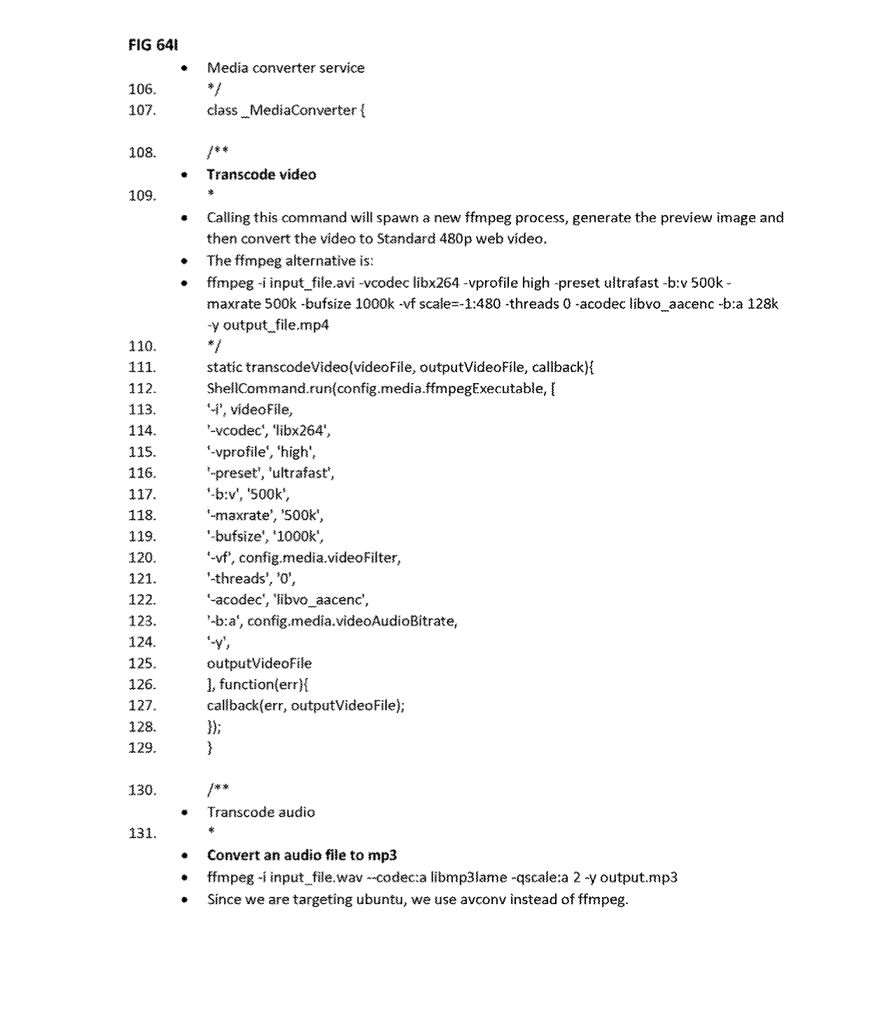

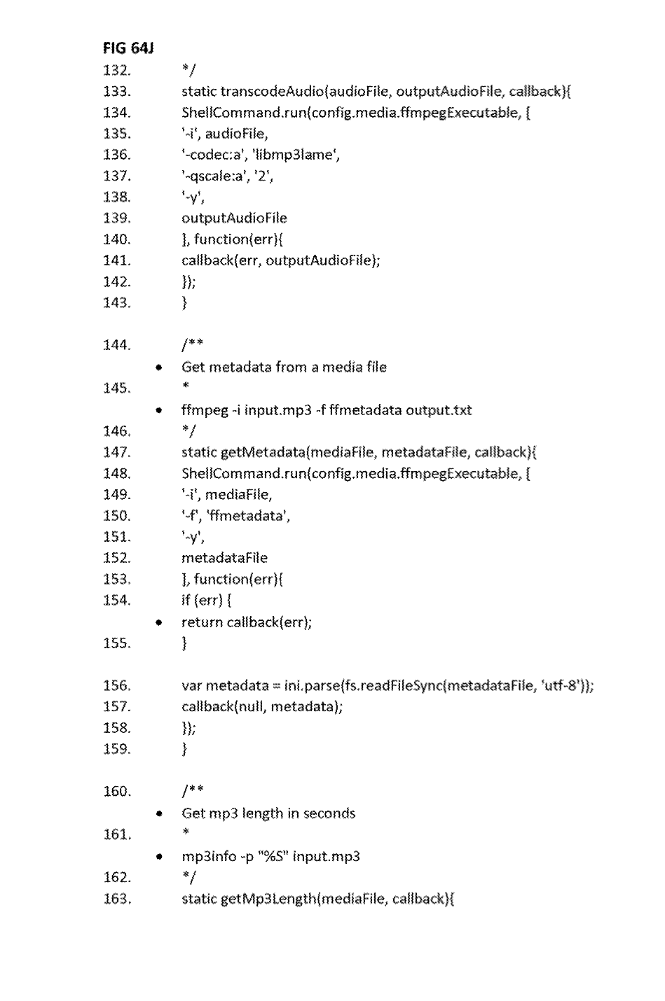

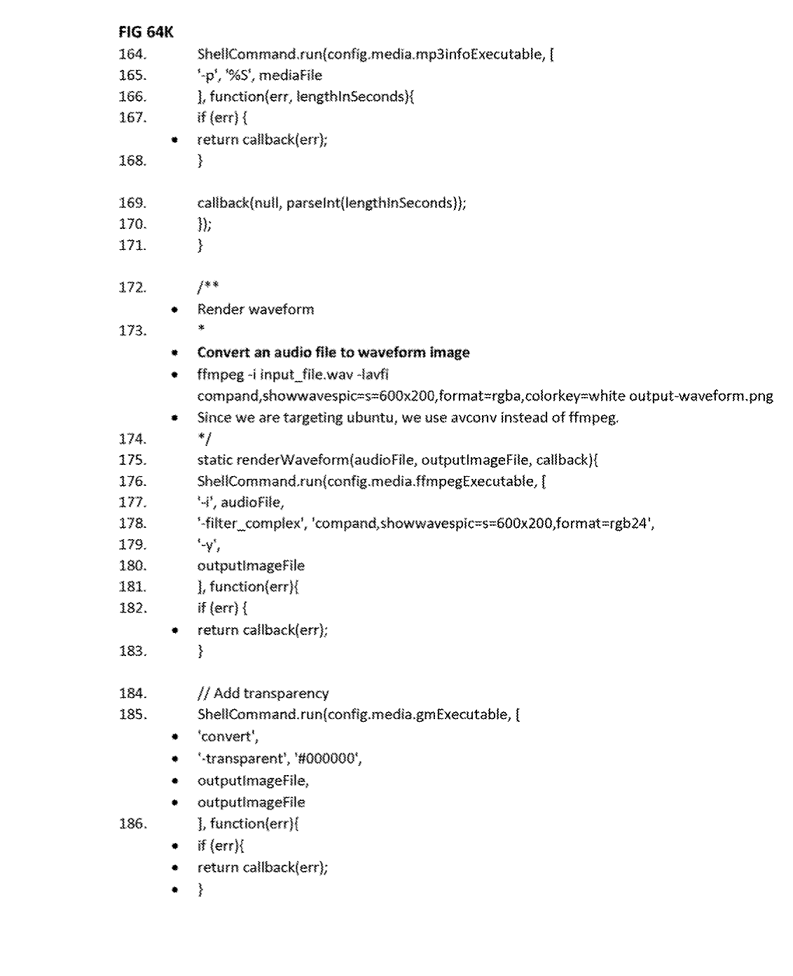

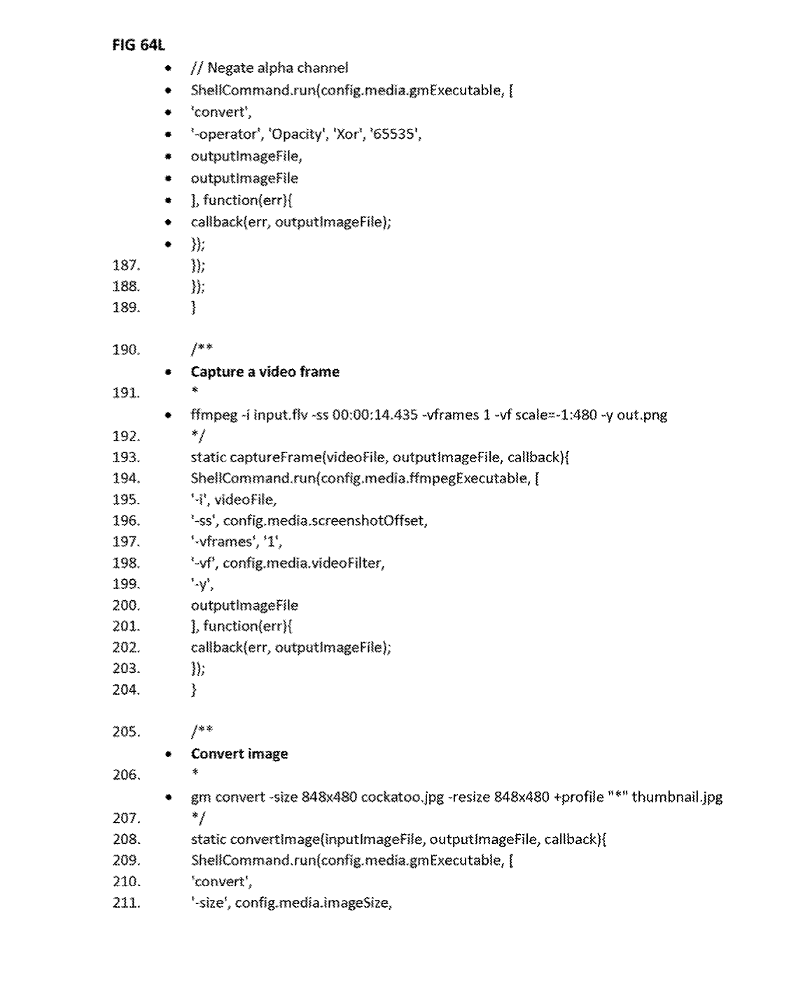

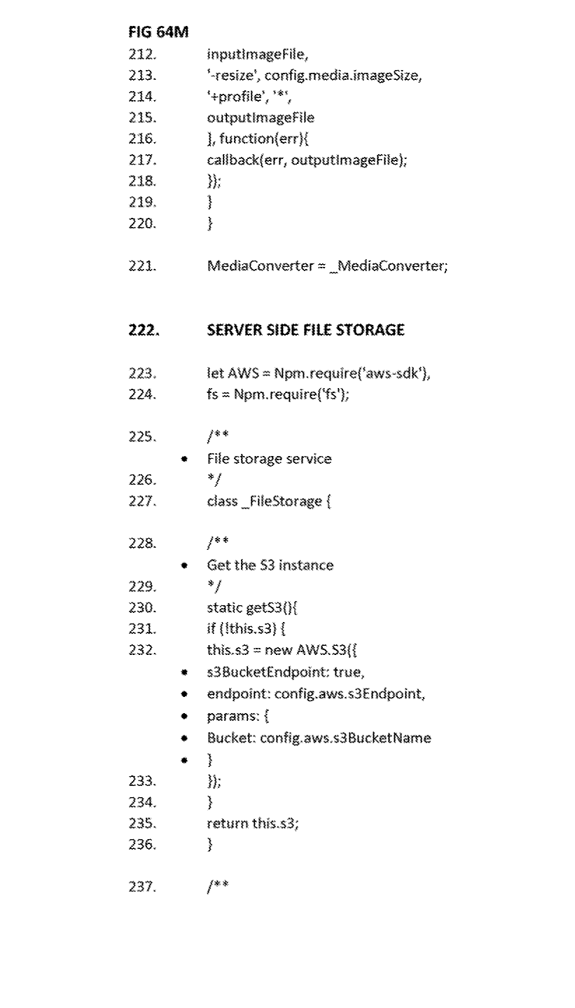

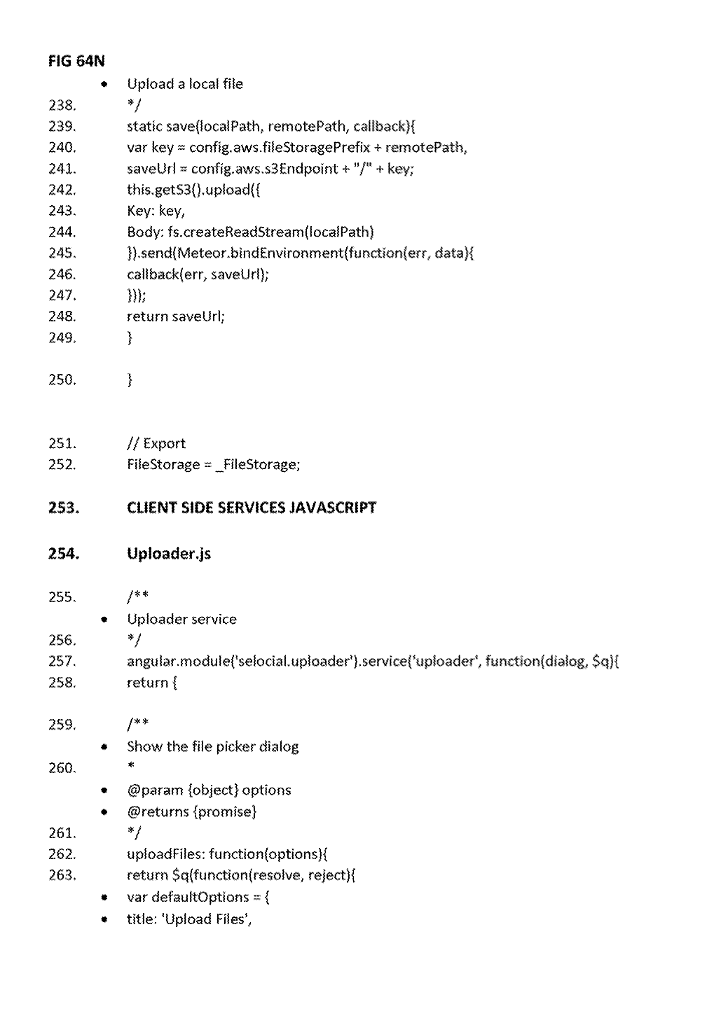

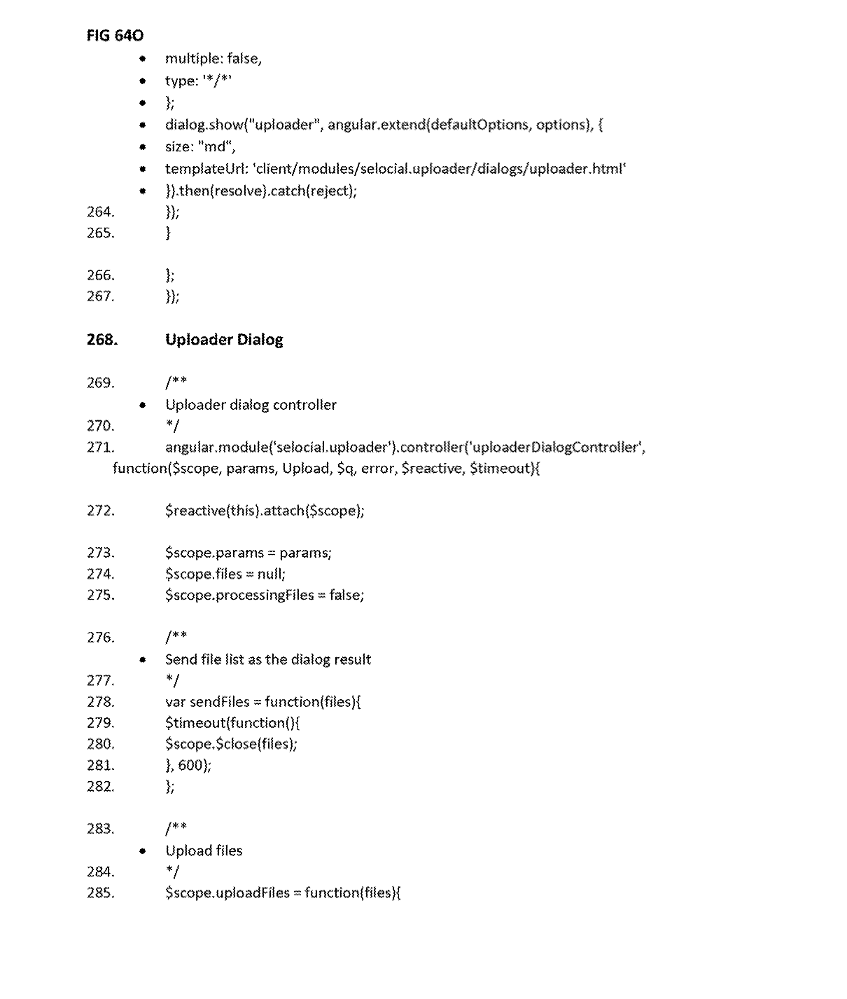

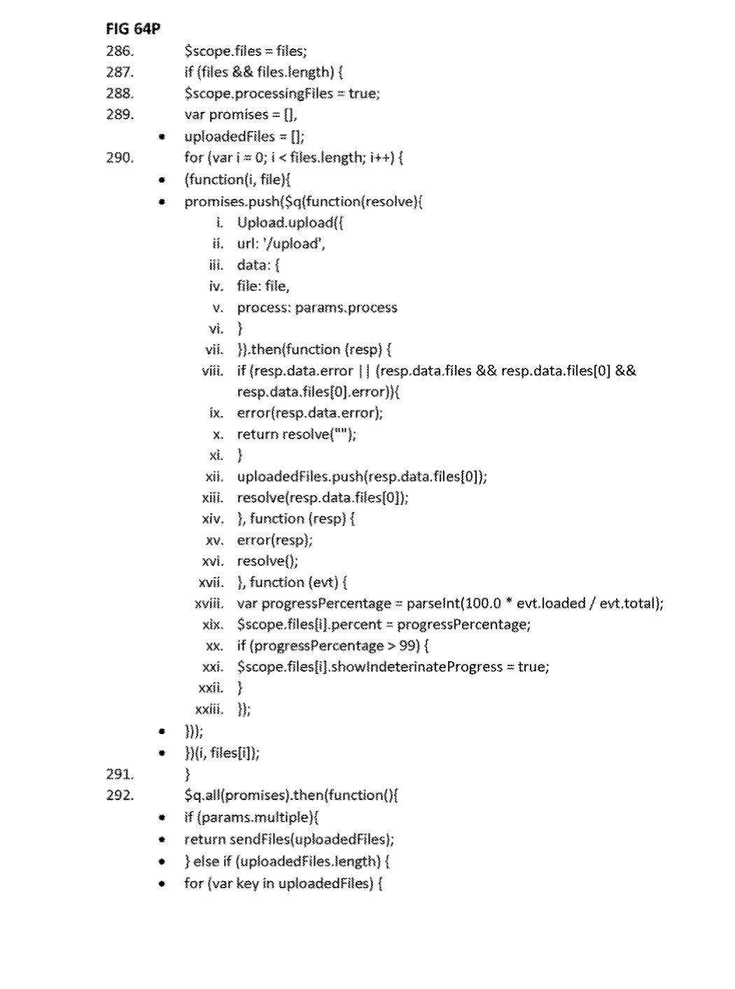

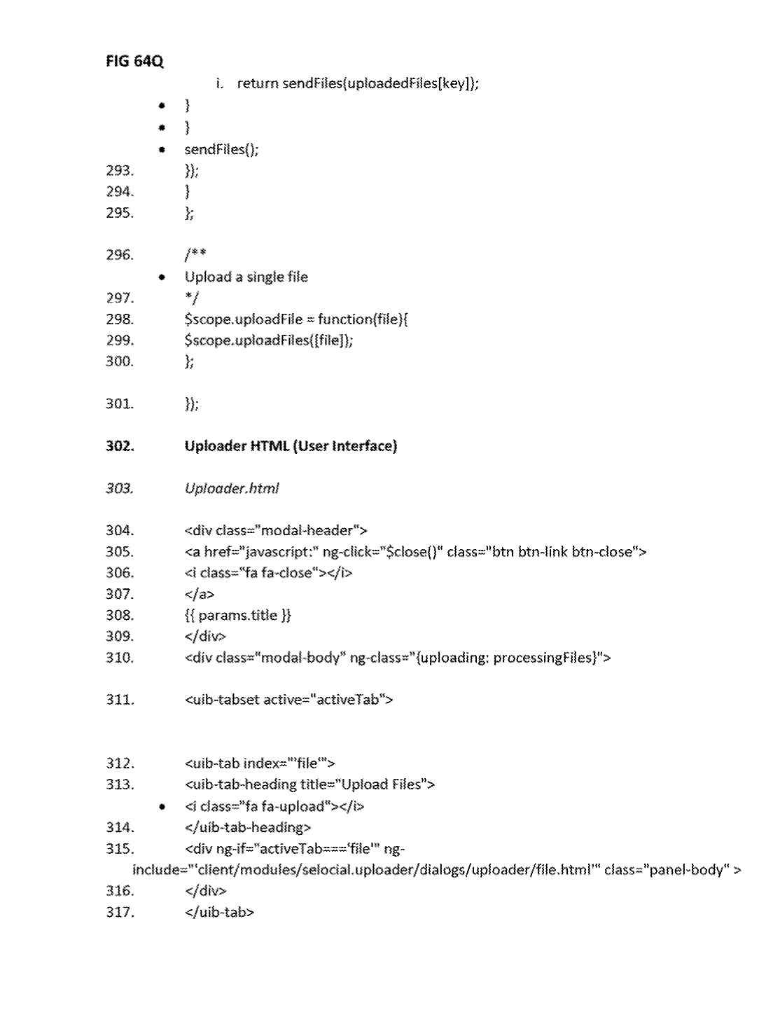

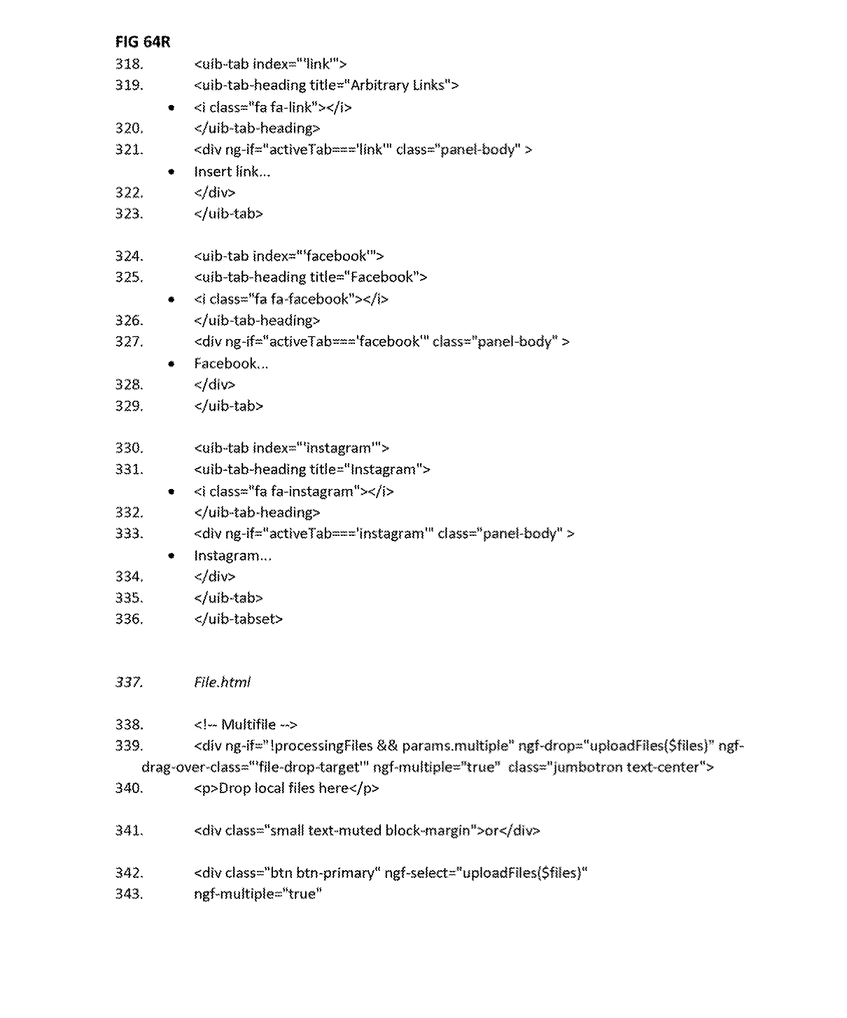

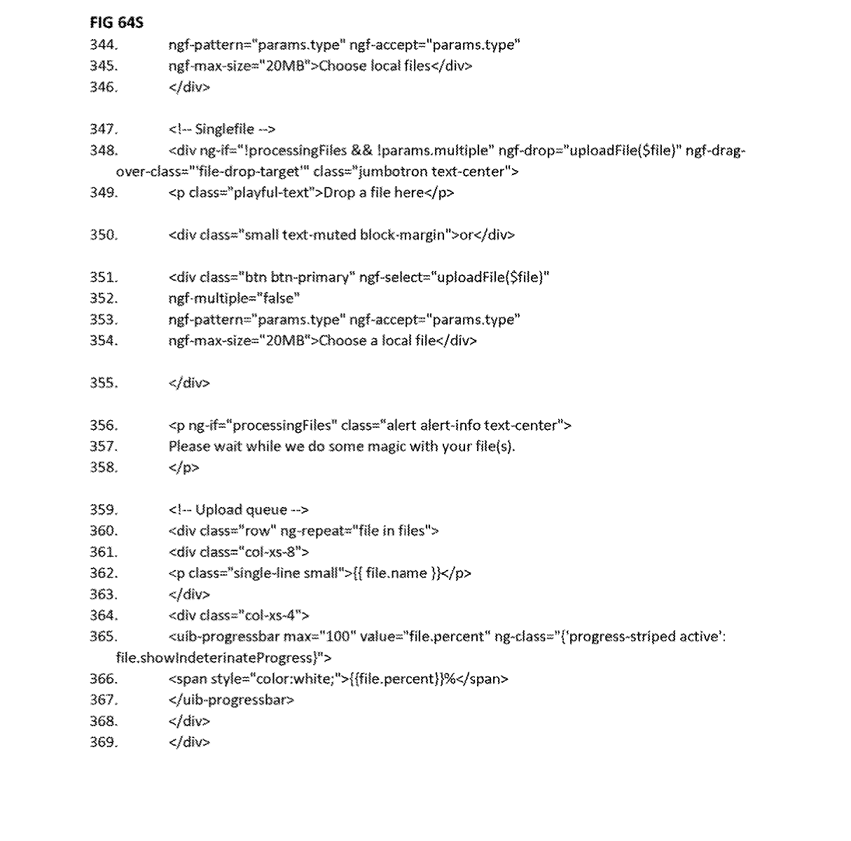

FIGS. 38-61 are as described in the Brief Description of the Drawings above, incorporating all the contents of said FIGS. 38-64 expressly and entirely in this Detailed Description.

The foregoing description and accompanying drawings illustrate the principles, preferred embodiments and modes of operation of the invention. These should be regarded as illustrative rather than restrictive. However, the invention should not be construed as being limited to the particular embodiments discussed above. Additional variations of the embodiments will be appreciated by those skilled in the art without departing from the scope of the invention as defined by the following claims.

1. A system for creating multimedia playlists comprising:
a music module that aggregates a multiplicity of sound files targeted by a User from one or more audio media sources, as a musical playlist;
a time module that registers an allocated playlist duration and references an elapsed mix duration versus the allocated playlist duration, as the mix is created by the User;
a visual module that aggregates at least one image file targeted by the User from one or more visual media fields;
a news module that aggregates topical textual information targeted from one or more news fields, pertaining to at least one of the sound files, as the sound file is added to the playlist by the User; and
a publishing module that compiles the sound files, image file and updates news as an audiovisual playlist, provided the elapsed mix duration is less than or equal to the allocated mix duration, wherein the playlist is discretely displayed on a User interface console as the sound files are played, when prompted by the system or the User.

2. The system of claim 1 wherein the console displays multiple playlists respectively published by multiple Users, together in a pre-determined sequence.

3. The system of claim 2 wherein the playlists are displayed in chronological order.

4. The system of claim 3 wherein the playlists are selected by Users manually by navigating the console or are played automatically by the system.

5. The system of claim 1 wherein the visual module further targets locations selected from those accessible via the interne, private network or local User drive.

6. The system of claim 1 wherein the news module further updates continually with topical information, which is automatically displayed on the console, as a playlist is being played by a User or the system.

7. The system of claim 1 further comprising a manual text input for entering a title or caption by the User.

8. The system of claim 1 further comprising a social currency module that increases the allocated mix duration according to selected value criteria, which enables the User to extend the elapsed mix duration beyond the allocated mix duration.

9. The system of claim 1 wherein the publishing module further displays the image and text for each moment on a card that can be manually flipped to display a reverse side for User commentary or other textual information.

10. A method for creating multimedia playlists comprising the steps of:
targeting a multiplicity of sound files from one or more audio media fields and aggregating the sound files in a music module, for each playlist;
registering an allocated mix duration in a time module and referencing an elapsed mix duration versus the allocated mix duration, for each playlist;
targeting at least one image file from one or more visual media fields and aggregating the image file in a visual module for each playlist;
targeting topical textual information pertaining to at least one of the sound files from one or more news fields and aggregating the textual information in a news module, as the sound file is added to the playlist; and
compiling the sound files and image file and updating the topical information, ascertaining that the elapsed mix duration is less than or equal to the allocated mix duration and publishing the files and updated text as an audiovisual playlist, discretely displaying each audiovisual playlists on a User interface console as the sound files are played, respectively.

11. The method of claim 10 further comprising the step of publishing multiple playlists, by separate Users, displaying the playlists in a pre-determined sequence on the console.

12. The method of claim 11 further comprising the step of displaying the playlists in chronological order of publication.

13. The method of claim 12 further comprising the step of navigating the multiple playlists on a console and manually playing the sound files by Users or automatically in a predetermined order.

14. The method of claim 10 further comprising the step of targeting visual fields selected from those accessible via the internet, private network or local User drive, in the visual module

15. The method of claim 10 further comprising the step of continually updating the topical information in the news module and automatically displaying the topical information on the console, as a sound file is being played by a User.

16. The method of claim 10 further comprising the step of a providing a text input window for manually entering a title or caption by the User.

17. The method of claim 10 further comprising the step of increasing the allocated mix duration according to selected value criteria in a social currency module, enabling the User to extend the elapsed mix duration beyond the allocated mix duration.

18. The method of claim 10 wherein the publishing module further displays the image and text for each moment on a card that can be manually flipped to display a reverse side for User commentary or other textual information.
